(19) United States
(12) Patent Application Publication
(10) Pub. No.: US 2026/0295748 A1
(43) Pub. Date: Oct. 1, 2026

(54) CNC MACHINE AND WORKPIECE TROLLEY

(71) Applicant: Omachron Intellectual Property Inc., Hampton (CA)

(72) Inventor: Wayne Ernest Conrad, Hampton (CA)

(21) Appl. No.: 19/093,867

(22) Filed: Mar. 28, 2025

(51) Int. Cl. B23Q 5/22

(52) U.S. Cl. CPC B23Q 5/22

(57) ABSTRACT

A computer numerical control (CNC) machine has a vertical main datum frame having an opening for receiving a work piece and a horizontal spindle. A counterweight frame together with the datum frame provide the structural members of the CNC machine. A work piece trolley, which has a work piece table which can be rotated from a horizontal mounting position, in which a work piece can be mounted to the work piece table, to a vertical milling position, in which a work piece can be milled is useable to position and hold a work piece in the CNC machine.

### FIELD

This disclosure relates generally to a computer numerical control (CNC) machine, which may comprise a horizontal gantry system. A movable workpiece trolley, which is useable with the NC machine, is also provided.

### INTRODUCTION

The following is not an admission that anything discussed below is part of the prior art or part of the common general knowledge of a person skilled in the art.

Various types of cutting machines are known, including vertical milling machines, horizontal milling machines, and CNC machines, including 3 axis, 4 axis, and 5 axis CNC machines. Further, various designs for rotation and movement of a cutting head as well as rotation and movement of a workpiece are known in the art.

### SUMMARY

This summary is intended to introduce the reader to the more detailed description that follows and not to limit or define any claimed or as yet unclaimed invention. One or more inventions may reside in any combination or sub-combination of the components or process steps disclosed in any part of this document including its claims and figures.

In accordance with one aspect of this disclosure, which may be used alone or in combination with one or more other aspects, a computer numerical control (CNC) machine and a workpiece trolley are provided. The CNC machine comprises a mill body having an internal working volume, a spindle provided in the working volume, and a front side which has a work piece insertion opening. The work piece trolley comprises a work piece holder. The work piece trolley may be movable with respect to the CNC machine between a loading position in which a work piece is mountable to the work piece trolley, and a milling position in which the work piece is positioned to be milled. In the working position, the workpiece trolley may close and optionally seal the insertion opening. Accordingly, the work piece trolley is useable to mount a work piece when spaced from the CNC machine and/or transport a work piece to the CNC machine and/or close the working volume of the CNC machine.

In accordance with this aspect, there is provided a combination of:
(a) a computer numerical control (CNC) machine comprising:
   (i) a mill body comprising a front side, a rear side and opposed lateral sides which enclose a working volume, the front side having a work piece insertion opening; and,
   (ii) a spindle provided in the working volume wherein, when the CNC machine is positioned on a floor, the spindle has an axis of rotation that extends horizontally;
(b) a work piece trolley comprising a work piece holder, the work piece trolley moveable with respect to the CNC machine between a loading position in which a work piece is mountable to the work piece trolley and a milling position in which the work piece is positioned to be milled;

In accordance with another aspect of this disclosure, which may be used alone or in combination with one or more other aspects, a computer numerical control (CNC) machine has a mill body, a main datum frame having that extends vertically, and a spindle with a horizontal axis of rotation provided in a working volume. The front side of the mill body has a work piece insertion opening, which may be provided in the main datum frame. The main datum frame may provide some or all of the structural support for the CNC machine. Accordingly, the rear side and the opposed lateral sides of the mill body may be thin-walled members, e.g., sheet metal, which provide walls for the working volume but are not load bearing. Accordingly, the rear and side walls may be removable for providing access to internal components of the CNC machine, e.g., the spindle, without a need to provide a structural member to support a wall when it is removed.

In accordance with this aspect, there is provided a computer numerical control (CNC) machine comprising:
(a) a mill body comprising a front side, a rear side and opposed lateral sides which enclose a working volume, the front side having a work piece insertion opening;
(b) a main datum frame that extends vertically when the CNC machine is positioned on a floor, the main datum frame has a front face and a rear face; and,
(c) a spindle provided in the working volume wherein, when the CNC machine is positioned on the floor, the spindle has an axis of rotation that extends horizontally.

In accordance with another aspect of this disclosure, which may be used alone or in combination with one or more other aspects, a computer numerical control (CNC) machine has a mill body, a main datum frame that extends vertically and a counterweight which underlies the working volume. Accordingly, a vertical plane may intersect at least a portion of a work piece positioned in the working volume and the counterweight. The spindle, which is provided in the working volume, may have a horizontal axis of rotation. The front side of the mill body may have a work piece insertion opening. An advantage of this design is that the counterweight may be positioned at least partially and, optionally, fully within the perimeter of the mill body thereby providing a compact structure for the CNC machine.

In accordance with this aspect, there is provided a computer numerical control (CNC) machine comprising:
(a) a mill body comprising a front side, a rear side and opposed lateral sides which enclose a working volume, the front side having a work piece insertion opening;
(b) a main datum frame that extends vertically when the CNC machine is positioned on a floor;
(c) a counterweight wherein, when the CNC machine is positioned on a floor, the counterweight underlies the working volume and, when at least a portion of a work piece is positioned in the working volume, a vertical plane intersects the at least a portion of the work piece and the counterweight; and,
(d) a spindle provided in the working volume wherein, when the CNC machine is positioned on the floor, the spindle has an axis of rotation that extends horizontally.

In accordance with another aspect of this disclosure, which may be used alone or in combination with one or more other aspects, a computer numerical control (CNC) machine has a removable coolant tray, which underlies the working volume. The CNC machine may have a vertically extending main datum frame with a workpiece insertion opening provided therethrough. The insertion opening may be on the front side of the CNC machine. An advantage of this design is that the coolant tray may underlie the working volume and may be slidably removable, e.g., on wheels, tracks or the like, from the lower end of the CNC machine.

In accordance with this aspect, there is provided a computer numerical control (CNC) machine comprising:
(a) a mill body comprising a front side, a rear side and opposed lateral sides which enclose a working volume, the front side having a work piece insertion opening;
(b) a main datum frame that extends vertically when the CNC machine is positioned on a floor;
(c) a removable coolant tray that underlies the working volume; and,
(d) a spindle provided in the working volume wherein, when the CNC machine is positioned on the floor, the spindle has an axis of rotation that extends horizontally.

In accordance with another aspect of this disclosure, which may be used alone or in combination with one or more other aspects, a computer numerical control (CNC) machine has a front side which has a work piece insertion opening. A work piece trolley comprises a work piece support surface, and a work piece holder. The orientation of the work piece support surface can be adjusted from a generally horizontal position in which a work piece can be mounted to the work piece holder, and a generally vertical position in which at least a portion of the work piece can be inserted into the working volume through the work piece insertion opening. The work piece trolley may be movable with respect to the CNC machine between a loading position in which a work piece is mountable to the work piece trolley, and a milling position in which the work piece is positioned to be milled. Accordingly, the work piece trolley may have, e.g., a plurality of wheels or the like to enable the work piece trolley to move across a floor. An advantage of this design is that the work piece trolley may both hold a work piece during a milling operation and close a working volume during a milling operation. A further advantage is that the work piece trolley may be positioned to have a work piece mounted thereto while at a distance from the CNC machine, e.g., a work piece storage area, and also transport the mounted work piece to the CNC machine.

In accordance with this aspect, there is provided a combination of:
(a) a computer numerical control (CNC) machine comprising a mill body comprising a front side, a rear side and opposed lateral sides which enclose a working volume, the front side having a work piece insertion opening; and,
(b) a work piece trolley that is discrete from the CNC machine, the work piece trolley comprising a plurality of wheels and a work piece support surface and a work piece holder, the orientation of the work piece support surface is adjustable from a generally horizontal orientation in which a work piece is mountable to the work piece holder and a vertical orientation in which at least a portion of the work piece is insertable into the working volume through the work piece insertion opening.

In accordance with another aspect of this disclosure, which may be used alone or in combination with one or more other aspects, a computer numerical control (CNC) machine comprises a mill body and a work piece support surface. The mill body comprises a front side having a work piece insertion opening, a rear side, and opposed lateral sides, all of which together enclose a working volume. The orientation of the work piece support surface is adjustable from a generally horizontal orientation in which a work piece can be mounted to a work piece holder, which may be part of or removably connectable to the work piece support surface, and a vertical orientation in which at least a portion of the work piece can be inserted into the working volume through the work piece insertion opening. The work piece support surface may be laterally, e.g., forwardly, translatable to enable the work piece support surface to be rotated to an insertion orientation (e.g., to extend vertically) and then translated back towards the CNC machine to enable the work piece to be positioned partially or fully in the working volume. An advantage of this design is that the work piece support surface may be supported by the CNC machine while enabling the work piece support surface to be reconfigured to position the work piece partially or fully in the working volume of the CNC machine.

In accordance with this aspect, there is provided a computer numerical control (CNC) machine comprising:
(a) a mill body comprising a front side, a rear side and opposed lateral sides which enclose a working volume, the front side having a work piece insertion opening; and,
(b) a work piece support surface, the orientation of the work piece support surface is adjustable from a generally horizontal orientation in which a work piece is mountable to a work piece holder and a vertical orientation in which at least a portion of the work piece is insertable into the working volume through the work piece insertion opening;

In accordance with another aspect of this disclosure, which may be used alone or in combination with one or more other aspects, a work piece trolley is provided to transport a work piece to a computer numerical control (CNC) machine. The work piece trolley comprises a trolley frame, a work piece table, e.g., a first work piece table) which is removably mountable to the trolley frame, and a work piece holder. The orientation of the work piece table, a work piece support surface, can be adjusted from a generally horizontal position in which a work piece can be mounted to the work piece holder, and a generally vertical position in which at least a portion of the work piece can be inserted into the working volume through the work piece insertion opening. The work piece holder may be removably mounted to the work piece trolley, e.g., the work piece table. The work piece table may close the work piece insertion opening of the CNC machine. An advantage of this design is that the trolley frame may be used to transport a further work piece, e.g., by placing a second work piece table on the trolley fame while the first work piece table hold a work piece that is being machine by the CNC machine.

In accordance with this aspect, there is provided a combination of:
(a) computer numerical control (CNC) machine comprising a mill body comprising a front side, a rear side and opposed lateral sides which enclose a working volume, the front side having a work piece insertion opening; and,
(b) a work piece trolley that is discrete from the CNC machine, the work piece trolley comprising a trolley frame, a work piece table removably mountable to the trolley frame and a work piece holder, the orientation of the work piece support surface is adjustable from a generally horizontal orientation in which a work piece is mountable to the work piece holder and a vertical orientation in which at least a portion of the work piece is insertable into the working volume through the work piece insertion opening;

In accordance with another aspect of this disclosure, which may be used alone or in combination with one or more other aspects, a work piece support surface is moveable between a horizontal loading position and a vertical milling position. In the horizontal loading position, a work piece is mountable to the work piece support surface. In the vertical milling position, the work piece is positioned in a working volume that is internal of a computer numerical control (CNC) machine. A work piece holder is removably attachable to the work piece support surface. An advantage of this design is that a single work piece support surface may utilize a number of different work piece holders without the different work piece holders to block part of the support surface.

In accordance with this aspect, there is provided a work piece support surface that is moveable between a horizontal loading position in which a work piece is mountable to the work piece support surface and a vertical milling position in which the work piece is positioned in a working volume that is internal of a CNC machine, and a work piece holder that is removably attachable to the work piece support surface.

In accordance with another aspect of this disclosure, which may be used alone or in combination with one or more other aspects, a computer numerical control (CNC) comprises a mill body having a tool bay with an interior door and, optionally, an exterior door. The interior door of the tool bay is movable between a closed position in which the tool bay is isolated from the working volume of the CNC machine and an open position in which the tool bay is accessible from within the working volume, e.g., by the spindle. The spindle may also be operable to open and/or close the interior door.

In accordance with this aspect, there is provided a computer numerical control (CNC) machine comprising:
(a) a mill body comprising a front side, a rear side and opposed lateral sides which enclose a working volume, the front side having a work piece insertion opening;
(b) a spindle provided in the working volume wherein, when the CNC machine is positioned on the floor, the spindle has an axis of rotation that extends horizontally; and,
(c) a tool bay which has an interior door that is moveable between a closed position in which the tool bay is isolated from the working volume and an open position in which the tool bay is accessible from within the working volume.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a perspective view of an example computer numerical control (CNC) machine, in accordance with an embodiment;

FIG. 2 is a perspective view of the CNC machine of FIG. 1, with a work piece trolley secured to the CNC machine;

FIG. 3 is a rear perspective view of the CNC machine of FIG. 1 with the walls forming the mill body removed;

FIG. 4 is a perspective view of the CNC machine of FIG. 1 with a transparent window in the electronics bay door;

FIG. 5 is a perspective view of the CNC machine of FIG. 1 with a transparent window in the tool bay door;

FIG. 6 is a perspective view of a CNC machine with a single joint electronics bay and tool bay door with a user interface (UI);

FIG. 7 is a perspective view of a CNC machine with a single joint electronics bay and tool bay door with an optional slidable UI in a lowered position;

FIG. 8 is a perspective view of the CNC machine of FIG. 1 with the slidable UI in a raised position;

FIG. 9 is a perspective view of a CNC machine with a single joint electronics bay and tool bay door with a transparent window and a slidable UI in a raised position;

FIG. 10 is a perspective view of a work piece trolley having a work piece table in a horizontal position;

FIG. 11 is a perspective view of the work piece trolley of FIG. 10 with the work piece table rotated to a vertical position;

FIG. 12 is a rear perspective view of the work piece trolley of FIG. 11;

FIG. 13 is a perspective view of the work piece trolley of FIG. 11 having a spoil board attached to the work piece table;

FIG. 14 is a perspective view of the work piece trolley of FIG. 11 having a T-slot table attached to the work piece table;

FIG. 15 is a perspective view of the work piece trolley of FIG. 14 having a 2-part vise attached to the T-slot table;

FIG. 16A is a perspective view of the CNC machine of FIG. 1 and an exploded view of the work piece trolley of FIG. 15 with a work piece in position to be secured to the work piece trolley;

FIG. 16B is a perspective view of the CNC machine of FIG. 1 and the work piece trolley of FIG. 16A with the work piece secured thereto;

FIG. 16C is a rear perspective view of the CNC machine of FIG. 1 and the work piece trolley of FIG. 16B with the work piece table in a vertical position;

FIG. 16D is a front perspective view of the CNC machine of FIG. 1 and the work piece trolley of FIG. 16C;

FIG. 16E is a front perspective view of the work piece trolley of FIG. 16C inserting the work piece into the CNC machine of FIG. 1;

FIG. 16F is a front perspective view of the work piece trolley of FIG. 16C with the work piece secured in the CNC machine of FIG. 1;

FIG. 16G is a perspective view of the trolley frame of the work piece trolley of FIG. 16C being removed from the CNC machine of FIG. 1 while leaving the work piece table attached;

FIG. 17 is a perspective view of a work piece trolley having two openable sub doors on the work piece table;

FIG. 18 is a rear perspective view of the work piece trolley of FIG. 17;

FIG. 19 is a perspective view of the work piece trolley of FIG. 17 with the two sub doors opened;

FIG. 20 is a perspective view of the work piece trolley of FIG. 17 loading a work piece into a CNC machine;

FIG. 21 is a front perspective view of a gantry system with a horizontal spindle;

FIG. 22 is a top rear perspective view of the gantry system of FIG. 21;

FIG. 23 is a bottom perspective view of the gantry system of FIG. 21;

FIG. 24 is a rear perspective view of the gantry system of FIG. 21 attached to a main datum frame of a CNC machine;

FIG. 25 is a front perspective view of the gantry system of FIG. 21 attached to the main datum frame of the CNC machine;

FIG. 26A is a perspective view of the gantry system of FIG. 21 attached to a CNC machine in a first touch off position;

FIG. 26B is a perspective view of the gantry system of FIG. 21 attached to a CNC machine in a second touch off position;

FIG. 26C is a perspective view of the gantry system of FIG. 21 attached to a CNC machine in a third touch off position;

FIG. 27A is a perspective view of a CNC machine with variable sealing plates;

FIG. 27B is a perspective view of the CNC machine of FIG. 27A with a work piece contacting the CNC machine;

FIG. 28 is a perspective view of the CNC machine of FIG. 1 with fans on the electronics bay door;

FIG. 29 is a perspective view of the CNC machine of FIG. 28 with the electronics bay door open;

FIG. 30 is a perspective view of the CNC machine of FIG. 4 with the electronics bay door open;

FIG. 31 is a rear perspective view of a CNC machine with the interior tool bay door closed;

FIG. 32 is a rear perspective view of the CNC machine of FIG. 31 with the interior tool bay door open;

FIG. 33 is a perspective view of the CNC machine of FIG. 1 with the electronics bay door and the tool bay door open;

FIG. 34 is a perspective view of the CNC machine of FIG. 6 with the electronics and tool bay door open;

FIG. 35A is a rear perspective view of the CNC machine of FIG. 32 with the spindle awaiting a work tool change;

FIG. 35B is a rear perspective view of the CNC machine of FIG. 32 with the spindle removing a work tool;

FIG. 35C is a rear perspective view of the CNC machine of FIG. 32 with the spindle receiving a new work tool;

FIG. 35D is a rear perspective view of the CNC machine of FIG. 32 with the spindle after the tool change;

FIG. 36 is a rear view of a CNC machine having a three-stage cleaning system;

FIG. 37A is a rear perspective view of the CNC machine of FIG. 36 and a cutting tool in the first cleaning stage;

FIG. 37B is a rear perspective view of the CNC machine of FIG. 36 and a cutting tool in the second cleaning stage;

FIG. 37C is a rear perspective view of the CNC machine of FIG. 36 and a cutting tool in the third cleaning stage;

FIG. 38 is a top perspective view of a coolant tray in accordance with an embodiment;

FIG. 39 is a top perspective exploded view of the coolant tray of FIG. 38 further including a chip tray and porous screen;

FIG. 40A is a perspective view of the coolant tray of FIG. 39 moving towards CNC machine of FIG. 1; and,

FIG. 40B is a perspective view of the coolant tray of FIG. 39 inserted into the CNC machine of FIG. 1.

The drawings included herewith are for illustrating various examples of articles, methods, and apparatuses of the teaching of the present specification and are not intended to limit the scope of what is taught in any way.

### DESCRIPTION OF VARIOUS EMBODIMENTS

Various apparatus, methods and compositions are described below to provide an example of an embodiment of each claimed invention. No embodiment described below limits any claimed invention and any claimed invention may cover apparatuses and methods that differ from those described below. The claimed inventions are not limited to apparatus, methods and compositions having all of the features of any one apparatus, method or composition described below or to features common to multiple or all of the apparatus, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

The terms “an embodiment”, “embodiment”, “embodiments”, “the embodiment”, “the embodiments”, “one or more embodiments,” “some embodiments”, and “one embodiment” mean “one or more (but not all) embodiments of the present invention(s)”, unless expressly specified otherwise.

The terms “including”, “comprising”, and variations thereof mean “including but not limited to”, unless expressly specified otherwise. A listing of items does not imply that any or all of the items are mutually exclusive, unless expressly specified otherwise. The terms “a”, “an”, and “the” mean “one or more”, unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. None of the terms “coupled”, “connected”, “attached”, and “fastened” distinguish the manner in which two or more parts are joined together.

Furthermore, it will be appreciated that for simplicity and clarity of illustration, where considered appropriate, reference numerals may be repeated among the figures to indicate corresponding or analogous components. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

As used herein, the wording “and/or” is intended to represent an inclusive- or. That is, “X and/or Y” is intended to mean X or Y or both, for example. As a further example, “X, Y, and/or Z” is intended to mean X or Y or Z or any combination thereof.

As used herein and in the claims, two components are said to be “parallel” where those components are parallel and spaced apart, or where those components are collinear.

Some components herein may be identified by a part number, which is composed of a base number followed by an alphabetical or subscript-numerical suffix (e.g., 300a, or 300₁). Multiple components herein may be identified by part numbers that share a base number in common and that differ by their suffixes (e.g., 300₁, 300₂, and 300₃). All components with a common base number may be referred to collectively or generically using the base number without a suffix (e.g., 300).

It should be noted that terms of degree such as “substantially”, “about”, and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies. For example, the expressions “substantially perpendicular” and “substantially parallel” mean within 10% of perpendicular and parallel, respectively.

### General Description of a CNC Machine

The following is a general description intended to provide a basis for understanding several of the features that are discussed herein. As discussed in detail subsequently, each of the features may be used alone, or in combination, in any embodiment such as the exemplary embodiments described herein.

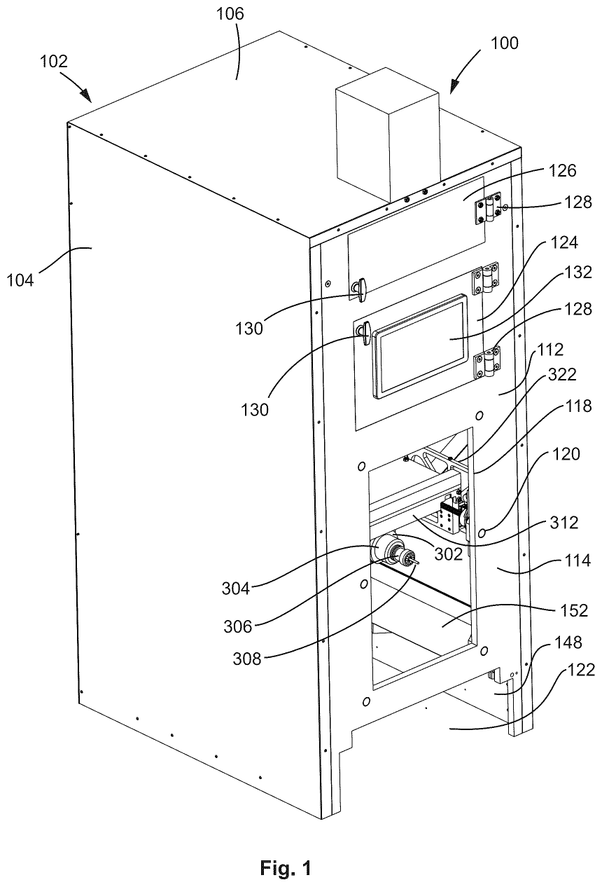

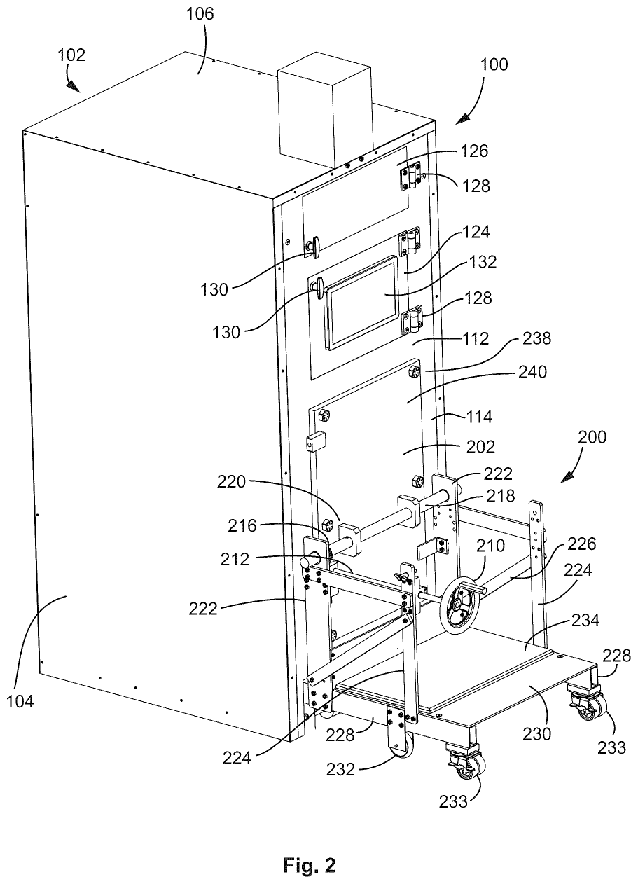

FIGS. 1 and 2 show an example embodiment of a computer numerical control (CNC) machine 100. A CNC machine is a semi-automated or fully automated machine that is programmed to control operations and movements. A CNC machine follows instructions programmed by a user or given to the machine, allowing for precise and quick machining of complex parts or components using a spindle. A CNC machine can often move the spindle about several axes, offering more maneuverability and options for machining than a typical lathe or mill. Different tooling options are available for cutting different materials or providing bigger or smaller cuts.

The working volume of the CNC machine 100 is defined by a mill body 102, which surrounds the machine to create an enclosed area. Tooling of a workpiece may be done in the enclosed area in order to prevent shavings, dust, coolant, or any other byproducts of the machining process from being dispersed outside of the working volume of the CNC machine 100. The working volume of the CNC machine 100 further comprises a tooling mechanism to machine the workpiece that is inside the CNC machine 100. The tooling mechanism is translatable in multiple axes to machine different areas of the workpiece. The tooling mechanism may further be rotatable in multiple axes to machine different areas of the workpiece.

Operation of the CNC machine 100 includes a trolley 200 which is used to move the workpiece into position within the enclosed area defined by mill body 102. The workpiece may be loaded or mounted onto the trolley before the trolley 200 is moved into position. The trolley 200 is configured to interface with mill body 102 in order to immovably secure the workpiece into the enclosed area defined by mill body 102.

### Detailed Discussion of Particular Features

The foregoing general description is intended to provide a basis for understanding several of the features that are discussed herein. It will be appreciated that any embodiment, such as the example embodiments described herein, may use any one or more of the features as described in the general description. Similarly, any embodiment may use any one or more of those features as described in greater detail in the following detailed discussion of particular configurations.

### Mill Body

A CNC machine using any one or more aspects discussed herein may have a mill body that defines an enclosed working volume.

The mill body 102 may define any shape for the enclosed working volume, including spherical, triangular, cubic, cylindrical, conic, or any other non-uniform or irregular structure. For example, if the mill body 102 is rectangular as exemplified in FIG. 1, then the mill body 102 may form a cuboid working volume defined by a left wall 104, a top wall 106, a right wall 108, a rear wall 110 a lower wall and a front wall. As exemplified and as discussed in more detail subsequently, the front wall may comprise or consist of a main datum frame 112 and/or the floor may be a lower wall and optionally a removable tray.

To define the cuboid working volume, the left wall 104 may be substantially parallel to the right wall 108, and the rear wall 110 may be substantially parallel to the main datum frame 112. To further define the cuboid working volume, one vertical edge of the left wall 104 may be affixed to one vertical edge of the rear wall 110 at about a 90° angle, and the other vertical edge of the left wall 104 may be affixed to one vertical edge of the main datum frame 112 at about a 90° angle. Similarly, one vertical edge of the right wall 108 may be affixed to the other vertical edge of the rear wall 110 at about a 90° angle, and the other vertical edge of the right wall may be affixed to the other vertical edge of the main datum frame 112 at about a 90° angle. Each one of the horizontal edges of the top wall 106 may be affixed to the top edge of one of the left wall 104, the right wall 108, the rear wall 110, and the main datum frame 112. Optionally, a lower wall may be affixed to the lower edge of one of the left wall 104, the right wall 108, the rear wall 110, and the main datum frame 112.

Any combination of the left wall 104, top wall 106, right wall 108, lower wall and rear wall 110 may be removably or permanently affixed to each other and/or to main datum frame 112 to create the mill body 102. For example, the left wall 104, right wall 108, and rear wall 110 may be permanently affixed to one another, and the combination may be removably affixed to top wall 106 and main datum frame 112. If one or more of the left wall 104, the top wall 106, the right wall 108, and the rear wall 110 are removed, the working volume may no longer be completely enclosed and may be accessible. The walls 104, 106, 108, and 110 may be affixed to each other via fasteners, such as screws, nails, rivets, bolts, and the like. Alternately or in addition, the walls 104, 106, 108, and 110 may be affixed to each other via adhesive means, such as glue, epoxy, and the like.

Walls 104, 106, 108, and 110 may be made of a non-load bearing member and/or the walls may be made of the same material, such as sheet metal. The sheet metal may be made of any suitable material, such as carbon steel, stainless steel, aluminum, cold rolled steel, galvanized steel, copper, brass, alloy steel, and the like. Alternatively, walls 104, 106, 108, and 110 may be made out of a different rigid material, such as high-density polyethylene, acrylic, or carbon fiber. Any of walls 104, 106, 108, and 110 may be made of the same or different material as each other. Any of walls 104, 106, 108, and 110 may be of the same or different thickness as each other.

Walls 104, 106, 108, and 110 may have any suitable dimensions to form a mill body 102 of any size. In an embodiment, the mill body 102 may have a height of less than 80 inches, and a width of less than 36 inches. That is, left wall 104, rear wall 110, and right wall 108 may have a vertical height of less than 80 inches, and rear wall 110 and top wall 106 may have a horizontal width of less than 36 inches. Main datum frame 112 may also have a vertical height of less than 80 inches and a horizontal width of less than 36 inches. In an embodiment, the dimensions of the mill body 102 ensure that the CNC machine 100 can be translated upright through a standard doorway opening with a width of 36 inches and a height of 80 inches.

In an alternate embodiment, one or more of the left wall 104, the top wall 106, the right wall 108, and the rear wall 110 may be formed out of the same metal sheet and bent into approximately 90° angle. For example, a large metal sheet may be bent at two approximately 90° angles to form the left wall 104, the rear wall 110, and the right wall 108. As a result, the substantially vertical walls 104, 108, and 110 are comprised of a monolithic component. In an alternate embodiment, one or more of walls 104, 106, 108, and 110 may be cast from a mold. For example, hot liquid metal may be cast into a mold containing a “U” shape. As a result, the substantially vertical walls 104, 108, and 110 are comprised of a monolithic component. The above examples are merely meant for illustration of an exemplary case and are in no way limiting to a preferred embodiment or fixed process.

### Main Datum Frame

In accordance with this aspect, which may be used by itself or with one or more of the other aspects set out herein, a CNC machine may have a main datum frame that extends upwardly. For example, the main datum frame may extend generally vertically with respect to the floor when the CNC machine is in use.

Accordingly, the main datum frame 112 may be one of the structural frame members of the CNC machine and it may be the only vertically extending structural frame member. Accordingly, the main datum frame 112 may be the component to which other components are attached, directly or indirectly. For example, a gantry system for a spindle may be mounted to the main datum frame. Alternately, or in addition, one or more of the walls that define a working volume, a counterweight and a removable coolant tray may be directly mounted to the main datum frame 102.

For example, as exemplified in FIGS. 1, 2 and 3, the mill body 102 is partially comprised of a main datum frame 112 having a front face 114 outside the working volume of the CNC machine 100 and a rear face 116 inside the working volume of the CNC machine 100. The main datum frame 112 extends vertically and is substantially parallel to the left wall 104, right wall 108, and rear wall 110.

It will be appreciated that the main datum frame 112 may be permanently or removably affixed to the left wall 104, the right wall 108, and the top wall 106 via fastening or adhesive means as described previously.

It will also be appreciated that the main datum frame 112 may be the same height as walls 104, 108, and 110, may be slightly taller than walls 104, 108, and 110, or may be slightly shorter than walls 104, 108, and 110. The main datum frame 112 may be the same width as rear wall 110, may be slightly wider than rear wall 110, or may be slightly narrower than rear wall 110.

The front face 114 and rear face 116 of the main datum frame 102 may be planar and they may be ground or machined to be parallel to each other.

The main datum frame 112 may be load bearing and, accordingly, it may have a thickness equal to, greater than, or less than any of walls 104, 106, 108, and 110.

The main datum frame may be made from the same or a different material than any of walls 104, 106, 108, and 110, such as carbon steel, stainless steel, aluminum, cold rolled steel, galvanized steel, copper, brass, alloy steel, and the like. In an embodiment, the main datum frame 112 may be made from more than one type of material. In embodiments where the main datum frame 112 is made from more than one type of material, the differing materials may be layered between the front face 114 and rear face 116. In a non-limiting example, the front face 114 and rear face 116 may be comprised of the same material, such as stainless steel, and may be separated by a layer of an insulating material disposed between the front face 114 and the rear face 116. It will be appreciated that any number of layers comprising any number of materials could be disposed between the front face 114 and the rear face 116. The main datum frame 112 may be made from a solid piece of material, or may be produced by welding, soldering, or otherwise combining two or more components. In an embodiment where the main datum frame 112 is made through combining two or more components, the two or more components may be composed of the same or different material.

The shape of the main datum frame 112 may be substantially rectangular. Alternately, for example, if access to a coolant tray or a chip tray is provided in the same face of the mill body 102 as the main datum frame, 112, then the lower end of the main datum frame 112 may terminate above the floor and/or a recess 112 may be provided therein (see, e.g., FIG. 1). The recess 122 may extend from a section of the main datum frame 112 to the floor, such that a portion of the bottom edge of main datum frame 112 does not make contact with the floor. The recess 122 may have a substantially rectangular shape, or may have an irregular shape, such as a rectangle with notched corners. In an embodiment, the recess may be as wide or almost as wide as main datum frame 112.

As illustrated in FIG. 1, the main datum frame 112 may have a through opening 118 which facilitates insertion of a work piece into the working volume of mill body 102. The opening 118 may have any shape, such as circular, rectangular, triangular, elliptical, square, trapezoidal, or any irregular or non-uniform shape. The opening 118 may additionally be of any size. The opening 118 may be located anywhere on the plane of the main datum frame 112 parallel to the front face 114 and rear face 116. As exemplified in FIG. 1, the opening 118 is substantially rectangular and is centered along a central vertical axis of main datum frame 112. Alternately or in addition, the opening 118 may be approximately half of the height of the main datum frame 112, and/or may be approximately half of the width of the main datum frame 112. It will be appreciated that the main datum frame 112 may extend around the entire perimeter of the opening 118 or part thereof. For example, the opening 118 may be a U-shaped recess in the main datum frame 112 (e.g., a lower side of the opening 118 need not be formed by the main datum frame 112) and the lower part of the front wall of the mill body 102 may be formed, e.g., of sheet metal.

In an embodiment, more than one opening 118 may be present on the main datum frame 112. In embodiments comprising more than one opening 118, the plurality of openings 118 may have identical or differing shapes. Similarly, in these embodiments, the plurality of openings may have identical or differing sizes. In embodiments comprising more than one opening 118, the plurality of openings 118 may be located along a same axis, such as a central vertical axis of the main datum frame 112, or a horizontal axis of the main datum frame 112. Alternately, the plurality of openings 118 may be disposed anywhere on the plane of the main datum frame 112 parallel to the front face 114 and rear face 116.

The opening or openings 118 may be closed an opening closing member, such as a door that is affixed to or removably affixed to the mill body (e.g., the main datum frame 112). Alternately, as discussed in more detail subsequently a work piece table 202 of a work piece trolley 200 may act as a door to close the working volume during a milling operation.

In order to secure an opening closing member, such as a door or the work piece table 202, in position, one or more fastening holes 120 may partially or fully surround the opening 118. The fastening holes may receive (optionally removably receive) a fastener, such as a screw or bolt. Accordingly, an openable door may be pivotally mounted to the main datum frame 112 by one or more fasteners that are received in fastening holes 120 or a work piece table 202 may be secured overlying the opening 118 by one or more fasteners 120. Alternately or in addition, fastening holes 120 may function as alignment holes to receive an alignment member, such as a pin. In this latter case, the opening closure member may be secured in place by a fastener which engages another portion of the mill body 102.

The fastening holes 120 may mimic the shape of opening 118 at an offset or may be a defined shape separate from the shape of opening 118. For example, the fastening holes 120 may always be oriented in a vertically elongated rectangular shape, regardless of the shape of the opening 118. In embodiments comprising more than one opening 118, one or more of the openings 118 of the plurality of openings 118 may be separately surrounded by fastening holes 120 or may share a set of fastening holes 120. For example, in an embodiment comprising two rectangular openings 118, one disposed vertically above the other, both openings 118 may be surrounded by one set of fastening holes 120. Alternately, for the same embodiment comprising two rectangular openings 118, each opening 118 may be surrounded by a respective set of fastening holes 120. Alternately, for the same embodiment comprising two rectangular openings 118, both openings 118 may be surrounded by one set of fastening holes 120, and may further share a set of fastening holes 120 disposed between the two openings 118. Although specific configurations have been described above, it will be appreciated that these configurations are merely exemplary, and any configuration with respect to arrangement of openings 118 and fastening holes 120 may be possible.

Fastening holes 120 may be through holes, may be blind holes (i.e., holes that do not penetrate the entire thickness) on the front face 114 of main datum frame 112, or may be any combination of the two. In any embodiment, fastening holes 120 may be further be straight holes, may be tapped or threaded holes, or may be any combination of the two. Alternately or in addition, fastening holes 120 of any type may have a counterbore, countersink, or any combination of the two on the front face 114 of main datum frame 112. Alternately or in addition, fastening holes 120 may be tapered holes, with the diameter of the fastening hole 120 being the largest on front face 114 of the main datum frame 112. Any of fastening holes 120 may instead be a slot with varying lengths. In an embodiment where one or more of fastening holes 120 are slots, the slot may have a fixed diameter or may have a variable diameter over the length of the slot. Alternately or in addition, any one of fastening holes 120 may be a keyhole slot. Any such fastening hole 120 may receive a fastener and/or an alignment member, such as an alignment pin.

As discussed in more detail subsequently, the mill body 102 may have one or more openable volumes (which may be referred to as bays) that are optionally separate (optionally sealed) from the working volume during a milling operation and/or optionally selectively accessible from the exterior of the mill body 102. For example, the openable volumes may be an electronics bay and/or a tool bay. If an electronics bay and a tool bay are provided, they may be separated bays, each of which may have an openable interior door to enable access from within the working volume and/or an exterior door to enable access by a user from the exterior of the CNC machine. Alternately, the tools and electronics may be provided in a combined electronics and tool bay, which may have an openable interior door to enable access from within the working volume and/or an exterior door to enable access by a user from the exterior of the CNC machine. It will be appreciated that the access to one or more of these bays from exterior of the CNC machine may be through the main datum frame 112. Therefore, the main datum frame 112 may have one or more opening which provide access to one or more bays. Accordingly access doors, such as doors 124 and 126 which are discussed subsequently may be provided on the mill body 102 and may be on the main datum frame 112.

### Counterweight Frame

In accordance with this aspect, which may be used by itself or with one or more of the other aspects set out herein, a CNC machine may have a counterweight frame to position the center of gravity of the CNC machine (with and without a workpiece in the working volume) at a location within a perimeter of the working volume and, optionally, generally centered within the perimeter (i.e., generally centered between the front and rear sides of the working volume and generally centered between the left and right sides of the working volume). Optionally, the counterweight frame may also provide a structure that enables a forklift or the like to pick up the CNC machine and move the CNC machine to another location.

The counterweight frame provides a mass which, when combined with the main datum frame 112, positioned a center of gravity of the CNC machine within the working volume. Optionally, the center of gravity is below the midpoint height of the CNC machine and optionally in the lower end of the CNC machine. For example, if the height H of the CNC machine is 80 inches, then the center of gravity may be less than 40 inches (½ H) from the floor, less than 20 inches (¼ H) from the floor or less than 16 inches (⅕ H) from the floor. Accordingly, the lower frame members (e.g., left lower frame member 146 and right lower frame member 148 as discussed subsequently) may be sized to provide sufficient mass to position the center of gravity within the perimeter of the working volume and at the lower end of the CNC machine.

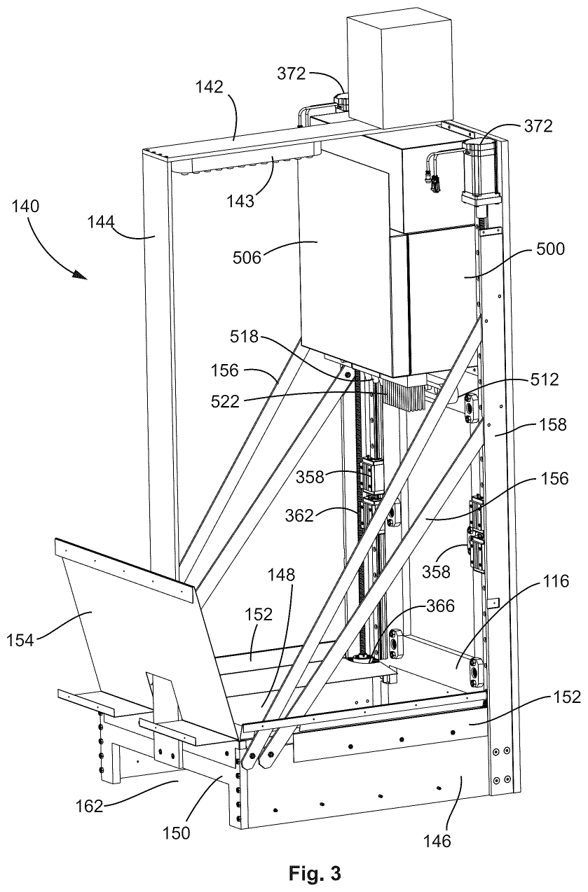

Optionally, as best exemplified in FIG. 3, a counterweight frame 140 may be removably or permanently affixed to the rear face 116 of main datum frame 112.

The counterweight frame may comprise or consist of one or more components provided at the lower end of the CNC machine which, in combination with the main datum frame 112, positions the center of gravity of CNC machine 100 towards the center of the perimeter of the working volume and below the midpoint height of the CNC machine, and optionally lower. Accordingly, the counterweight frame may comprise a lower section as discussed subsequently and optionally also an upper section as discussed subsequently.

For example, the counterweight frame 140 may be comprised of an upper section and a lower section, the upper section being further comprised of an upper frame member 142 and a vertical frame member 144. The upper frame member 142 may be attached to the rear face 116 of main datum frame 112 on one end, and the other end may extend substantially horizontally towards rear wall 110, where it may be attached to and/or rest on top of vertical frame member 144. The upper frame member 142 may be attached to the rear face 116 of the main datum frame 112 and the top of vertical frame member 114 by any attachment means as previously described, such as adhesive means or fastening means. In an embodiment, one end forms a substantially 90° angle at the attachment point with the rear face 116 of the main datum frame 112, and/or the other end forms a substantially 90° angle at the attachment point with vertical frame member 144. In an embodiment, both upper frame member 142 and vertical frame member have a substantially rectangular shape.

In an embodiment, upper frame member 142 and vertical frame member 144 may be composed of the same material. In an embodiment, it may be advantageous for upper frame member 142 and vertical frame member 144 to be composed of a solid, heavy material such as steel, tungsten, titanium, or iron, such that in combination with the main datum frame 112, the center of gravity of CNC machine 100 is adjusted towards the center of the perimeter of the working volume. In an embodiment, the upper frame member 142 and vertical frame member 144 may be made out of different materials. In an embodiment, the upper frame member 142 and vertical frame member 144 may have the same thickness and width. In an embodiment, the length of the upper frame member 142 (i.e., the extension in the horizontal direction) may be shorter than the length of the vertical frame member 144 (i.e., the extension in the vertical direction). In an embodiment, the length of the upper frame member 142 may be the same or substantially similar to the depth of top wall 106. In an embodiment, the length of the vertical frame member 144 may be substantially similar to the height of left wall 104, right wall 108, and/or rear wall 110.

In an embodiment, upper frame member 142 and vertical frame member 144 may be formed of the same material such that they form a single monolithic component. In this embodiment, the component comprising upper frame member 142 and vertical frame member 144 may be created by any method previously described, such as by bending, machining, molding, forming, or any other similar means.

The lower section of counterweight frame 140 may be comprised of a left lower frame member 146, a right lower frame member 148, and a rear lower frame member 150. Left lower frame member 146 and right lower frame member 148 may both extend substantially horizontally along the floor from the rear face 116 of main datum frame 112 towards rear wall 110, and rear lower frame member 150 may extend substantially horizontally along the floor to connect to both left lower frame member 146 and right lower frame member 148, such that the lower portion of counterweight frame 140 is positioned beneath the enclosed working volume of mill body 102 and may underlie the perimeter of the working volume.

Left lower frame member 146 and right lower frame member 148 may both be permanently or removably affixed to the rear face 116 of main datum frame 112, as well as to a left side and a right side respectively of rear lower frame member 150, by any adhesive or fastening means as previously described. In an embodiment, both left lower frame member 146 and right lower frame member 148 may have the same dimensions (i.e., length, width, and thickness), and may both be substantially rectangular. In an embodiment, both left lower frame member 146 and right lower frame member 148 may be attached to the rear face 116 of main datum frame 112 at substantially a 90° angle. Alternately or in addition, both left lower frame member 146 and right lower frame member 148 may be attached to rear lower frame member at substantially a 90° angle, such that left lower frame member 146 and right lower frame member are parallel to each other, and both are perpendicular to rear lower frame member 150 and main datum frame 112.

In a further embodiment, left lower frame member 146, right lower frame member 148, and rear lower frame member 150 may be composed of the same material. In a further embodiment, left lower frame member 146, right lower frame member 148, and rear lower frame member 150 may be composed of the same material as upper frame member 142 and vertical frame member 144. It may be similarly advantageous for left lower frame member 46, right lower frame member 148, and rear lower frame member 150 to be composed of a heavy, solid material such that in combination with the main datum frame 112, the center of gravity of CNC machine 100 is adjusted towards the center of the perimeter of the working volume, and is further adjusted to the lower end of the CNC machine.

In an embodiment, left lower frame member 146, right lower frame member 148, and rear lower frame member 150 may be formed of the same material such that they form a single monolithic component. In this embodiment, the component comprising left lower frame member 146, right lower frame member 148, and rear lower frame member 150 may be created by any method previously described, such as by bending, machining, molding, forming, or any other similar means or any combination thereof.

In an embodiment, the lower end of vertical frame member 144 may be permanently or removably attached to rear lower frame member 150 via any adhesive or fastening means as previously described. Alternately, the upper section and lower section of counterweight frame 140 may be composed of a single material such that the entire counterweight frame 140 is comprised of a single monolithic component. In this embodiment, the single component comprising the entire counterweight frame 140 may be created by any method previously described, such as by bending, machining, molding, forming, or by any other similar means or any combination thereof.

The main datum frame 112 may be mounted (optionally removably mounted) to the counterweight frame. Accordingly, for example, datum support frames 158, 160 may be provided. These may be part of the counterweight frame. The datum support frames 158, 160 provide structural members that support the main datum frame 112 and/or a mount for the gantry.

The datum support frames 158, 160 may be permanently or removably attached to the left side and the right side respectively of the rear face 116 of main datum frame 112 via adhesive or fastening means as previously described. In an embodiment, the datum support frames 158, 160 extend substantially vertically from the floor, and are additionally removably or permanently attached to left lower frame member 146 and right lower frame member 148 respectively.

Optionally, one or more diagonal support bars 156 may be attached to either one of the left lower frame member 146 or the right lower frame member 148 and further to a left datum support frame 158 or right datum support frame 160. In an embodiment, more than one diagonal support bar 156 is attached to the left lower frame member 146 and the left datum support frame 158. Alternately or in addition, more than one diagonal support bar 156 may be attached to right lower frame member 148 and right datum support frame 160. In an embodiment, the one or more diagonal support bars 156, the left datum support frame 158, and the right datum support frame 160 are composed of the same material as any or all of upper frame member 142, vertical frame member 144, left lower frame member 146, right lower frame member 148, and rear lower frame member 150.

It will be appreciated that counterweight frame 140 is comprised of heavy, rigid materials such that the combined weight of all component(s) in the counterweight frame 140 may be substantially heavier than the combined weight of walls 104, 106, 108, 110 forming the enclosed working space. As a result, a person of skill in the art would understand that the walls 104, 106, 108, and 110 need not be load bearing, structural elements of CNC machine 100 and may not substantially affect the location of the center of gravity of CNC machine 100 compared to the counterweight frame 140. It will further be appreciated that any or all of walls 104, 106, 108, 110 can be affixed to the counterweight frame 140, or can be removed entirely from contact with the counterweight frame 140 without impacting the structural rigidity of the CNC machine 100.

As discussed subsequently, a tray such as a coolant tray 600 may be provided at the lower end of the CNC machine and may be exposed to (underlie) the working volume. Accordingly, one or more directing members may be provided to direct spent coolant or parts removed from a workpiece during a milling operation to be directed to the tray. Accordingly, one or more funnel sheets 152 may be permanently or removably attached to the left lower frame member 146, the right lower frame member 148, and/or the rear lower frame member 150 via adhesive or fastening means as previously described. The funnel sheets 152 may be angled downwardly to direct material into a tray. In an embodiment, the one or more funnel sheets 152 may be composed of a thin, lightweight material, such as sheet metal. Alternately, the one or more funnel sheets 152 may be composed of the same material as one or more of walls 104, 106, 108, 110. The one or more funnel sheets 152 may be shaped and may abut each other such that there is no gap between edges of adjacent funnel sheets 152.

The directing member may alternately or in addition include one or more support sheets 154. The support sheet(s) may be further permanently or removably attached to the rear lower frame member 150 via adhesive or fastening means as previously described, and may be shaped such that it does not intersect with or contact vertical frame member 144. The support sheet(s) 154 may additionally be permanently or removably attached to rear wall 110 via adhesive or fastening means as previously described. Alternately, the support sheet(s) may not be attached to rear wall 110 and may be configured only to contact rear wall 110. As exemplified, the support sheet 152 may be angled downwardly and inwardly so as to direct material into a tray.

As illustrated in FIG. 3, the rear lower frame member 150 may contain a recess 162 which may be used to enable the CNC machine to be moved. Recess 162 may be used concurrently with recess 122.

As exemplified in FIG. 3., recess 162 may extend from a section of the rear lower frame member 150 to the floor, such that a portion of the bottom edge of rear lower frame member 150 does not contact the floor. The recess 162 may be as wide as or almost as wide as the rear lower frame member. In an embodiment, the recess 162 in the lower frame member 150 corresponds substantially in shape, size, and horizontal and vertical alignment with the recess 122 in main datum frame 112. Accordingly, an arm, fork, or prong of a carrier such as a pallet truck or forklift may be inserted into recesses 122, 162 (e.g., through the front recess 122 and then through the rear recess 162) such that the CNC machine 100 is movable over the floor in an upright position.

Alternately or in addition rollers, which may be vertically adjustable, may be permanently or removably attached to one or more of the main datum frame 112, the left lower frame member 146, the right lower frame member 148 and the rear lower frame member 150. The vertically adjustable rollers may be situated such that in a retracted position, the rollers do not contact the floor, and in an extended position, the rollers contact the floor and lift main datum frame 112, left lower frame member 146, right lower frame member 148, and rear lower frame member 150 off of the floor. Actuation of the vertically adjustable rollers may be done manually, by electronic means, by hydraulic means, by pneumatic means, by electro-mechanical means, or by any combination therein. Once the CNC machine 100 is lifted out of contact with the floor on the vertically adjustable rollers, the CNC machine 100 may be movable over the floor in an upright position on the rollers. It will be appreciated that any type of ground engaging member may be used such as a ground engaging member comprising wheels, tank treads or the like.

### Work Piece Trolley

In accordance with this aspect, which may be used by itself or with one or more of the other aspects set out herein, a work piece trolley may be provided to move and/or secure a work piece to a CNC machine.

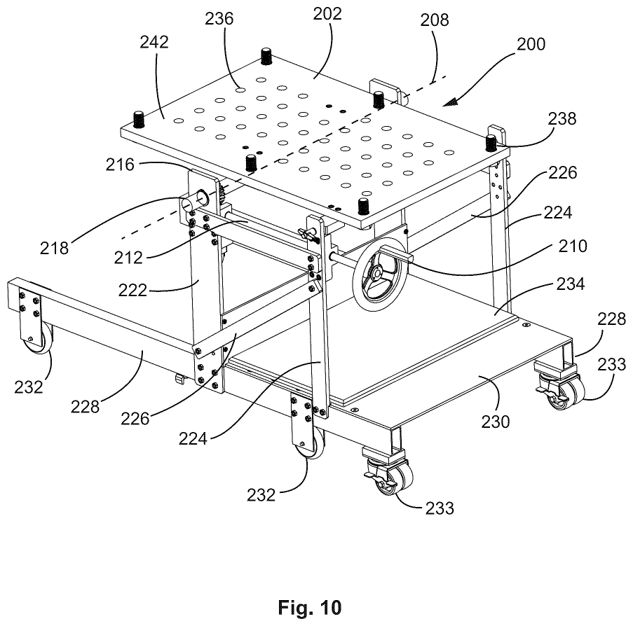

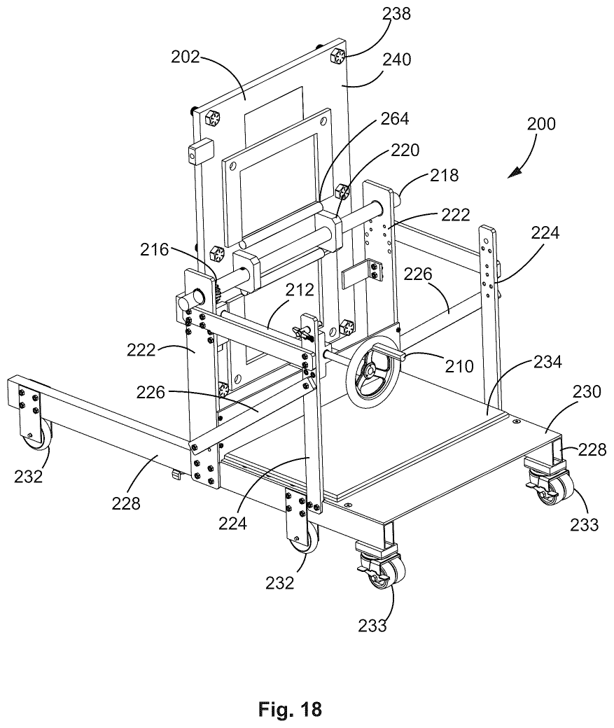

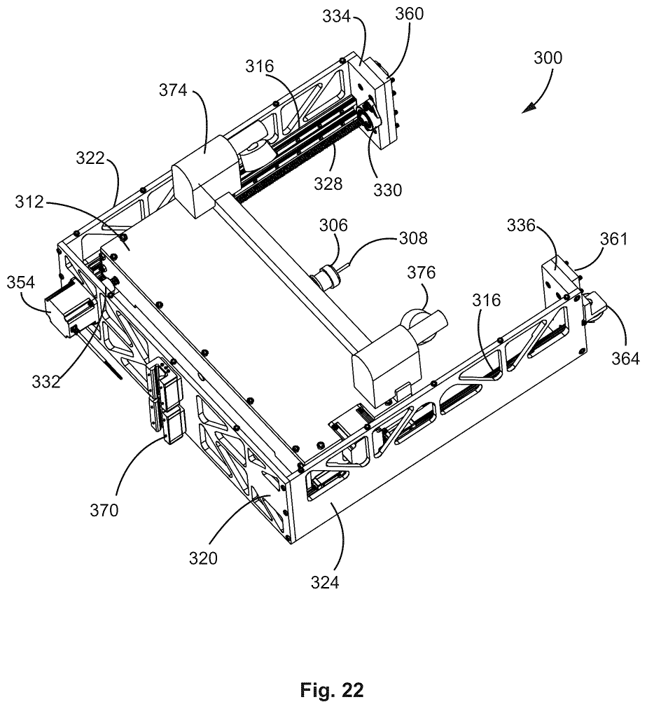

A workpiece trolley provides a stable support for receiving and maintaining a workpiece in position while the workpiece is moved along a floor from a workpiece loading or unloading position to a CNC machine. Accordingly, as exemplified in FIGS. 10-26, a work piece trolley 200 may principally be comprised of a work piece table 202, an optional work piece table rotation mechanism 204, and a movable support structure 206.

The workpiece trolley may also be used to secure the workpiece in position to be milled, such as being partially or fully inserted into the working volume of the CNC machine and optionally to seal the working volume with the workpiece inserted therein.

Accordingly, as exemplified in FIGS. 2 and 10-26, a work piece may be removably affixed to work piece trolley 200, which may move the work piece outside of CNC machine 100 and secure the work piece into the opening 118 of main datum frame 112.

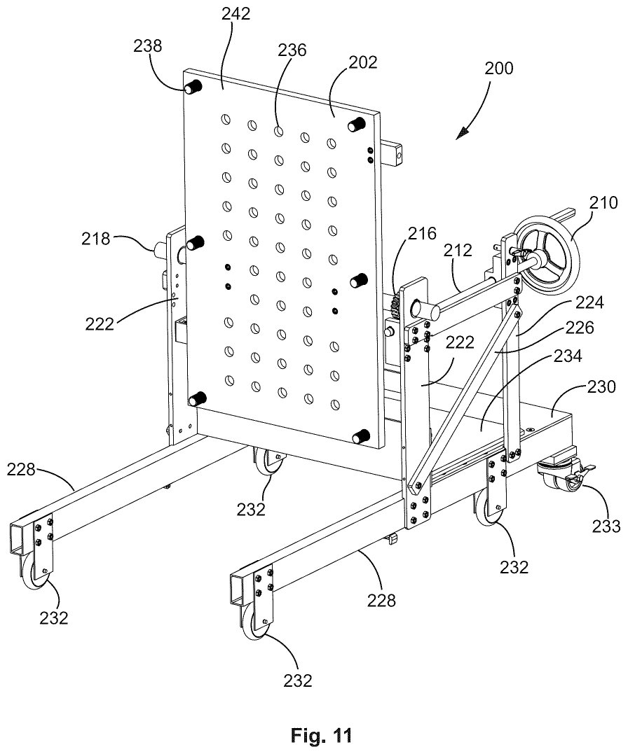

Optionally, a workpiece may be mounted to the work piece table 202 while the work piece table 202 is oriented generally horizontally, as exemplified in FIG. 10, and then reoriented so as to be able to align the workpiece with the opening 118 of the CNC machine. Accordingly, the work piece table 202 may be configured to rotate up to 90° about an axis of rotation 208, such as through actuation of the work piece table rotation mechanism 204. The work piece table 202 may lie completely or substantially horizontal in a first (loading) position (FIG. 10), and may lie completely or substantially vertical in a second (working) position (FIG. 11). The axis of rotation 208 may correspond with the central horizontal axis of the work piece table 202 (e.g., central between the front and rear sides of the work piece table 202). In an embodiment, the axis of rotation 208 may instead be offset from the central horizontal axis of work piece table 202, such that work piece table 202 does not rotate around its central horizontal axis.

Optionally, the height of the work piece table 202 may be adjustable if needed to align the workpiece with the opening. For example, in the loading position, the work piece table 202 may have a height such that, when rotated to the working position, the work piece table 202 positions the workpiece to be inserted through the opening 118 and optionally to also align the work piece table 202 such that fasteners may be used to secure the work piece table 202 to the CNC machine using fastening holes 120. Alternately, the height of the workpiece may be adjusted, w.f., the height of the work piece table 202 may be adjusted to provide this alignment.

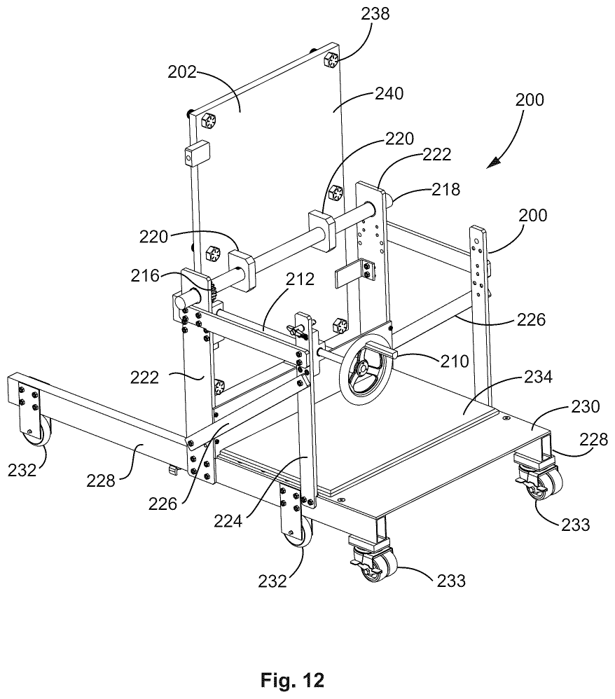

The work piece table 202 may be rotated and/or raised manually. Alternately, as exemplified in FIG. 12, the work piece table rotation mechanism 204 may include a system that provides a mechanical advantage to an operator of the mechanism, such as a gearing system, such that a single person operating the mechanism can exert sufficient force to effect the rotation of work piece table 202 from the first position to the second position. For example, the work piece table rotation mechanism 204 may be composed of a wheel 210 which is permanently or removably attached to one end of a wheel rod 212. The other end of wheel rod 212 may be permanently or removably attached to a wheel rod gear 214, which may be in physical gearing contact with a work piece table rod gear 216.

In an embodiment, the wheel rod gear 214 and the work piece table rod gear 216 may contact each other at an angle, such as a 90° angle. In order to effect the change in direction, one of either wheel rod gear 214 or work piece table rod gear 216 may be a worm gear. In another embodiment, one or both of wheel rod gear 214 and work piece table rod gear 216 may be a helical gear. In a further embodiment, one or both of wheel rod gear -29-214 and work piece table rod gear 216 may be a bevel gear. Alternately or in addition to any one of the embodiments listed above, one or both of wheel rod gear 214 and work piece table rod gear 216 may be spur gears.

Work piece table rod gear 216 may be permanently or removably attached to work piece table rod 218, which may be movably supported by one or more of work piece rod support mounts 222 such that rotation of work piece table rod 218 is allowed. To facilitate rotation of work piece table rod 218, bearings may be disposed in an opening in work piece rod support mounts 222. Alternately, the opening in work piece rod support mounts 222 may be slightly or substantially larger than the diameter of the work piece table rod 218. Work piece table rod 218 may be further permanently or removably attached to one or more work piece table holding members 220, which may be permanently or removably attached to the rear face 240 of the work piece table 202. In an embodiment, the one or more work piece table holding members 220 are attached to the rear face 240 of work piece table 202 such that the work piece table rod 218 lies below a central horizontal axis of the work piece table 202, so as to rotate the work piece table 202 about an axis of rotation 208 that is offset from the central horizontal axis of the work piece table 202.

The wheel rod 212 may be further movably supported by a wheel rod support mount 224, which may support wheel rod 212 while allowing rotation of wheel rod 212. To facilitate rotation of wheel rod 212, bearings may be disposed in an opening in wheel rod support mount 224. Alternately, the opening in wheel rod support mount 224 may be slightly or substantially larger than the diameter of the wheel rod 212. Wheel rod support mount 224 may be attached to a work piece rod support mount 222 via one or more frame supports 226, which may be permanently or removably attached to one or both of work piece rod support mount 222 and wheel rod support mount 224.

As illustrated in FIG. 12, the side of the work piece trolley 200 without the work piece table rotation mechanism 204 (i.e., the right side in FIG. 12) may also contain a wheel support mount and one or more frame supports 226. In an embodiment, as the components of work piece table rotation mechanism 204 may be removably attached to each other, disassembly and reassembly of work piece table rotation mechanism 204 may be possible such that work piece table rotation mechanism can be disposed on the other side of the work piece trolley 200. For example, in the embodiment illustrated in FIG. 12, the assembly containing the work piece table rod 218 and the work piece table rod gear 216 could be removed from work piece rod support mounts 222 and work piece table holding members 220 and rotated 180°, such that the work piece table rod gear 216 is now disposed on the right side of work piece trolley 200. Similarly, the assembly containing the wheel 210, the wheel rod 212, and the wheel rod gear 214 may be attached to the other wheel rod support mount 224 such that the wheel rod gear 214 is now in gearing connection with the newly positioned work piece table rod gear. As a result, rotation of the work piece table 202 can be effected from either end of the work piece trolley 200, and the work piece table rotation mechanism 204 may be altered to suit the needs of the operator.

In an embodiment, the work piece table rotation mechanism 204 may include more than one wheel 210, wheel rod 212, wheel rod gear 214, and work piece table rod gear 216, so that the work piece table rotation mechanism may be actuated from either end of the work piece trolley 200 without requiring disassembly and reassembly of the work piece table rotation mechanism 204.

Advantageously, the work piece table rotation mechanism 204 provides a way for an operator to rotate work piece table 202 without exerting a large amount of force, as may typically be required for movement or rotation of objects of similar size and weight. Further, by positioning wheel 210 away from gears 214, 216, the work piece table rotation mechanism 204 removes the operator from pinch points or contact points of the work piece trolley 200, providing a safer alternative to adjusting the rotation of the work piece table 202 manually and directly.

Although a certain configuration of the work piece table rotation mechanism 204 has been illustrated and described, it will be appreciated that other work piece table rotation mechanisms are possible, which may be used instead of or in addition to the mechanism previously described. For example, instead of wheel 210, the workpiece table rod 218 may be actuated via an electronic motor. The electronic motor used may be a servo motor for providing rotation of work piece table 202 between a first point and a second point, or the electronic motor may be a stepper motor for providing intermediate positionings of work piece table 202 between substantially vertical and substantially horizontal. Alternately or in addition to any embodiment previously described, work piece table rotation mechanism 204 may be configured as a pulley system, such that an operator can effect rotation of work piece table 202 from a distance and with minimal force required. In another embodiment, the work piece table rotation mechanism 204 may include a pneumatic rotary actuator to effect the rotation of work piece table 202, which may be similarly controlled by an operator from a distance and with minimal force exerted. In yet another embodiment, the work piece table rotation mechanism 204 may include a hydraulic rotary actuator to effect the rotation of work piece table 202, which may be similarly controlled by an operator from a distance and with minimal force exerted. In yet another embodiment, the work piece table rotation mechanism 204 may include a mechanical advantage screw to effect the rotation of work piece table 202. In yet another embodiment, the work piece table rotation mechanism 204 may include a lever which can effect the rotation of work piece table 202, which may be similarly controlled by an operator from a distance and with minimal force exerted. For example, the end of the lever opposite an operator may include a gear configured to be in gearing connection with work piece table rod gear 216, such that rotation of the lever effects rotation of the work piece table rod 218 and thereby rotates work piece table 202.

The work piece table rotation mechanism 204 as previously described may be mounted on or attached to the movable support structure 206 of the work piece trolley 200, as illustrated throughout FIGS. 10 to 26. The movable support structure 206 may be of any construction that provides a structural support for the work piece table 202 (with a work piece thereon) and enables the movable support structure 206 to travel across a floor between the loading and working positions.

The work piece table 202 may be permanently mounted to the movable support structure 206 or, optionally, as discussed subsequently, it may be removably mounted thereto.

As exemplified in FIG. 12, the movable support structure 206 may be comprised of two horizontally extending beams 228 that are maintained in a fixed spaced apart position by one or more transverse extending member, such as one or more transversely extending cross beams. Optionally, as exemplified in FIG. 12, beams 228 are attached to a platform 230. The platform 230 may be any rigid member that has sufficient structural strength to support and maintain beams 228 in a fixed position. The platform may also provide an upper surface on which, e.g., tools may be stored for use.

The platform 230 may span from a leftmost edge of a left beam 228 to a rightmost edge of a right beam 228. Alternately or in addition, the platform may be as wide as or slightly narrower than the width of recess 122 and/or recess 162. Alternately or in addition, the distance from the leftmost edge of a left beam 228 to a rightmost edge of a right beam 228 may be as wide as or slightly narrower than the width of recess 122 and/or recess 162. In an embodiment, more than two horizontally extending beams 228 may be present in the movable support structure 206.

The work piece rod support mounts 222 and the wheel rod support mounts 224 may be removably or permanently directly attached to a respective one of beams 228. It will also be appreciated that the work piece rod support mounts 222 and the wheel rod support mounts 224 may be removably or permanently indirectly attached to the beams 228.

Each beam 228 may have one or more wheels 232 attached to and optionally positioned under beam 228 such that the work piece trolley is translatable along the floor. As exemplified, two forward wheels and two rearward wheels are provided. Optionally, the rear-most wheel 233 on each beam 228 may be a swivel wheel or caster wheel, which can rotate 360° about the point of attachment to allow the work piece trolley 200 to rotate along the floor. In this embodiment, other wheels 232 attached to the beam 228 may be roller wheels, or wheels which cannot rotate about the point of attachment, such that movement of the wheel 232 is fixed in a forwards or backwards direction. Alternately or in addition, any other of wheels 232 (e.g., the forward wheels) may be swivel or caster wheels.

Any or all of wheels 232, 233 may be vertically adjustable wheels. In an extended position, the vertically adjustable wheels may lift the beams 228 and subsequently the work piece trolley 200 higher off of the floor. Actuation of the vertically adjustable wheels may be done manually, by electronic means, by hydraulic means, by pneumatic means, by electro-mechanical means, or by any combination therein. In this embodiment, the work piece trolley 200 is movable along the floor when the vertically adjustable wheels are in an extended position, and optionally when the vertically adjustable wheels are in a compressed position.

The platform 230 connecting the beams 228 may further comprise a raised portion 234 that may serve as a step on which an operator can stand. For example, a user may stand on it to access a bay as discussed subsequently.

Optionally, the raised portion 234 and/or the platform 230 may be rotatably attached to the work piece trolley, e.g., to an edge of platform 230, such that the raised portion 234 may limit the downward rotation of the work piece table 202 to, e.g., the horizontal position or to reinforce the work piece table when the work piece table is rotated to the vertical position. For example, a rotatable mechanism such as a hinge may be provided. In this embodiment, the raised portion 234 may be rotatable from a first substantially horizontal position to a second substantially vertical position. The raised portion 234 may be dimensioned such that the raised portion 234 can be rotated into a substantially vertical position without contacting the work piece table 202 when the work piece table is in a substantially horizontal position or a substantially vertical position. The raised portion 234 and the rotatable connection may be positioned such that when the raised portion 234 is in a substantially vertical position, it may contact the one or more work piece table holding members 220 to prevent downward rotation, and to hold the raised portion 234 in a substantially vertical position.

The work piece table 202 may be used to secure the work piece in position for machining. Accordingly, as exemplified in FIGS. 10 and 11, the work piece table may have a plurality of mounting holes 236 and/or work piece table fasteners 238 that are useable to secure the work piece table 202, while attached as part of the trolley or removed from the support structure 206, to the CNC machine. Accordingly, the mounting holes may align with some or all of the fastening holes 120 to enable a fastener to extend through the mounting holes 236 and be secured in or to some or all of the fastening holes 120. Alternately, or in addition, the fasteners 238 may align with fastening holes 120 to enable the fasteners 238 to be secured in or to some or all of the fastening holes 120.

Mounting holes 236 may be through holes, may be blind holes (i.e., holes that do not penetrate the entire thickness) on the front face 242 of work piece table 202, or may be any combination of the two. In any embodiment, mounting holes 236 may further be straight holes, may be tapped or threaded holes, or may be any combination of the two. Alternately or in addition, mounting holes 236 of any type may have a counterbore, countersink, or any combination of the two on the front face 242 of work piece table 202. Alternately or in addition, mounting holes 236 may be tapered holes, with the diameter of the mounting hole 236 being the largest on front face 242 of the work piece table 202. Any of mounting holes 236 may instead be a slot with varying lengths. In an embodiment where one or more of mounting holes 236 are slots, the slot may have a fixed diameter or may have a variable diameter over the length of the slot. Alternately or in addition, any one of mounting holes 236 may be a keyhole slot.

The orientation and configuration of mounting holes 236 may substantially correspond to the shape and size of opening 118 of the main datum frame 112. For example, for a main datum frame 112 having a substantially rectangular opening 118 with fastening holes 120 forming a rectangle surrounding the opening 118, the mounting holes 236 may be situated on work piece table 202 in a rectangular manner of similar size as the fastening holes surrounding the opening 118. In another example, in an embodiment of a main datum frame 112 having two separate rectangular openings 118 each with fastening holes 120 forming a rectangle surrounding each opening 118, the mounting holes 236 may form two separate rectangles of similar size as the fastening holes 120 surrounding each opening 118 on work piece table 202.

Table fasteners 238 may similarly be configured to substantially or exactly correspond to the shape and size of fastening holes 120. In an embodiment, fasteners 238 may have the same placement on workpiece table 202, such that each one of fastening holes 120 corresponds and matches to a respective table fasteners 238. The fasteners 238 may be of any construction that enables the fasteners to be secured to fastening holes 120.

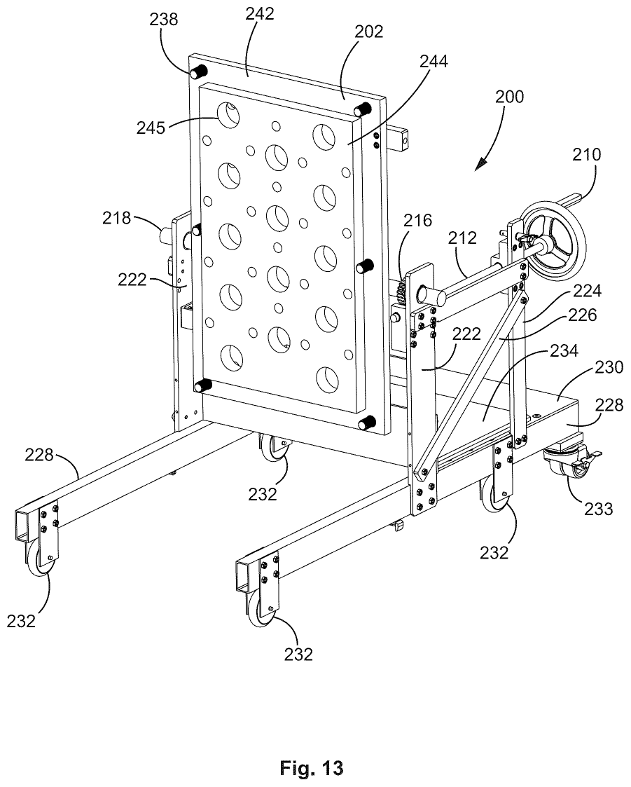

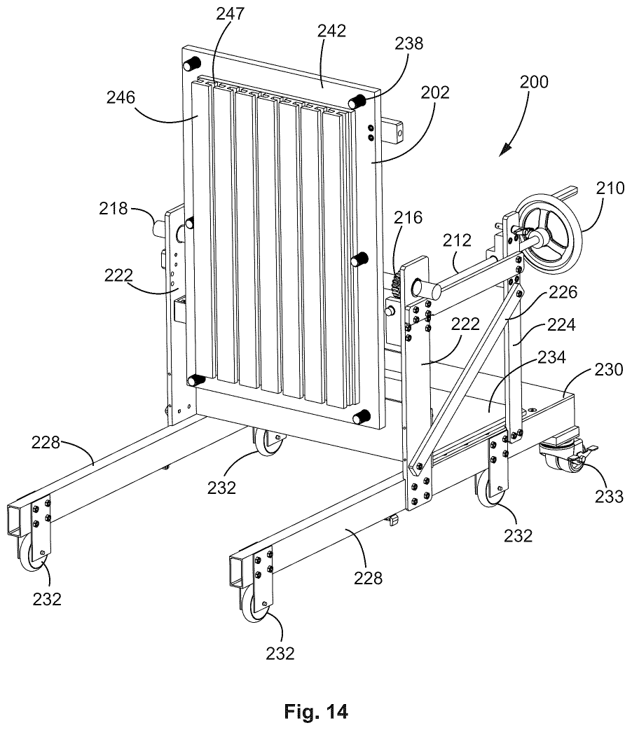

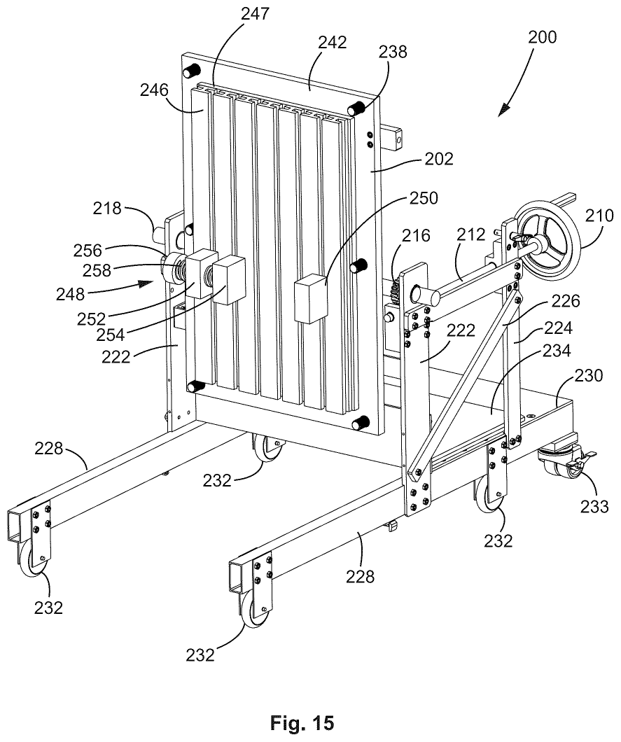

It will be appreciated that mounting holes 236 may also be used to mount work piece holding members onto the work piece table 202, as exemplified in FIGS. 13 to 15. The work piece holding member may be used to removably secure a work piece to the work piece table 202, such that the movement of the work piece is restricted in all directions whether the work piece table 202 is in a substantially horizontal position, a substantially vertical position, or any position in between. As discussed subsequently, the work piece holding member may be any securement member that can be removably affixed to work piece table 202, such as a spoil board 244 (FIG. 13), a T slot table 246 (FIG. 14), or a 2-part vise 248 (FIG. 15).

### Work Piece Holding Member

In accordance with this aspect, which may be used by itself or with one or more of the other aspects set out herein, a work piece holding member is secured to or removably mountable to a work piece table 202.

The work piece holding member may be one or members that releasably secures a work piece on a work piece table 202. The work piece holding member may be removably mountable at one or a plurality of locations on a workpiece mounting table 202. Optionally, if two or more work pieces are to be machines at the same time, then the work piece holding member may secure a plurality of work pieces to the work piece table 202 and/or a two or more work piece holding members may be provided, each of which is concurrently mountable to the work piece table 202.

It will be appreciated that a work piece holding member, which is mounted to a work piece table 202, may enable a work piece to be secured to the work piece table 202 in two or more different positions. In such an embodiment, the work piece holding member mat be secured to the work piece table 202 and need to be removable therefrom.

The work piece holding member may be a spoil board 244 (see e.g., FIG. 13). The spoil board 244 may have any number of holes 245, which may be through holes, blind holes, straight holes, threaded holes, countersunk holes, counterbored holes, slots, or any combination therein. The holes 245 may be placed anywhere along the front face of the spoil board 244, and may be of varying sizes, positionings, or alignments. In an embodiment, the holes 245 may be disposed in an alternating pattern between larger and smaller holes, as illustrated in FIG. 13. The spoil board 244 may be removably affixed to work piece table 202 by any adhesive or fastening means as previously described. In an embodiment, the spoil board 244 may be removably affixed to work piece table 202 using fastening means securable to the mounting holes 236 of the work piece table 202.

As exemplified in FIG. 14, the work piece holding member may be a T-slot table 246. The T-slot table 246 may have any number of rails 247 which may form channels in between the rails. The rails 247 may be positioned substantially vertically when the work piece table 202 is in a vertical position, or the rails 247 may be positioned substantially horizontally when the work piece table 202 is in a vertical position. The T-slot table 246 may be removably affixed to work piece table 202 by any adhesive or fastening means as previously described. In an embodiment, the T-slot table 246 may be removably affixed to work piece table 202 using fastening means securable to the mounting holes 236 of the work piece table 202.

As exemplified in FIG. 15, work piece holding member may be a 2-part vise 248. The vise 248 may be affixed to a work piece holding member (such as, for example, T-slot table 246), or may be directly affixed to work piece table 202 via mounting holes 236. The 2-part vise 248 may be comprised of a stationary jaw 250 and a movable jaw assembly. The movable jaw assembly may comprise a movable jaw housing 252, a movable jaw 254, a rotatable handle 256, and a threaded shaft 258. In the embodiment illustrated in FIG. 15, both the stationary jaw 250 and movable jaw housing 252 may be removably affixed to T-slot table 246. The movable jaw 254 may be rotatably affixed to one end of threaded shaft 258, and the other end of threaded shaft 258 may be removably or permanently affixed to handle 256. Movable jaw housing 252 may have a threaded through hole which permits horizontal translation of threaded shaft 258 upon rotation of threaded shaft 258. In operation, the handle 256 may be rotated to effect rotation of threaded shaft 258 through movable jaw housing 252, and in turn translate threaded shaft 258 and movable jaw 254. At the rotatable connection point between movable jaw 254 and threaded shaft 258, the two components may be connected such that rotation of the threaded shaft 258 does not cause rotation of the movable jaw 254. In an embodiment, the end of threaded shaft 258 may be removably or permanently affixed in a bearing disposed in movable jaw 254, such that translation of the threaded shaft 258 causes translation of the movable jaw 254, but rotation of the threaded shaft 258 does not cause rotational movement of the movable jaw 254. In an embodiment, instead of a movable jaw assembly and a stationary jaw 250, the 2-part vise 248 may comprise two movable jaw assemblies which can both be moved towards or away from each other.

Advantageously, the 2-part vise 248 allows for the stationary jaw 250 and the movable jaw assembly to be spaced as far apart or as close together as required. For example, the stationary jaw 250 may be positioned on an opposite end of work piece table 202 from the movable jaw assembly, thereby providing the entire length or width of the work piece table 202 as a mountable area. The stationary jaw 250 and the movable jaw assembly may be horizontally or vertically aligned, such that the movable jaw 254 translates towards or away from stationary jaw 250. In an alternate embodiment, stationary jaw 250 and the movable jaw assembly may not be horizontally or vertically aligned. This configuration may provide a more effective method of securing a complex or irregularly shaped work piece.

It will be appreciated that other work piece holding members, or a combination of any work piece holding members previously described may be used to removably affix the work piece to work piece table 202. For example, in an embodiment, a tailstock and a rotatable clamp may both be removably affixed to T-slot table 246, spoil board 244, or directly to work piece table 202, such that a work piece is rotatably secured parallel to the front face 242 of work piece table 202. The rotatable clamp may be manually or electronically actuated to provide a variable or constant rotation to a work piece, while the tailstock provides a rotatable support to prevent lateral movement of the work piece. The rotatable clamp may be electronically actuated by a motor to provide a constant, controllable rotational motion, and/or may be electronically actuated by a motor such as a stepper motor to provide discrete rotation positions.

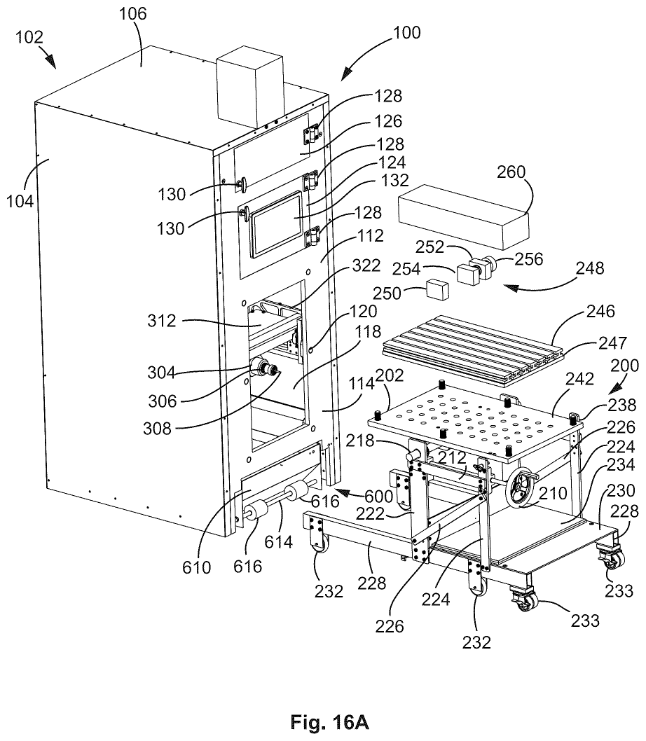

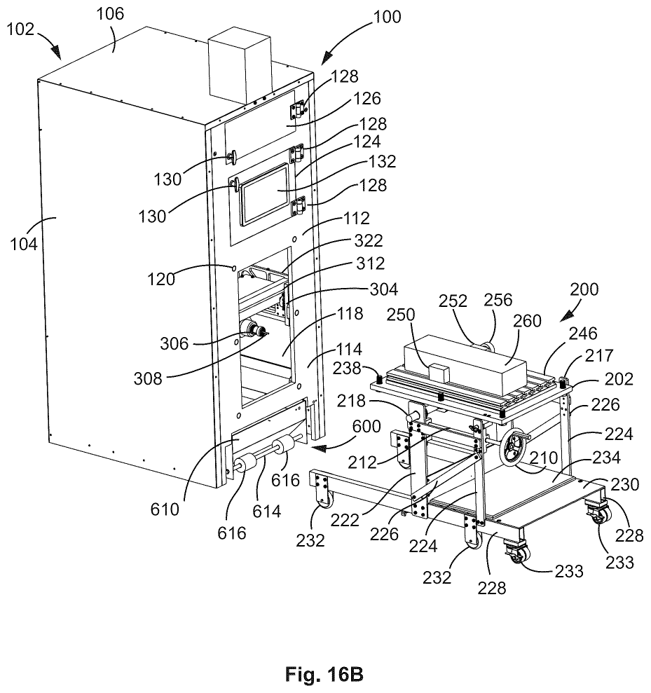

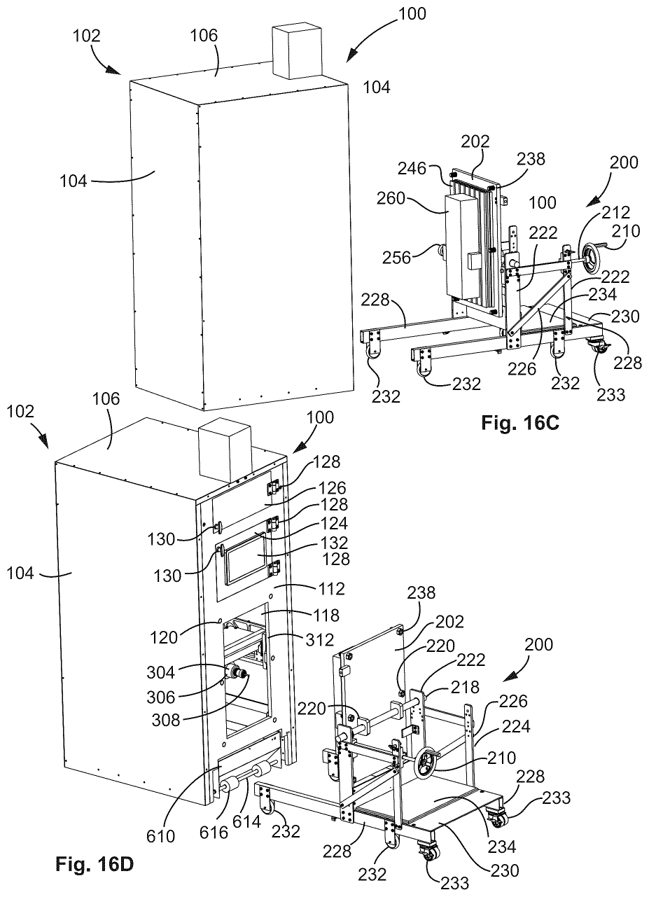

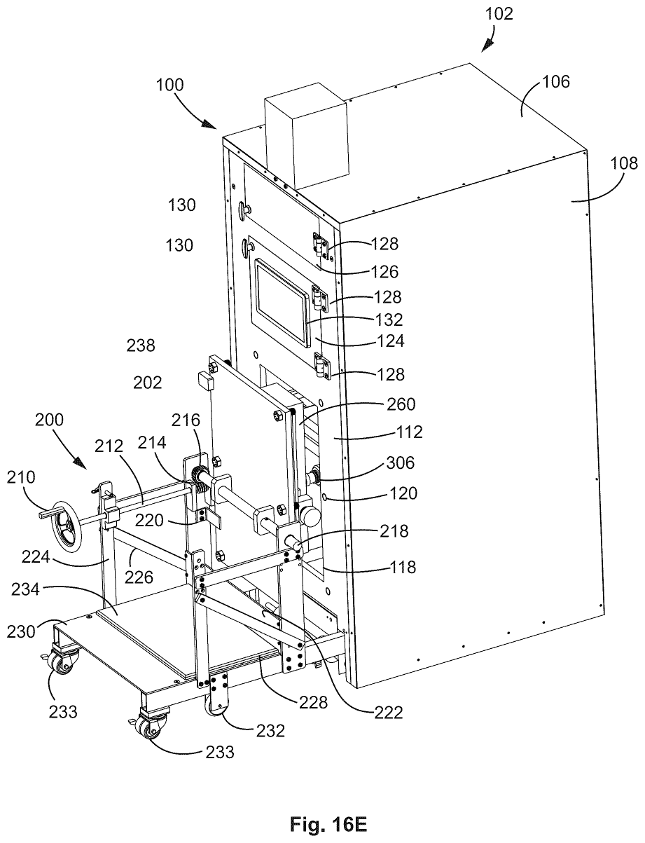

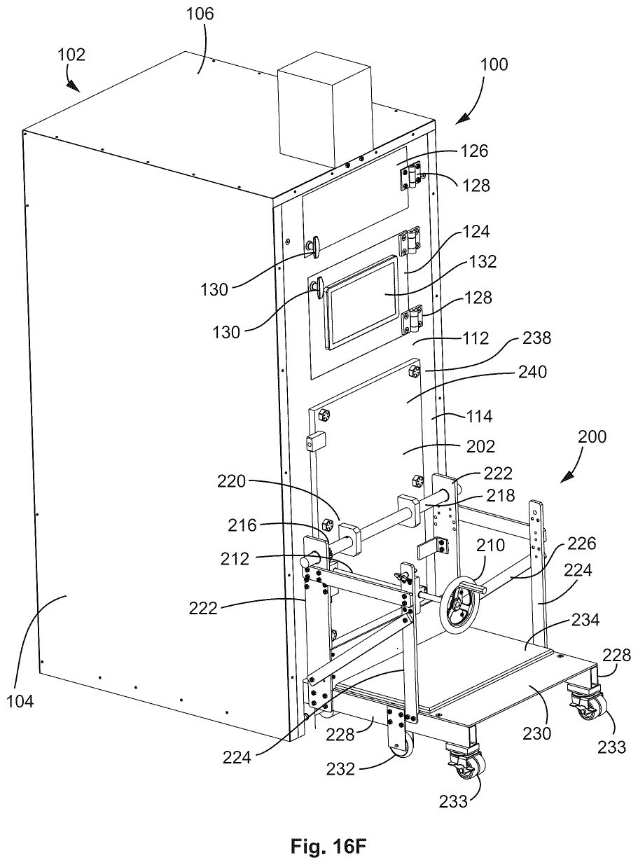

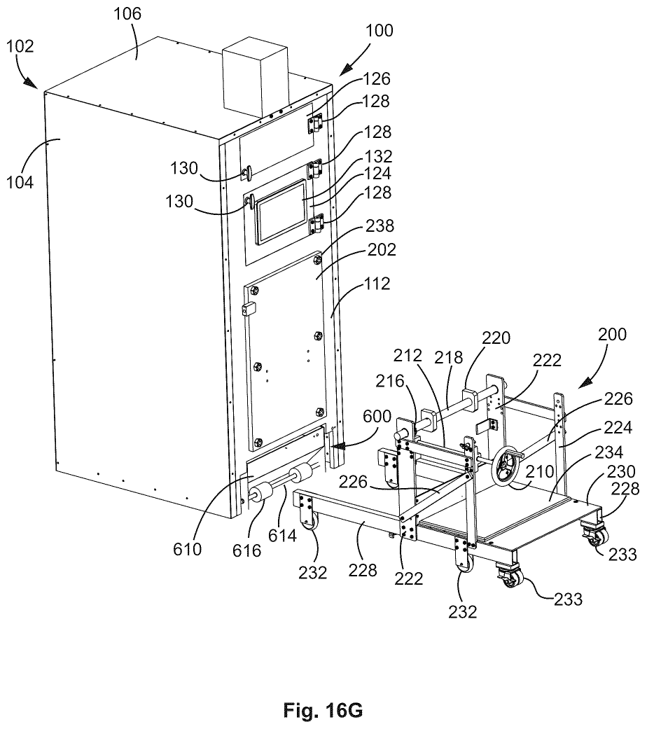

A work piece trolley 200 may incorporate any one or more of the features described herein to secure a work piece 260 into opening 118 of main datum frame 112, as illustrated in FIGS. 16A to 16G.

Referring to the embodiment of FIGS. 16A to 16G, a T-slot table 246 is removably attached to work piece table 202 via mounting holes 236. A 2-part vise 248 is removably attached to the T-slot table 246, with the movable jaw assembly and the stationary jaw 250 spaced far enough apart on the T-slot table to accommodate work piece 260 (FIG. 16A).

The work piece 260 may be lifted onto work piece table 202 by a person, a crane, a robotic arm or other lifting member. The lifting member may be affixed to one of the CNC machine 100 and the work piece trolley 200 or the lifting member may be remote from both CNC machine 100 and work piece trolley 200. Accordingly, the crane may be removably or permanently affixed to a portion of work piece trolley 200, such as the trolley platform 230. The base of the crane may be translatable in a horizontal plane along platform 230.

The robotic arm may be a 3 degree of freedom (DoF) robotic arm, which can move an end effector holding the work piece 260 in the x, y, and z axis. In an alternate embodiment, the robotic arm may be a 6 DoF robotic arm, which can move an end effector holding the work piece 260 in the x, y, and z axis, as well as three rotational axes. In a further alternate embodiment, base of the robotic arm may be horizontally translatable along platform 230, providing 7 DoF for the end effector of the robotic arm. The end effector may be any type suitable for lifting work piece 260, including, for example, a gripping member, a clamp, a hook, or a magnet.

To secure the work piece as shown in FIG. 16B, the handle 256 may be turned as previously described to move the movable jaw 254 into contact with the workpiece 260, thereby preventing translational or rotational movement of workpiece 260. Using any embodiment of the work piece table rotation mechanism 204 as previously described, the work piece table 202 may be rotated about axis of rotation 208 into a substantially vertical position. Due to the frictional force of the 2-part vise 248 on the work piece 260, the work piece 260 is secured on the work piece table 202 even while substantially vertical (FIGS. 16C and 16D).

Using the movable support structure 206 as previously described, the work piece trolley 200 can be moved along the floor towards the main datum frame 112 of CNC machine 100. As the work piece trolley 200 approaches the main datum frame 112, the beams 228 may enter into the recess 122, and the T-slot table 246, 2-part vise 248, and work piece 260 may enter into the opening 118 (FIG. 16E). As described previously, the distance between the outer edges of beams 228 may be equal to or slightly narrower than the width of recess 122, such that both beams 228 may freely enter and exit the recess 122. The distribution of mounting holes 236 on work piece table 202 may correspond substantially in shape and size to opening 118, such that the work piece and the work piece holder may freely enter and exit the opening 118.

The work piece table 202 may fully contact the main datum frame 112 such that the portion of the work piece table 202 surrounding the work piece and work piece holder abuts the front face 114 of the main datum frame 112 (FIG. 16F). As described previously, fastening holes 236 and/or fasteners 238 may correspond substantially in placement, diameter, and orientation to fastening holes 120, such that when work piece table 202 abuts the front face 114 of the main datum frame 112 in a substantially vertical orientation, a fastener may be placed through both of each of fastening holes 120 and fastening holes 236 and/or fasteners 238 may engage fastening holes 120 to immovably secure the work piece table 202 to the main datum frame 112.

The fastener may comprise a threaded bolt which enters a fastening hole 236 through the rear face 240 of work piece table 202, and subsequently enters a fastening hole 120 through the front face 114 of the main datum frame. In an embodiment in which fastening holes 120 and 236 are threaded holes, the threaded bolt may be tightly secured in the threads of fastening holes 120 and 236. Alternately, fastener 238 may be a threaded bolt that may be tightly secured in the threads of fastening hole 120. In addition to or in alternate embodiments, the threaded bolt may be tightened with a washer and/or a threaded nut, both disposed in the enclosed working volume of the mill body 102. It will be appreciated that when the work piece table 202 is fastened to the front face 114 of the main datum frame 112, the opening or openings 118 may be completely covered by the work piece table 202, thereby fully enclosing the enclosed working volume of the mill body 102.

When the work piece table 202 is secured in the main datum frame 112, at least a portion of the work piece 260 enters through the opening 118 and into the enclosed working volume of mill body 102. As the counterweight frame 140 extends horizontally along the length of left wall 104 and right wall 108, when the work piece 260 is fully inserted into the enclosed working volume of mill body 102, the work piece 260 may be positioned internal of the counterweight frame 140 such that a vertical plane intersects at least a portion of the work piece 260 and the counterweight frame 140. Further, the workpiece may overlie the center of gravity of the CNC machine such that a vertical plane intersects at least a portion of the work piece 260 and the center of gravity of the CNC machine.

As described previously, work piece table 202 may be removably affixed to support structure 206, e.g., one or more work piece table holding members 220. In such an embodiment, after work piece table 202 is fastened to front face 114 of main datum frame 112, the work piece table 202 may be disengaged from the one or more work piece table holding members 220 such that the work piece trolley can be removed from the CNC machine 100 while the work piece table 202 remains affixed to the main datum frame 112 (FIG. 16G). In such an embodiment, a work piece trolley 200 may have several work piece tables 202, and therefore may service more than one CNC machine 100 at a time. Alternately or in addition, a work piece trolley 200 may have a second work piece table secured to the one or more work piece table holding members 220, e.g., underlying the first work piece table 202. After separating the first work piece table 202 from the support structure 206, a second work piece to be affixed to the second work piece table while the first work piece 260 is still fastened in the enclosed working volume of the mill body 102 using the first work piece table 202.

Optionally, the work piece table 202 or work piece holding member may be movable after the work piece table 202 is affixed to the main datum frame 112. For example, a T-slot table 246 may be mounted to work piece table 202 via rails, such that the T-slot table 246 may move laterally and/or vertically when the work piece table 202 is affixed to the main datum frame 112. Alternately or in addition, a portion of the work piece table 202 may be configured to rotate while the work piece table 202 remains affixed to the main datum frame 112, such that a work piece 260 directly affixed to the rotatable portion of the work piece table 202 may rotate while being machined.

### Work Piece Table Sub Doors

In accordance with this aspect, which may be used by itself or with one or more of the other aspects set out herein, a work piece table 202 may have more than one support surface on which a work piece may be mounted and used to position a work piece in an opening 118 of a CNC machine. Accordingly, for example, a work piece table may have two portions, each of which may have a work piece mounted thereon using any technique disclosed herein wherein each work piece may be separately moved into and/or out of an opening 118.

Accordingly, a first work piece may be mounted to a first portion of the work piece table 202 and a second work piece may be mounted to a second portion of the work piece table 202. The trolley may then be used to concurrently insert the two work pieces into a single opening or to concurrently insert each work piece into a separate opening 118.

Alternately, the trolley may then be used to sequentially insert the first work piece into a first opening 118 and to then insert the second work piece a second opening 118.

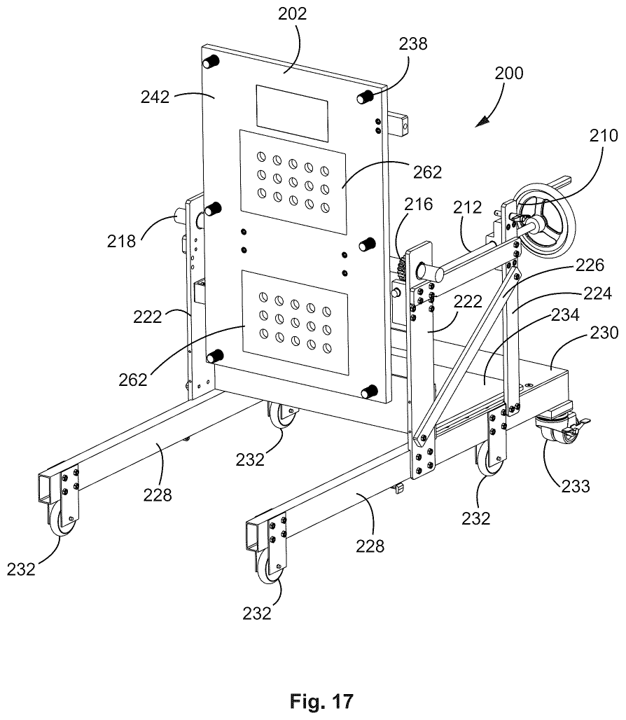

Each portion of the work piece table 202 may be a sub-door 262 as exemplified in FIGS. 17 to 20. Each sub-door 262 and/or the entire work piece table 202 may be rotated to insert a work piece into the opening 118 as discussed previously. In addition, the work piece table 202 and/or the sub door 262 may be translated away from the CNC machine prior to the work piece table or the sub door is rotated to an insertion position. The work piece table 202 and/or the sub door 262 may then be translated back to the CNC machine to insert the work piece into the opening 118.

It will be appreciated that some, most or all of the mounting holes 236 and/or fasteners 238 may be disposed on the sub-doors 262.

It will be appreciated that the sub-doors 262 may be the same thickness as work piece table 262, such that a front face of the sub-door 262 is flush with the front face 242 of the work piece table 202, and a rear face of the sub-door 262 is flush with the rear face 240 of the work piece table 202.

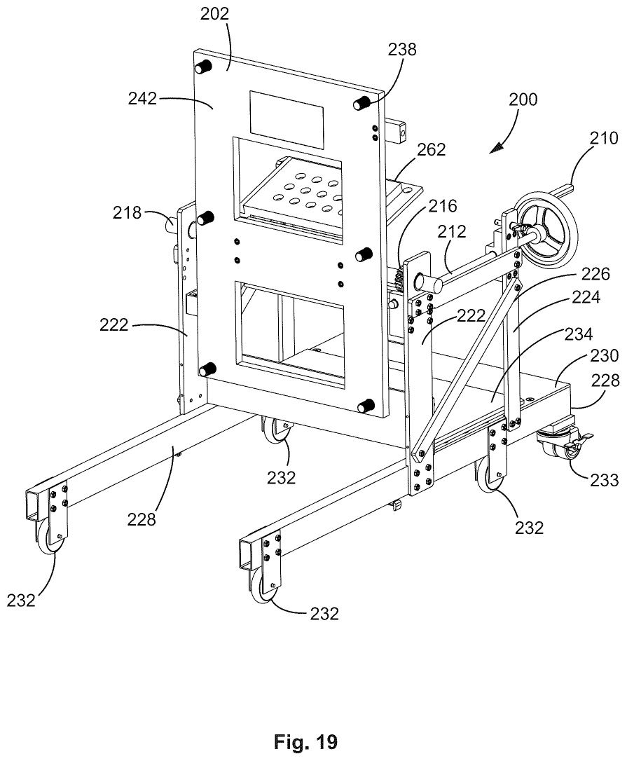

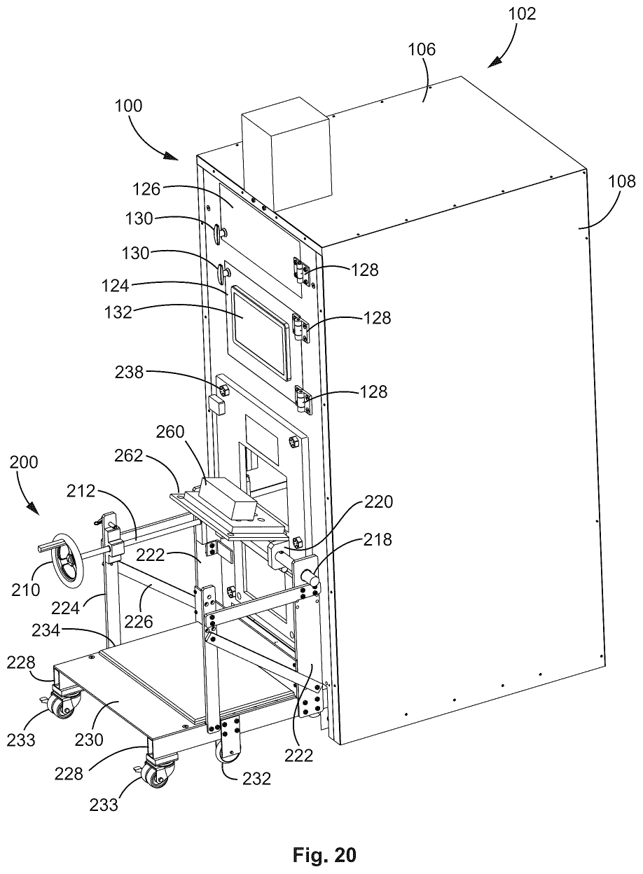

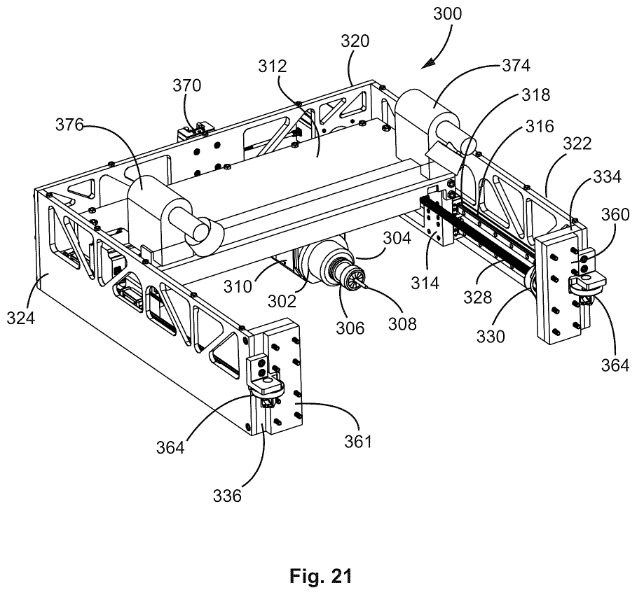

Each sub-door 262 may be rotatably attached, e.g., to the rear face 240 of the work piece table 202 via a hinge 264. The hinge 264 may be attached to the bottom edge of the sub-door 262 such that the sub-door 262 rotates downwards away from the rear face 240 of work piece table 202 (FIGS. 19 to 20). In alternate embodiments, the hinge 264 may be attached to the top edge of sub-door 262 such that the sub-door 262 rotates upwards away from the rear face 240 of work piece table 202, or the hinge 264 may be attached to a side edge of sub-door 262 such that the sub-door 262 rotates sideways away from the rear face 240 of work piece table 202. In will be appreciated that more than one hinge 264 may be attached to each sub-door 262. Each sub-door 262 may rotate when the work piece table 202 is separate from the main datum frame 112, and/or may rotate when the work piece table 202 is removably attached to the main datum frame 112 as previously described.

Each sub-door 262 may be the same size and shape as the other sub-door(s), or one sub-door may be different shape and/or size to another sub-door. optionally, each sub-door 262 may be substantially rectangular, although any other shape of sub-door 262 may be possible.

The sub-doors 262 may be vertically aligned, horizontally aligned, diagonally aligned, or may be unaligned.

Each sub-door 262 may be manually moveable by an operator between a mounting position and an insertion or inserted position. Alternately or in addition, each sub-door 262 may have a mechanical advantage rotation mechanism as described previously.

Each sub-door 262 may be rotatable separate from any other sub-door 262. Alternately, two or more, or all, sub-doors 262 may be configured to rotate simultaneously, e.g., during actuation of a singular sub-door rotation mechanism. Alternately, any or all of sub-doors 262 may rotate based on actuation of the work piece table rotation mechanism 204.

As discussed previously, one or more of the sub-doors 262, or the work piece table 202 regardless of whether a sub-door is provided, may be horizontally translatable away from and towards support structure 206 in addition to rotatable as previously described. For example, one or more of the sub-doors 262 may be translatable relative to the rear face 240 of work piece table 202. For example, each of the sub-door hinges 264 may comprise a translatable hinge, which provides rotational movement as well as translatable movement towards and away from an attachment point on the rear face 240 of work piece table 202. It will be appreciated that each sub-door 262 may be manually translatable by an operator. Alternately or in addition, each sub-door 262 may have an assisted translation mechanism, such as an electronic motor system, a hydraulic system, and/or a pneumatic system. It will also be appreciated that the translation member may be separate from the hinge (for example, the hinge may be mounted to a rail assembly such that the hinge with the sub-door is translatable along the rails with respect to, e.g., the work piece table 202.

In an example scenario, a sub-door 262 may be rotated from a substantially vertical position to a substantially horizontal position after work piece table 202 has been removably attached to main datum frame 112. A work piece 260 may then be secured directly to a sub-door 262 via mounting holes 236, or may be secured to one or more work piece holding members as previously described, such as, for example, a 2-part vise 248 attached to a T-slot table 246, which in turn is secured to sub-door 262 via mounting holes 236. However, the work piece 260 may be too tall for sub-door 262 to rotate to a substantially vertical position, such that the top or side edge of a work piece 260 may contact the rear face 240 of work piece table 202 or the wall surrounding an opening 118, thereby preventing rotation of sub-door 262 to insert the work piece into the working volume. In order to fully rotate the sub-door 262, the sub-door 262 holding the work piece 260 may first be horizontally translated away from work piece table 202, providing clearance between the top or side edge of work piece 260 and the rear face 240 of work piece table 202, and the sub-door may then rotate to the vertical position. After the sub-door 262 is in a substantially vertical position, the sub-door 262 may be horizontally translated towards the work piece table 202, until the work piece is in a working position in which it may be machined, e.g., the front face of sub-door 262 is, flush with the front face 242 of work piece table 202. As a result, the work piece 260 is securely fixed into the opening 118 of main datum frame 112.

It will be appreciated that a work piece table 202, which does not have a sub-door 262, may be itself mounted to the CNC machine, e.g., the main datum frame 112. The work piece table may be translatable as discussed with respect to the sub-doors.

### Use of the Work Piece Trolley to Move the CNC Machine

In accordance with this aspect, which may be used by itself or with one or more of the other aspects set out herein, a work piece trolley may be used to move a CNC machine.

As exemplified in FIG. 12, beams 228 may extend forward of the work piece table such that a portion of the beams 228 extend into a recess in the CNC machine and may be used similar to a forklift to move a CNC machine. Accordingly, the beams 228 may be sized such that the forward sections thereof may extend through the recess 122 and optionally also the recess 162. The beams may then be used to lift the CNC machine for movement.

Accordingly, for example, one or more of the wheels 232, 233 may be vertically adjustable wheels. The vertically adjustable wheels may be actuated into an extended position while the beams 228 are positioned into one or more of the recesses 122, 162, thereby lifting the CNC machine 100 off the floor via, e.g., the main datum frame 112 and/or the counterweight frame 140. Once the CNC machine 100 is lifted off of the floor, the work piece trolley 200 may be used as a carrier to transport and move the CNC machine 100 in an upright position.

Alternately, or in addition, an arm, fork, or prong of a carrier such as a forklift or a pallet truck may be inserted into one or more of recesses 122, 162 (optionally under the trolley platform 230 while, e.g., the work piece table 202 is mounted to the CNC machine) and between the beams 228 to lift the CNC machine 100. In this embodiment, it will be appreciated that the CNC machine may be movable over the floor in an upright position with or without the work piece trolley 200 attached to the CNC machine 100.

### Horizontal Spindle System

In accordance with this aspect, which may be used by itself or with one or more of the other aspects set out herein, a CNC machine may have a horizontal spindle system disposed within the enclosed working volume of the CNC machine.

An advantage of a horizontal spindle system is that cuttings from the work piece may fall from a location at the lower end of the work piece to a lower end of the CNC machine (e.g., a removable tray as discussed subsequently) without hinderance from a support surface for the work piece.

The work piece and/or the spindle 302 of a spindle system 302 may be moveable in one or more of the X, Y and Z axis. Optionally, each of the work piece and/or the spindle 302 are moveable in at least one of, optionally 2 or all 3 of the X, Y and Z axis.

Accordingly, as exemplified in FIGS. 21-25, a horizontal spindle system 300 may be designed to provide movement in three axes for a cutting bit 308 via, e.g., a gantry system for the purposes of machining a workpiece secured in the enclosed working volume of the mill body 102 (FIGS. 21 to 25).

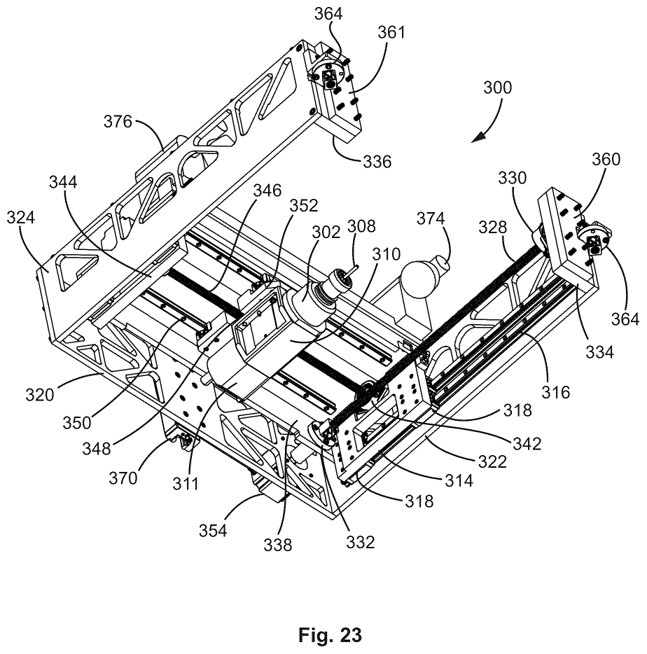

As exemplified, a spindle 302 may be connected at one end to a chuck 304 which may releasably hold a work tool 306 comprising a cutting bit 308. The other end of spindle 302 may be connected to or disposed within a headstock 310, containing a mechanism for controlling the rotation of spindle 302. As best illustrated in FIG. 23, the spindle headstock 310 may include or may be attached to a spindle motor 311, which provides the rotation and power to the spindle. The spindle motor 311 may be any type of motor, such as a brushless direct current (DC) motor, which offers constant rotation and precise control of motor speeds. The spindle headstock 310 may contain gearing mechanisms, bearings, belts, shafts, and any other components to provide rotation of the spindle 302 via rotation of the motor 311.

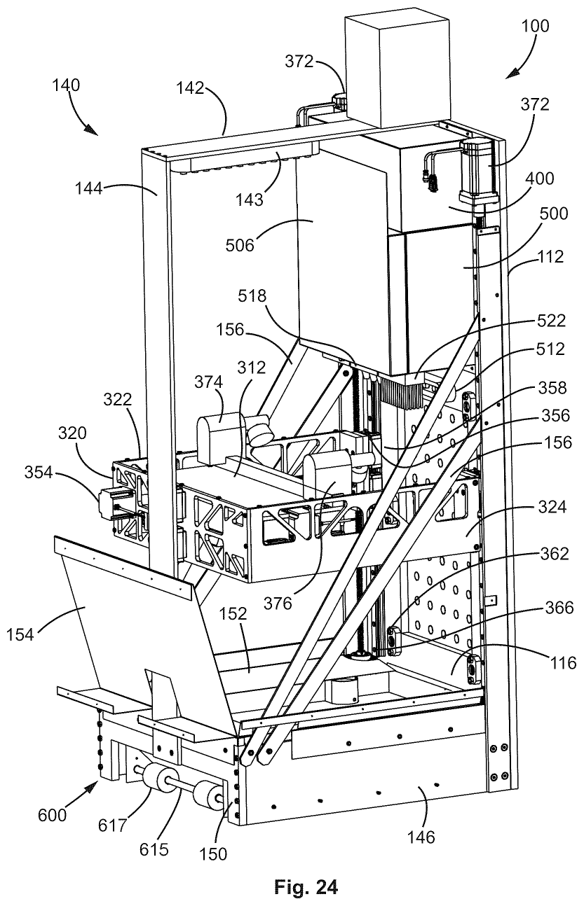

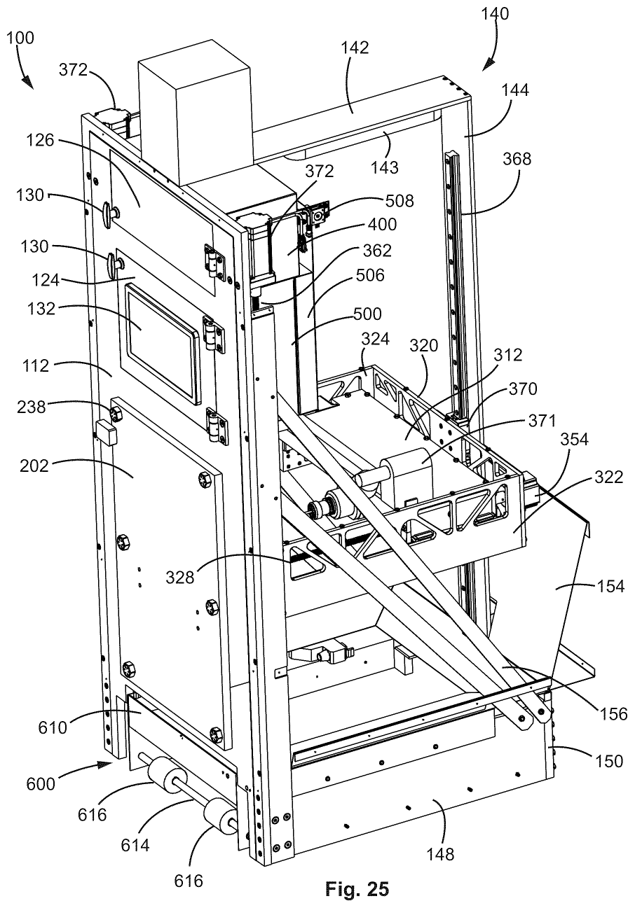

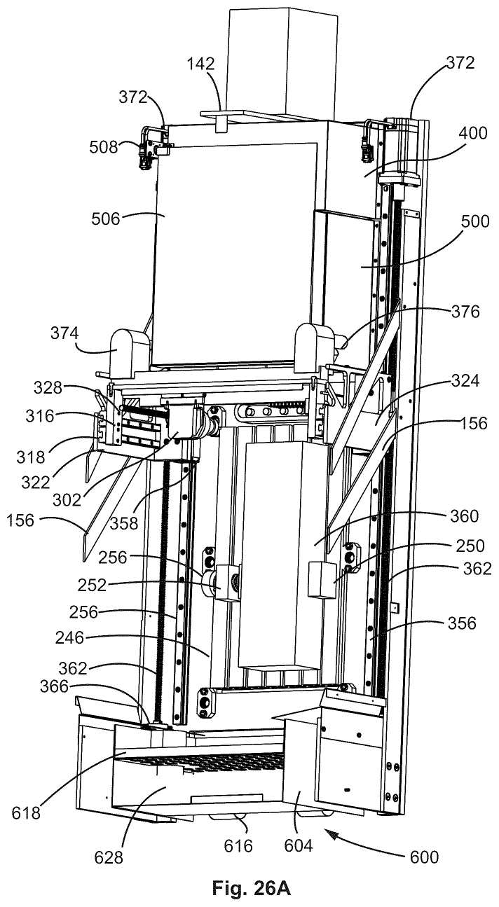

Notably, as illustrated in FIGS. 21 to 25, the spindle motor 311, and by proxy the spindle 302, chuck 304, work tool 306, and cutting bit 308 may all have a horizontal or substantially horizontal axis of rotation. When the horizontal spindle system 300 is assembled into the mill body 102 as will be further described, the spindle 302 is perpendicular or substantially perpendicular to the main datum frame 112, and by extension the attached work piece table 202 and work piece 260 (FIGS. 24 and 25).

To provide movement of the spindle 302 in an X axis (i.e., transversely or laterally towards and away from the left wall 104 and right wall 108 of mill body 102), the spindle 302 and spindle headstock 310 may be movably mounted to a spindle platform 312, e.g., the bottom end (FIG. 23). The bottom end of the spindle platform 312 may have one or more spindle platform rails 350 permanently or removably affixed to the bottom end of spindle platform 312. The one or more spindle platform rails 350 may extend substantially along the width of the spindle platform 312. One or all of the spindle platform rails 350 may have a “I” or “T” shape profile. To facilitate lateral movement along the one or more spindle platform rails 350, the spindle 302 and/or headstock 310 may have one or more spindle platform sliders 352 removably or permanently attached to the spindle platform rails 350, e.g., removably mounted onto a spindle platform rail 350 such that the spindle platform slider 352 is not secured in a fixed position to a spindle platform rail 350 but is prevented by the “I” or “T” shape profile of the spindle platform rail 350 from disconnecting from the spindle platform rail 350 due to the force of gravity (e.g., the slider may be C-shaped and clipped around the T profile of a rail). As a result, each of the one or more spindle platform sliders 352, and by extension the spindle 302 and/or headstock 310 can move freely along a respective spindle platform rail 350 without disconnecting.

Any motorized controller may be used to control the movement of the spindle in the X axis. For example, to control movement of the spindle along the X axis, a spindle lead screw 346 may be disposed between a left spindle platform stand 315 and a right spindle platform stand 314. The spindle platform stands 314, 315 may be removably or permanently attached to the spindle platform 312. The spindle platform 312 as well as spindle platform stands 314, 315 may be further removably or permanently attached to a rear spindle platform frame 338. Optionally, the spindle platform 312, the spindle platform stands 314, 315, and the rear spindle platform frame 338 may be composed of a single material such that they form a single monolithic component. A right spindle lead screw mount 342 may be attached to the inner face of right spindle platform stand 314, and similarly a left spindle lead screw mount 344 may be attached to the inner face of left spindle platform stand 315. One or both of spindle lead screw mounts 342, 344 may have a rotatable inner layer, such as a bearing, disposed within a fixed outer layer that attaches to spindle platform stands 314, 315. At each end, the spindle lead screw 346 connects an inner layer of one of the spindle lead screw mounts 342, 344, such that translation movement of the spindle lead screw 346 is prevented, but rotation movement of spindle lead screw 346 is allowed.

To permit the spindle 302 to interface with the spindle lead screw 346, a spindle nut 348 may be disposed on the spindle lead screw 346 and permanently or removably affixed to spindle 302 and/or spindle headstock 310. The spindle nut 348, and by extension the spindle 302 and/or spindle headstock 310 may move laterally along the length of the spindle lead screw 346 based on the rotation of spindle lead screw 346. That is, rotation of the spindle lead screw 346 in one direction may cause lateral movement of the spindle 302 towards the right spindle platform stand 314, and rotation of the spindle lead screw 346 in the opposite direction may cause lateral movement of the spindle 302 towards the left spindle platform stand 315.

Rotation of the spindle lead screw 346 may be effected by an actuator, such as an electric motor.

Optionally, one of spindle lead screw mounts 342, 344 may have a rotatable inner layer, such as a bearing, and the other of spindle lead screw mounts 342, 344 may include an actuatable motor. In this embodiment, the spindle lead screw 346 is rotatable actuated at one end, while the other end is freely rotatable with little friction.

Movement of the spindle 302 in a Z axis (i.e., forwardly and rearwardly towards and away from the main datum frame 112) may be effected in a similar manner as movement in the X axis as described previously. Accordingly, for example referring to FIG. 21, in order to move the spindle 302 in a Z axis, the spindle platform 312 and spindle platform stands 314, 315 may be disposed within a gantry frame assembly consisting of a rear gantry frame 320, a right gantry frame 322, and a left gantry frame 324. The right gantry frame 322 and left gantry frame 324 may be permanently or removably affixed to the rear gantry frame 320. In an embodiment, the rear gantry frame 320, right gantry frame 322, and left gantry frame 324 may be composed of a single material such that they form a single monolithic component. In an embodiment, one or more of the gantry frames 320, 322, 324 may have one or more cutouts 326. These cutouts 326 may reduce the weight of the gantry frames 320, 322, 324 without significantly or noticeably reducing the strength or stability of the gantry frame assembly as a whole. The gantry frame assembly may further include a right gantry corner block 334 and a left gantry corner block 336, which may be permanently or removably attached to the right gantry frame 322 and the left gantry frame 324 respectively. In an embodiment, the gantry frames 320, 322, 324 and the gantry corner blocks 334, 336 may be composed of a single material such that they form a single monolithic component.

The outer faces of right spindle platform stand 314 and left spindle platform stand 315 may be removably mounted to the right gantry frame 322 and the left gantry frame 324 respectively. The right gantry frame 322 and the left gantry frame 324 may each have one or more gantry frame rails 316, which may extend substantially along the length of each gantry frame 322, 324. One or all of the gantry frame rails 316 may have an “I” or “T” shape profile. To facilitate movement along the one or more gantry frame rails 316, each outer face of the right spindle platform stand 314 and left spindle platform stand 315 may similarly have one or more spindle platform stand sliders 318 removably or permanently attached. Each spindle platform stand slider 318 may be removably mounted onto a gantry frame rail 316, such that the spindle platform stand slider 318 is not affixed to the gantry frame rail 316 but is prevented by the “I” or “T” shape profile of the gantry frame rail 316 from disconnecting from the gantry frame rail 316 due to the force of gravity.

One or more gantry lead screws 328 may be disposed between the rear gantry frame 320 and the gantry corner blocks 334. In an embodiment, a gantry lead screw 328 is disposed between the rear gantry 320 and the right gantry corner block 334, and a second gantry lead screw 328 is disposed between the rear gantry frame 320 and the left gantry corner block 336. Each gantry lead screw 328 may be attached at one end to a respective forward gantry lead screw mount 330, each of which may be permanently or removably affixed to the inner face of right gantry corner block 334 and left gantry corner block 336 respectively. Similarly, the other end of each gantry lead screw 328 may be attached to a respective rear gantry lead screw mount 332, each of which may be permanently or removably affixed to the inner face of the rear gantry frame 320. The gantry lead screw mounts 330, 332 may be positioned such that the gantry lead screws 328 are substantially parallel to each other, and are further substantially parallel to gantry frame rails 316. Any or all of gantry lead screw mounts 330, 332 may have a rotatable inner layer, such as a bearing, disposed within a fixed outer layer that attaches to rear gantry frame 320, right gantry corner block 334, or left gantry corner block 336. Each gantry lead screw 328 may be connected to the inner layer of gantry lead screw mounts 330, 332, such that translation movement of the gantry lead screw 328 is prevented, but rotational movement of the gantry lead screw 328 is allowed.

To permit the spindle 302 to move in the Z axis, a spindle platform nut 340 may be disposed on each of the gantry lead screws 328 and permanently or removably affixed to the rear spindle platform frame 338. The rear spindle platform frame 338, and by extension the spindle platform 312 and spindle 302 may move forwardly and rearwardly along the length of the gantry lead screws 328 based on the rotation of the gantry lead screws 328. That is, rotation of the gantry lead screws 328 in one direction may cause forward movement of the spindle 302 towards the gantry corner blocks 334, 336, and rotation of the gantry lead screw 328 in the opposite direction may cause rearward movement of the spindle 302 towards the rear spindle platform frame 338.

Rotation of one or both of the gantry lead screws 328 may be effected by an actuator, such as an electric motor 354. The electric motor 354 may be attached, e.g., to the rear gantry frame 320. In an embodiment, the electric motor 354 may cause rotation of one gantry lead screw 328, while the other gantry lead screw 328 rotates freely between two bearings. In an alternate embodiment, the electric motor 354 may rotate both gantry lead screws 328 at the same time. In an alternate embodiment, each gantry lead screw 328 may be actuated by a respective motor. In an embodiment, the motor 354 is configured to rotate one or both of gantry lead screws 328, as well as the spindle lead screw 346.

Movement of the spindle 302 in a Y axis (i.e., upwardly and downwardly towards and away from the floor) may be effected in a similar manner as movement in the X axis and Z axis as described previously. In order to move the spindle 302 in a Z axis, the gantry frame assembly may be mounted, e.g., removably mounted, to the rear face 116 of the main datum frame 112 (FIG. 24). The rear face 116 of the main datum frame 112 may have one or more main datum frame rails 356 which may extend vertically along, e.g., substantially all of the height of the main datum frame 112. The main datum frame 112 may have two main datum frame rails 356, with each rail being disposed on an opposite side of opening 118. In an embodiment, one or all of the main datum frame rails 356 may have an “I” or “T” shape profile. To facilitate vertical movement of the gantry frame assembly along the one or more main datum frame rails 356, the outer face of right gantry corner block 334 and left gantry corner block 336 may have a right slider attachment block 360 and a left slider attachment block 361 respectively affixed thereto. Each of the attachment blocks 360, 361 may be further permanently or removably affixed to a respective main datum frame slider 358, which may be removably mounted onto a respective main datum frame rail 356 such that each main datum frame slider 358 is not affixed to the main datum frame rail 356 but is prevented by the “I” or “T” shape profile of the main datum frame rail 356 from disconnecting from the main datum frame rail 356.

Alternately, or in addition, the gantry frame assembly may be mounted, e.g., removably mounted, to the counterweight frame 140, e.g., the vertical frame member 114 of counterweight frame 140 (FIG. 25) and/or one or both of the left datum support frame 158 and the right datum support frame 160. As exemplified, the vertical frame member 140 may have a counterweight frame rail 368 which may extend vertically substantially along the height of the vertical frame member 114. The counterweight frame rail 368 may have an “I” or “T” shape profile. The outer face of the rear gantry frame 320 may have a counterweight slider 370 permanently or removably affixed, which may be removably mounted onto the counterweight frame rail 368 such that the counterweight slider 370 is not affixed to the counterweight frame rail 368 but is prevented by the “I” or “T” shape profile of the counterweight frame rail 368 from disconnecting from the counterweight frame rail 368. Optionally, more than one counterweight frame rail 368 may be disposed on vertical frame member 114. In embodiments with more than one counterweight frame rail 368, the outer face of the rear gantry frame 320 may have a corresponding number of counterweight sliders 370 permanently or removably affixed.

As the gantry assembly is supported by the main datum frame slider(s) 358 on one end and the counterweight slider(s) 370 on an opposing end, the gantry assembly can move freely vertically along main datum frame rail(s) 356 and counterweight frame rail(s) 368, without rotating and applying significant frictional force to any of rail(s) 356, 368.

One or more main datum frame lead screws 362 may be disposed vertically along, e.g., substantially all of the height of the main datum frame 112. In an embodiment, the number and of main datum frame lead screws 362 may correspond to the number of main datum frame rails 356. For example, in embodiments with two main datum frame rails 356, each disposed on an opposite side of opening 118, the two main datum frame lead screws 362 may similarly be disposed on an opposite side of opening 118. Each main datum frame lead screw 362 may be attached at a bottom end to a main datum frame lead screw mount 366. Each main datum frame lead screw mount 366 may be permanently or removably affixed to the counterweight frame 140. In an embodiment with two main datum frame lead screws 362, one main datum frame lead screw mount 366 may be affixed to the left lower frame member 146 near the main datum frame 112, and the other main datum frame lead screw mount 366 may be affixed to the right lower frame member 148 near the main datum frame 112. Any or all of the main datum frame lead screw mounts 336 may have a rotatable inner layer, such as a bearing, disposed within a fixed outer layer that attaches to the counterweight frame 140. Each main datum frame lead screw 362 may be connected to the inner layer of a respective main datum frame lead screw mount 366, such that translation movement of the main datum frame lead screw 362 is prevented, but rotational movement of the main datum frame lead screw 362 is allowed.

To interact with the one or more main datum frame lead screws 362, one or more main datum frame nuts 364 may be disposed on each of the main datum frame lead screws 362 and permanently or removably affixed to the right gantry corner block 334 and/or the left gantry corner block 336. In an embodiment with two main datum frame lead screws 362 disposed on opposite ends of opening 118, one main datum frame nut 364 may be affixed to the right gantry corner block 334, and one main datum frame nut 364 may be affixed to the left gantry corner block 336. The gantry assembly, and by extension the spindle 302 may move vertically along the length of the main datum frame lead screws 362 based on the rotation of the main datum frame lead screws 362.

Rotation of any of the main datum frame lead screws 362 may be effected by an actuator, such as an electric motor 372. Each of the main datum frame lead screws 362 may be actuated by a respective electric motor 372. In an alternate embodiment, a single electric motor 372 may rotate all main datum frame lead screws 362 at the same time. The electric motor 372 may be permanently or removably affixed to the rear face 116 of the main datum frame 112, and may be directly connected to the top end of a main datum frame lead screw 362.

Advantageously, as the main datum frame rail(s) 356 are affixed directly to the rear face 116 of main datum frame 112, the gantry assembly and by extension the spindle 302 will remain perpendicular or substantially perpendicular to the main datum frame 112, regardless of the orientation of main datum frame 112. That is, main datum frame 112 does not need to be positioned perfectly vertically from the ground in order to maintain perpendicular alignment with spindle 302. Further, as the front face 114 and rear face 116 of main datum frame 112 may be ground parallel to each other as previously described, the work piece table 202 and by extension work piece 260 will also remain perpendicularly aligned with the spindle 302, regardless of the orientation of main datum frame 112. As a result, the spindle 302 can accurately be positioned within the enclosed working volume without requiring constant calibration or measurement before use. Additionally, due to the use of the counterweight frame 140 and the main datum frame 112, the overall weight of CNC machine 100 may be reduced while retaining the necessary rigidity and accuracy of the cutting system.

It will be appreciated that as a result of the above-described system, the spindle 302 can move freely along 3 axes. As well, the spindle 302 can hold its position along any axis for an indefinite amount of time, and move freely along any axis while maintaining its position in another. Additionally, the spindle 302 can move along multiple axes at the same time, and does not need to wait for movement along one axis to conclude before moving along another axis.

It will further be appreciated that although a specific configuration has been described above, other linear movement systems may be employed in lieu of any or all of the above systems. For example, other linear movement systems may include a rack and pinion system, use of linear actuators, use of a capstan drive with string or fiber, and a belt drive, among others. Any linear movement system may further be implemented in addition to or in conjunction with any other linear movement system, including the ones previously described. It should be understood that embodiments described are exemplary, and not limiting to a specific configuration or system.

### Machining a Work Piece

In accordance with this aspect, which may be used by itself or with one or more of the other aspects set out herein, a CNC machine may locate the position of the cutting tool with respect to a work piece in the working volume prior to commencement of a machining operation.

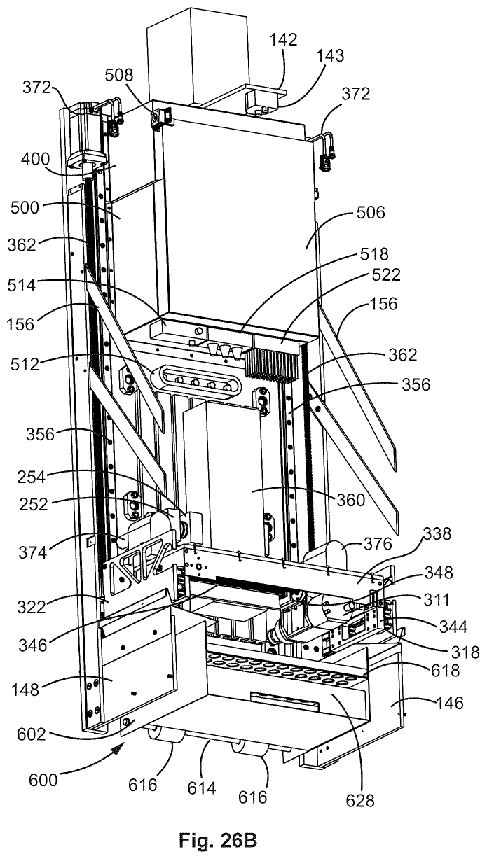

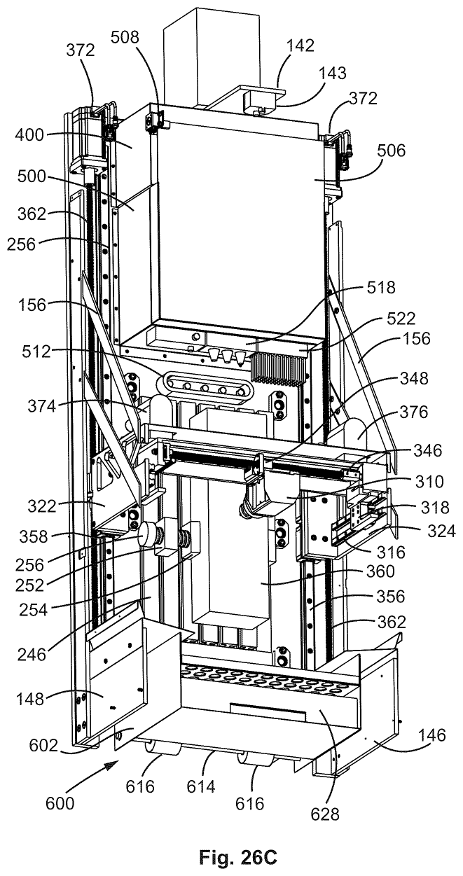

Once a work piece 260 has been secured in the enclosed working volume through opening 118, and the opening 118 has been closed and preferably sealed by the work piece table 202, the spindle 302 can use the cutting bit 308 to machine the work piece 260. Through the gantry assembly as previously described, the spindle 302 can access a large portion of the enclosed working volume of CNC machine 100. Before machining the work piece 260, the spindle 302 may ‘touch off’ against several areas on the work piece table 202, the work piece holding member (e.g., a spoil board 244 or T-slot table 246), and/or the work piece 260 to set the location of the cutting bit 308 with respect to the work piece within the enclosed working volume (FIG. 26A to 26C). For example, the spindle 302 may touch off against one or more corners of the work piece holding member (FIGS. 26A and B), as well as one or more portions of the work piece 260 (FIG. 26C). The touch off points may be automatically determined by the CNC machine 100, or may be input by an operator. In embodiments, where an electronic display screen 132 comprises an interactable UI, an operator may input touch off points via the UI.

Accordingly, the spindle 302 may touch off on various areas using an instrument such as a touch probe. Alternately or in addition, the spindle 302 may incorporate pressure sensors so that the touch off can be done with a cutting bit 308. Force readings or measurements from the touch off process may be displayed on the electronic display screen 132.

Once the location of the cutting bit 308 with respect to the work piece within the enclosed working volume is determined, the spindle 302 can rotate the cutting tool 308 to begin to machine the work piece 260. As will be appreciated, any number of machining operations may be possible, such as cutting holes, slots, edging, milling, chamfering, and the like. For example, using a work piece holding member such as a tailstock and rotating clamp, a slot can be cut around the diameter of a round or substantially round part, or different holes can be cut in different areas by rotating the part. In a further example, using a work piece holding member such as a tailstock and rotating clamp, a thread can be cut in work piece 260 by constantly rotating work piece 260 during cutting.

Optionally, in addition to determining the location of the cutting bit 208 or alternately, one or more cameras may be provided, optionally within the working volume, to monitor a machining operation and/or to check if a cutting it is clean. For example, a right spindle camera 374 and a left spindle camera 376 may be disposed within the enclosed working volume in order to monitor the spindle 302 and cutting tool 308 as it machines the work piece 260 (FIG. 21). The cameras 374, 376 may be permanently or removably affixed to spindle platform 312, and angled towards cutting tool 308.

Optionally, lighting may be provided to enhance the visibility of the area targeted by the camera9s). For example, the cameras 374, 376 may include a light source to illuminate the cutting tool 308. Alternately or in addition, the counterweight frame 140, e.g., the upper frame member 142 of the counterweight frame 140, may include lighting 143 to illuminate the part or all of the enclosed working volume.

The video feedback of cameras 374, 376 may be sent to and displayed on an electronic display screen 132 in real time. In embodiments in which the electronic display screen 132 comprises an interactable UI, an operator may choose which camera video feed to display on the electronic display screen 132, or may choose to display all camera video feeds at once.

As the cutting tool 308 machines the work piece 260, cuttings may fly off of the cutting tool 308 and obstruct the view of one of one or more cameras. Accordingly, if the view of one of the cameras is obstructed, the electronic display screen 132 may alert the operator to display a different camera video feed on the electronic display screen 132. Alternately or in addition, the electronic display screen 132 may use artificial intelligence (AI) to determine whether a current camera video feed is obstructed, and automatically display a different camera video feed if the current camera video feed is obstructed.

Optionally, the spindle 302 may move the work tool 308 along the Z axis to a location at or exterior to the opening 118. Accordingly, if a work piece or work piece table is not blocking opening 118, then the work tool 308 may be moved through opening 118 outside of the enclosed working volume to be manually cleaned or changed.

Sealing Screen with a Plurality of Individually Moveable Plates

In accordance with this aspect, which may be used by itself or with one or more of the other aspects set out herein, a work piece may not be fully receivable within the working volume of a CNC machine. Accordingly, to inhibit coolant and/or cuttings from exiting the working volume, the CNC machine may be provided with a closure member which is adjustable to generally match the profile of a work piece.

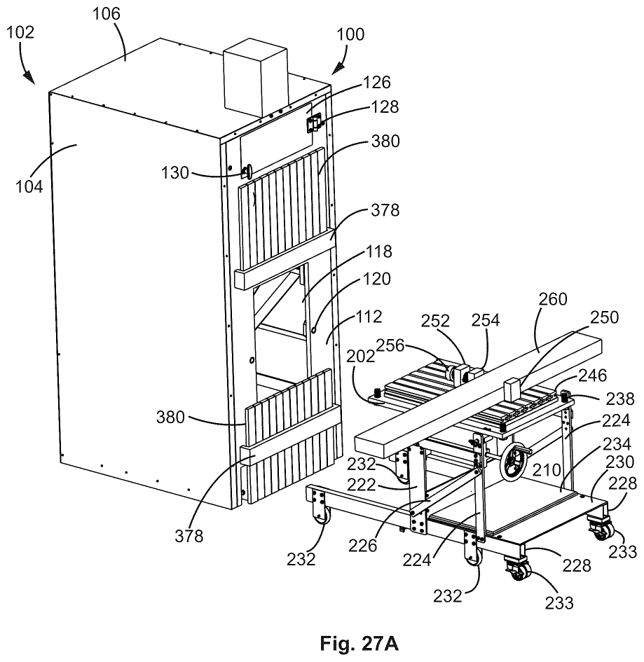

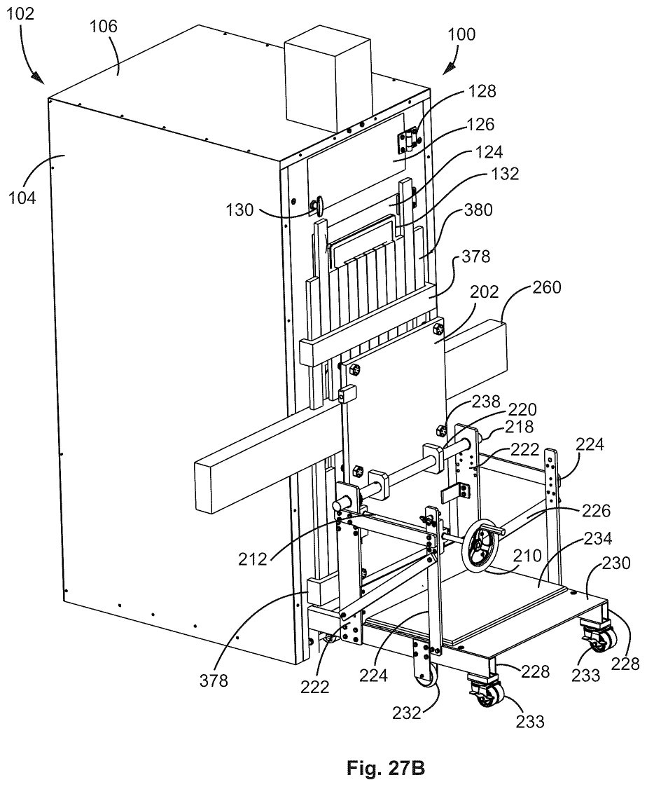

If a work piece 260 does not fit through opening 118 or does not enter the enclosed working volume, a closure member that can adapt to the profile of the work piece may be provided. Accordingly, the closure member, e.g., a sealing screen 378 as exemplified in FIG. 27A, may comprise a plurality of moveable members, e.g., sealing plates 380, each of which may be independently moveable. The moveable members, e.g., sealing plates 380, may move is a single axis, e.g., the Y axis (see for example FIG. 27B). As exemplified, each of the sealing plates 380 may be individually longitudinally translatable along the Y axis.

A sealing screen 378 containing a plurality of sealing plates 380 may be affixed, or removably affixed, to the front face 114 of the main datum frame above, below and or to a side of the opening 118 (FIG. 27A). In embodiments of the main datum frame 112 with more than one opening 118, a singe sealing screen 378 may be affixed below and/or above all openings 118 or each opening may have its own sealing screen 378.

Optionally, the sealing plates 380 may not cover the fastening holes 120 on the main datum frame 112, so that a work piece table 202 may still be removably affixed to main datum frame 112.

As the work piece 260 approaches the opening 118 and, e.g., abuts the front face 114 of the main datum frame 112, the sealing plates may be moved towards the opening 118 so as to surround the perimeter of the work piece 260, and close the opening 118 (FIG. 27B). As a result, even though the work piece table 202 does not close the opening 118 and the work piece 260 remains partially or fully outside of the enclosed working volume, the opening 118 is sealed such that dust, debris, cuttings, and any other byproducts of the machining operations are inhibited from escaping from the enclosed working volume. As each sealing plate 380 is individually translatable, the plurality of sealing plates 380 can conform to an irregularly shaped work piece 260.

It will be appreciated that, in such embodiments, the work tool 308 may move in the Z axis to reach the work piece and may be operable exterior to the working volume.

It will be appreciated that a long work piece 260 (in the Z axis) may be partially inserted through opening 118 and surrounded by sealing plates 380 in order to machine the end of the work piece 260 in the working volume.

### Electronics Bay

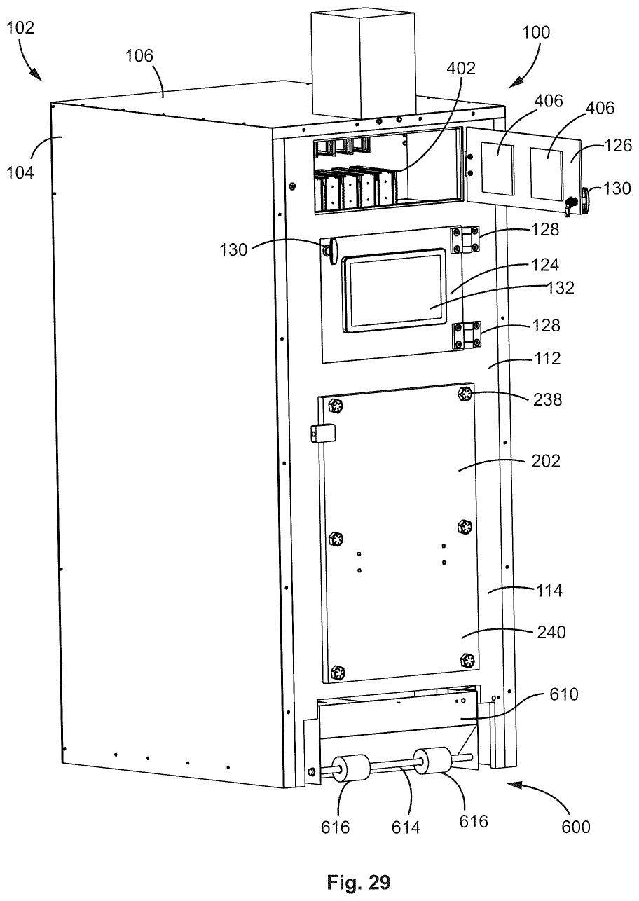

In accordance with this aspect, which may be used by itself or with one or more of the other aspects set out herein, a CNC machine may have an electronics bay, which may be accessible from the front of the CNC machine to store electronics. The electronics bay 400 may be used to store any electronic components 402 required for operation of the various components of the CNC machine 100, such as a power supply unit, a control unit (such as, for example, a microcontroller, a programmable logic controller, or a computer), wirings, and any other electrical connections or boards (FIG. 29).

An electronics bay 400 may extend from the main datum frame 112 into the enclosed working volume of the CNC machine 100 (FIGS. 3 & 24). The electronics bay 400 may be permanently or removably affixed to the rear face 116 of the main datum frame 112.

The electronics bay 400 may be accessible to remove, replace, or repair any of electronics components 402, or to add new components into the electronics bay 400.

The electronics bay 400 may be accessible from the front face 114 of main datum frame 112 via a door. If a tool bay 500 is also provided, as discussed subsequently, then the electronics bay may be provided above the tool bay. In such a case, the electronics bay may be accessed by an upper door 124 and the tool bay 500 may be accessed by a lower door 124. Alternately, if a tool bay 500 is also provided, one door 136 may be provided to access both the tool bay 500 and the electronics bay 400.

Optionally, the electronics bay 400 is only accessible from the front face 114 of the main datum frame 112 (e.g., through a door 126, 136), so the electronics bay 400 can be safely accessed while the CNC machine 100 is machining a work piece 260.

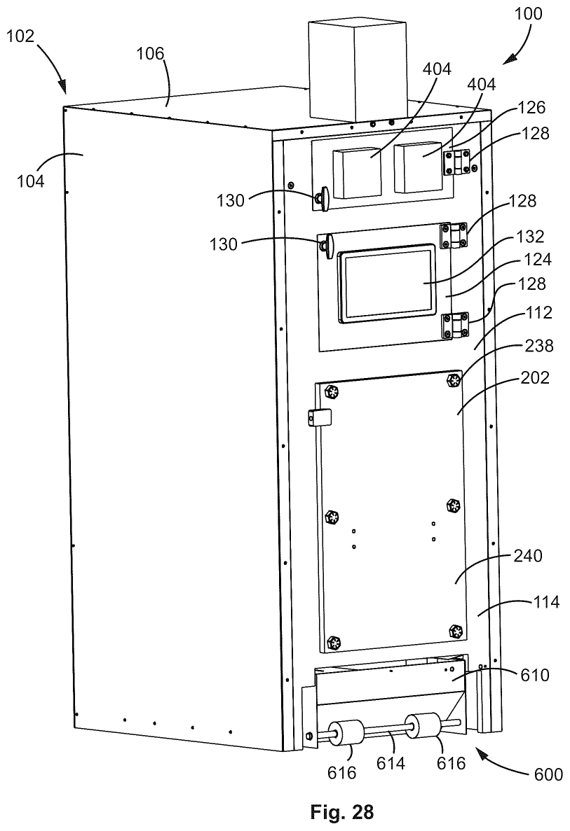

One or more fans may be provided to cool the electronics bay 400. For example, to cool the electronic components 402 and allow air flow through the electronics bay 400, the door (e.g., upper door 126 as exemplified) may have one or more inlet fans 404 permanently or removably mounted onto the upper door 126 (FIG. 28). The air blown by each inlet fan 404 may travel through an inlet filter 406 before entering the electronics bay.

Optionally, the inlet filters 406 may be accessible when the upper door 126 is open (FIG. 29). In embodiments with one door 136, the one or more fans 404 and the inlet filters 406 may be mounted on the upper half of door 136.

The electronics bay 400 may further have an outlet port to enable air to exit the electronics bay 400. Optionally, one or more outlet fans may be disposed, e.g., within the electronics bay 400 to blow air through the outlet port. Air may exit the electronics bay 400 and travel to the ambient or the air may travel through one or both of the tool bay 500 and the working volume before exiting to the ambient.

The air flow through the electronics bay 400 may have one or more cyclonic stages, in which particulate matter is separated from the air. The one or more cyclonic stages may be fluidically connected in parallel at an inlet port of electronics bay to filter air entering the electronics bay 400 and/or at the outlet port of electronics bay 400 to filter air exiting the electronics bay.

The outlet port of electronics bay 400 may be in fluid flow communication with the ambient to allow air to travel outside of the CNC machine 100. Alternately or in addition, the outlet port of electronics bay 400 may be in fluid flow communication with the working volume to allow air to travel into the enclosed working volume of the mill body 102. In an embodiment where the outlet port of electronics bay 400 allows air to travel into the enclosed working volume of the mill body 102, the mill body 102 may additionally have an outlet port to allow air to exit the mill body 102.

One or both of the mill body outlet port and the electronics bay outlet port may have a filter, which may be a high efficiency particulate air (HEPA) filter.

As the electronics bay outlet filter and the mill body outlet filter become clogged with particulate matter, air flow through the filters may be obstructed. If, for example, the electronics bay outlet filter becomes clogged, but the mill body outlet filter does not, air flow may into the mill body 102 may be slowed while air flow out of the mill body 102 remains unaffected, lowering the pressure of the enclosed working volume of mill body 102. If the pressure inside the enclosed working volume of mill body 102 becomes too low, there may be a risk of walls 104, 106, 108, 110 collapsing inwards due to the pressure differential inside the mill body 102 and outside of the mill body 102. To alleviate the risk, one or more one-way valves may be disposed within mill body 102 which may allow air into the mill body 102 if the pressure differential between inside the mill body 102 and outside the mill body 102 is too large. One or all of the one-way valves may incorporate a hall effect sensor to produce an electronic signal when the valve is actuated. In an embodiment, the electronic signal produced by the hall effect sensor may be displayed on the electronic display screen 132.

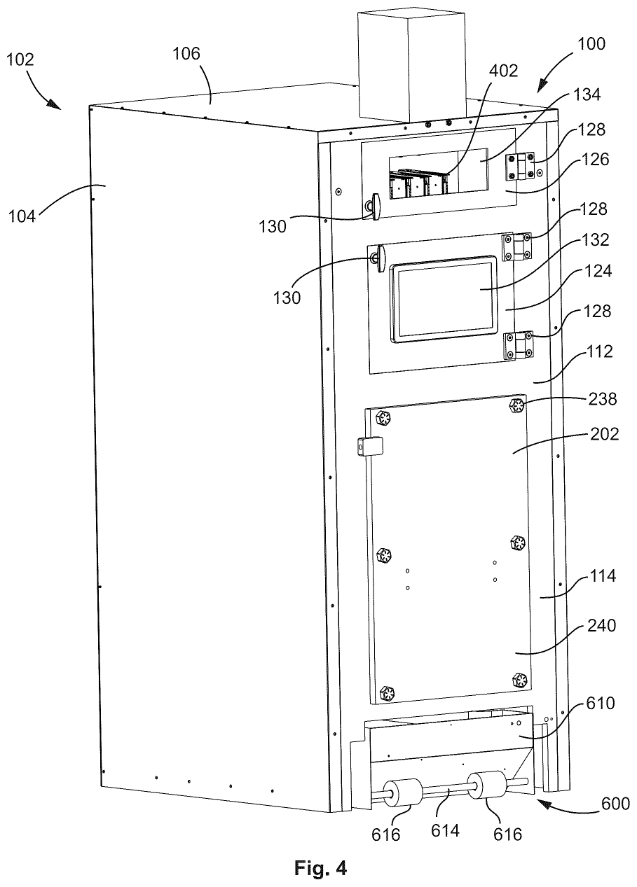

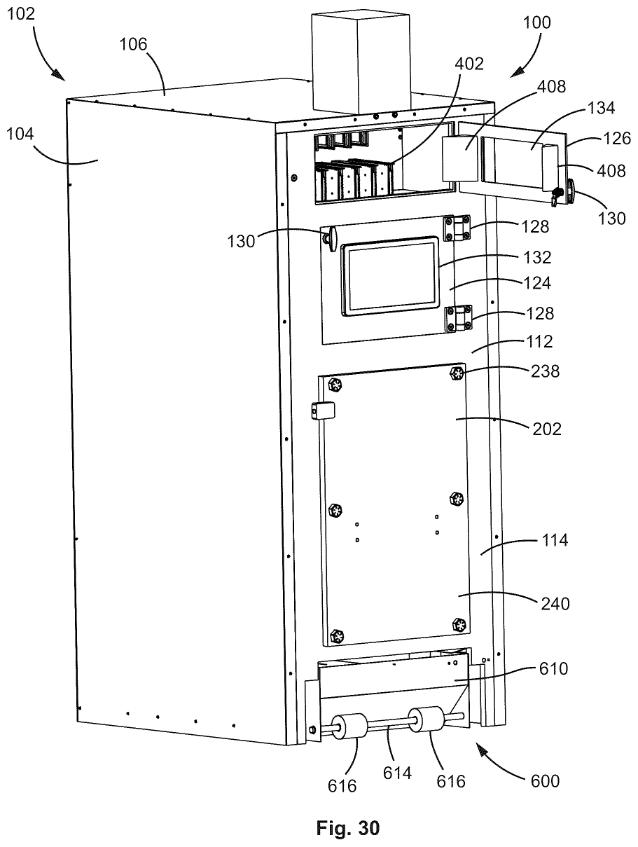

In embodiments where the upper door has a window 134 (FIG. 4), an operator may view the inside of the electronics bay 400. One or more mirrors 408 may be affixed to the rear face of upper door 126 to allow an operator to view the one or more inlet filters 406 and/or the one or more outlet filters (FIG. 30), preferably the upstream side thereof. Alternately or in addition, one or more mirrors 408 may be affixed in the electronics bay 400.

Optionally, one or more light sources may be disposed within electronics bay 400 to illuminate the space.

### Tool Bay

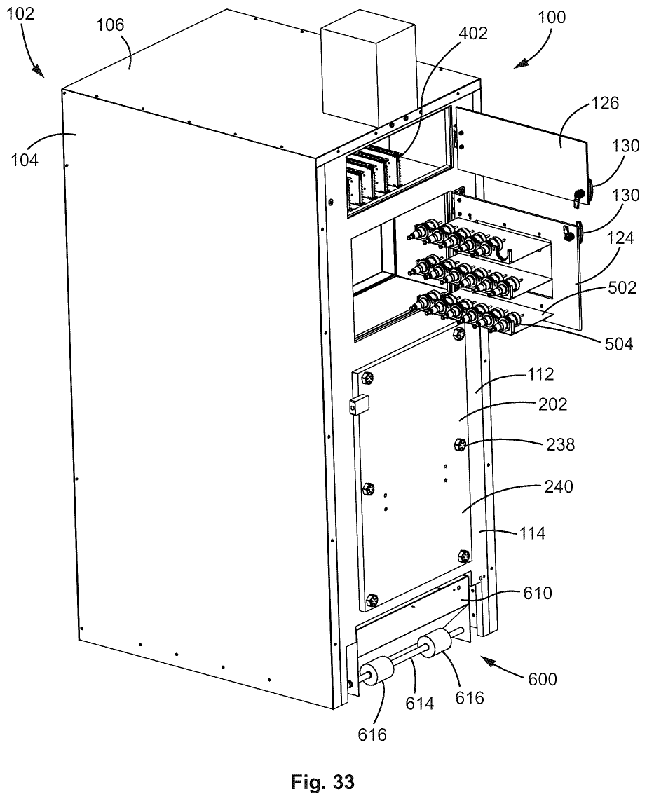

In accordance with this aspect, which may be used by itself or with one or more of the other aspects set out herein, a CNC machine may have a tool bay comprising a plurality of tools which may be accessed from outside the CNC machine and/or inside the CNC machine. The tool bay 500 may be used to store a plurality of work tools 504 to be used by the spindle 302 (FIG. 33).

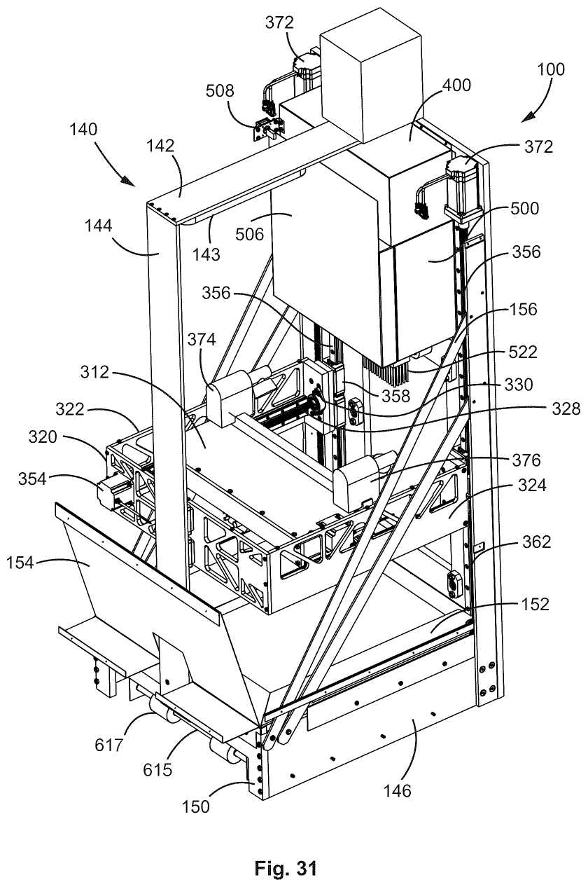

Similar to the electronics bay as outlined previously, a tool bay 500 may extend from the main datum frame 112 into the enclosed working volume of the mill body 102 (FIG. 31). The tool bay 500 may be permanently or removably affixed to the rear face 116 of main datum frame 112.

To enable an operator to access the tool bay 500 to remove, replace, or repair any of work tools 504, or clean tool bay 500 during machining operations a door is provided on the exterior of the CNC machine. As discussed previously, if an electronics bay is provided, the tool bay 500 may be below the electronics bay 400. Each of the electronics bay 400 and the tool bay 500 may be accessible from the front face 114 of main datum frame 112. Optionally two doors 124, 126 are provided so the bays may be separately accessibly and the tool bay 500 may be accessible via the lower door 124. If one door 136, the tool bay 500 may be accessible via the door 136.

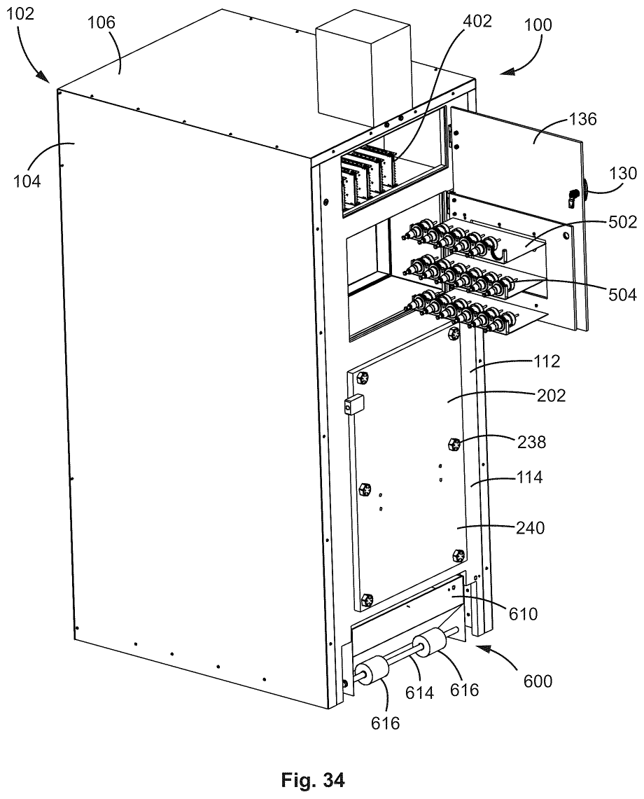

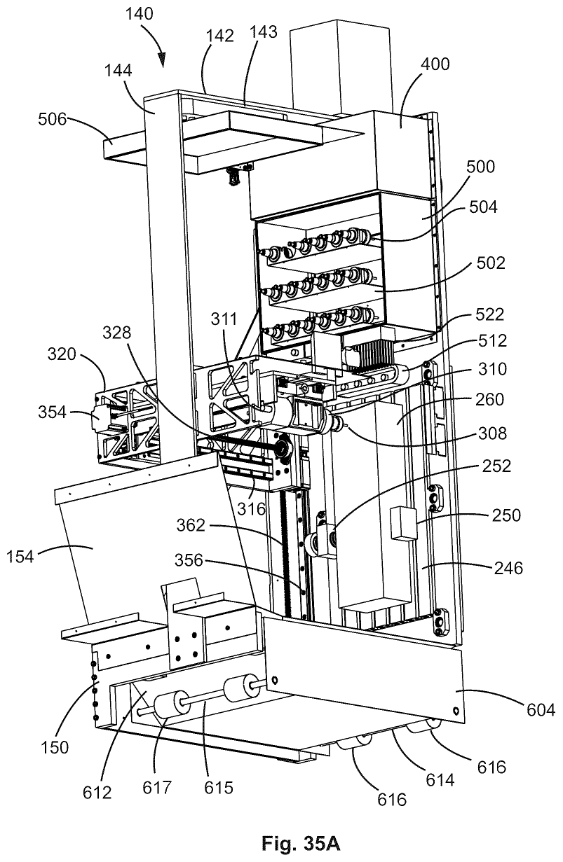

The plurality of work tools 504 may be removably stored horizontally on a tool bay shelf 502. In an embodiment with two doors 124, 126, the tool bay shelf 502 may be permanently or removably affixed to the inside of lower door 124. In an embodiment with one door 136, the tool bay shelf may be permanently or removably affixed to the bottom half of door 136 (FIG. 34). It will be appreciated that in embodiments with one door 136, both the tool bay 500 and the electronics bay 400 may be accessible via door 136.

Optionally, one or more lighting elements may be disposed in the tool bay 500 to illuminate the space for an operator.

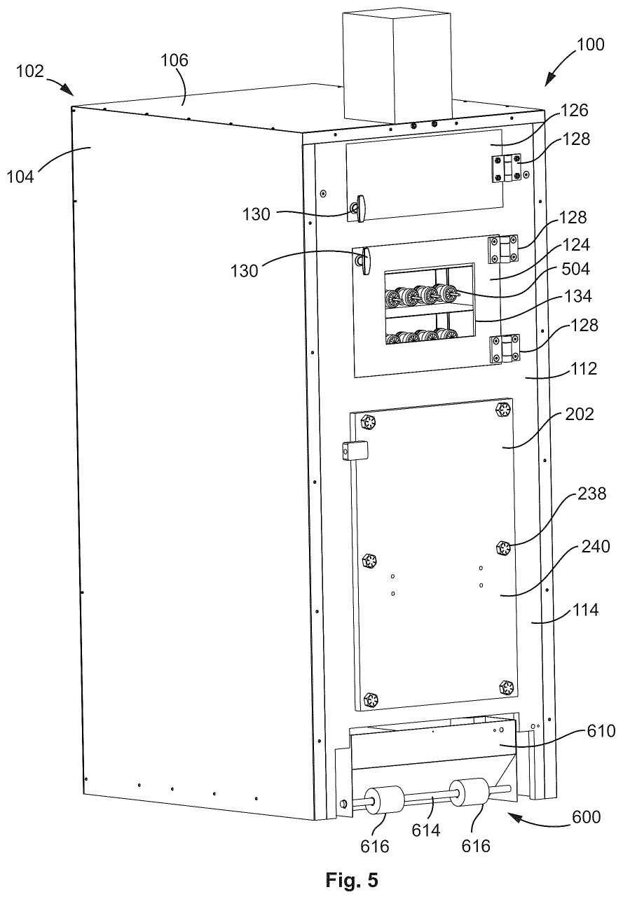

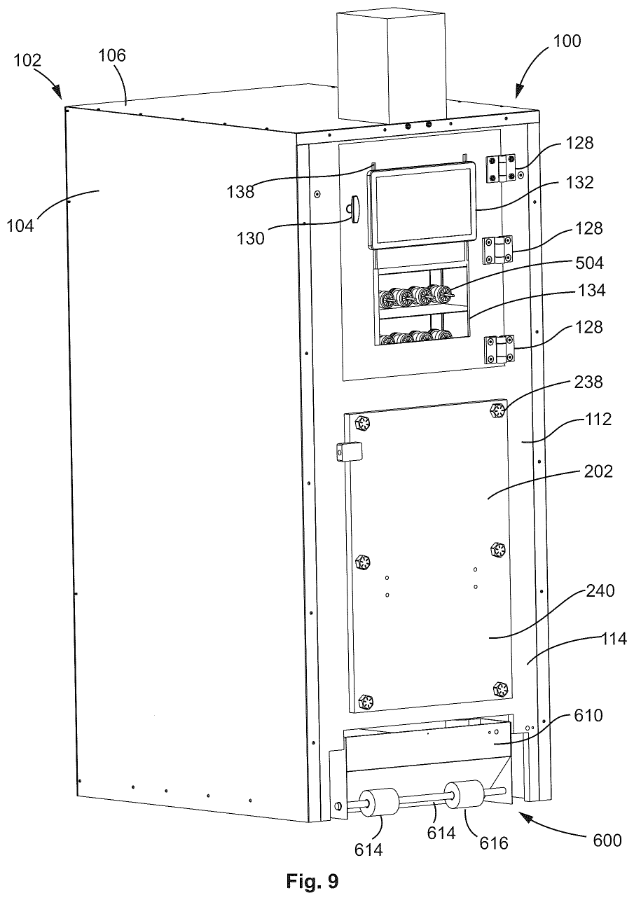

Optionally, the interior of the tool bay 500 may be viewed through a window 134 in the lower door 124 or door 136 (FIGS. 5 and 9). Alternately or in addition, a camera may be disposed within tool bay 500 that may display video feedback on the electronic display screen 132 to the operator.

In an embodiment, the tool bay 500 may have a positive pressure relative to the enclosed working volume of the mill body 102. By having a positive pressure in the tool bay 500 relative to the mill body 102 (e.g., the working volume), any particulate or dust from the machining operations will be inhibited from flowing into the tool bay 500 and interfering with work tools 504.

This relative higher positive pressure in the tool bay 500 may be created via, for example, the air flow out of the electronics bay 400 into the tool bay 500 via an inlet port in the tool bay 500 to allow air to flow into the tool bay 500.

Optionally, air exiting the tool bay 500 may travel into the working volume. For example, air flow such as that created by a cooling fan for the electronics bay 400 may be used to circulate air in the working volume during a machining operation. It will be appreciated that air flow created by a cooling fan may travel directly into the working volume from the electronics bay 400 or from the electronics bay 400 to the tool bay 500 and then to the working volume. Accordingly, the inlet port of the tool bay 500 may be in flid flow communication with the outlet port of the electronics bay 400, such that air flows through the electronics bay 400 into the tool bay 500.

In an embodiment, a one-way valve may be disposed in the air flow path such that if the tool bay 500 (or the electronics bay 400) has a relative negative pressure, the one-way valve may actuate to stabilize the pressures. The one-way valve may be triggered to close, thereby closing an outlet frow path, if the pressure in a bay falls below a preset limit.

It will be appreciated that the inlet air flow path into the tool bay 500 and/or the outlet air flow path from the tool bay 500 may include a HEPA filter. Alternately or in addition, one or more cyclonic stages may be provided to remove particulate matter from incoming or outgoing air.

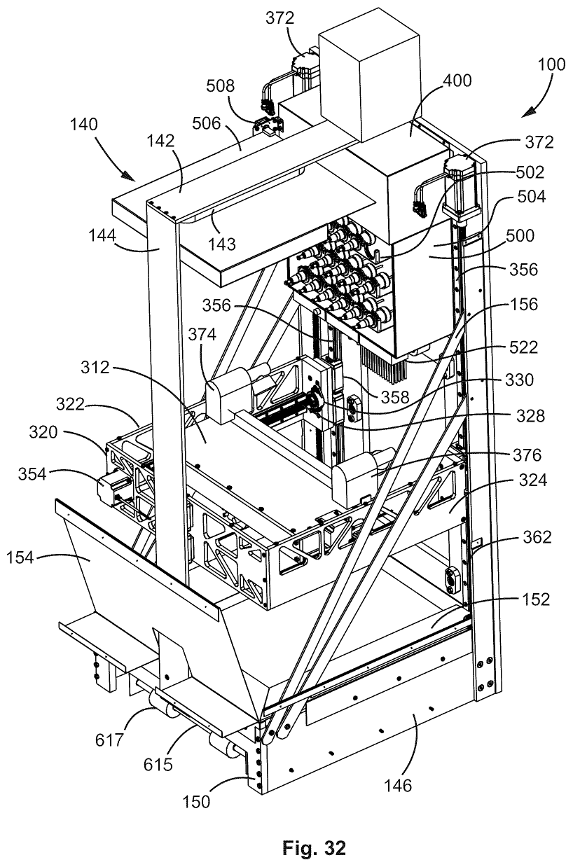

The tool bay 500 may be accessible from the enclosed working volume of mill body 102 via an interior door 506 (FIG. 31). The interior door 506 may be opened via a motorized hinge 508 which may be connected, e.g., to the exterior of the electronics bay 400 or the tool bay 500. The motorized hinge may be actuated by an electric motor, such as a servo motor or a stepper motor, to automatically raise the interior door 506 from a closed position to an open position, whereby in the open position, the plurality of work tools 504 are accessible (FIG. 32). In use, an operator may interact control the opening and/or closing of door 506, e.g., such as by using an electronic display screen 132 to open and close the interior door 506. Alternately or in addition, the interior door 506 may be opened by the spindle 302. For example, a button may be disposed within the enclosed working volume of the mill body 102, such as on the rear face 116 of the main datum frame 112. When pressed by the spindle 302, the button may issue a signal to causes the motorized hinge 508 to open the interior door 506 if the door 506 is closed, and close the interior door 506 if the door 506 is open. Alternately or in addition, a motion sensor may be disposed within the enclosed working volume of the mill body 102, such as on the rear face 116 of the main datum frame 112. The motion sensor may be placed so as to not be accidentally activated during normal machining operations. When the motion sensor detects motion of, for example, the spindle 302 to a particular location, the motion sensor may issue a signal that causes the motorized hinge 508 to open the interior door 506 if closed, and close the interior door 506 if open.

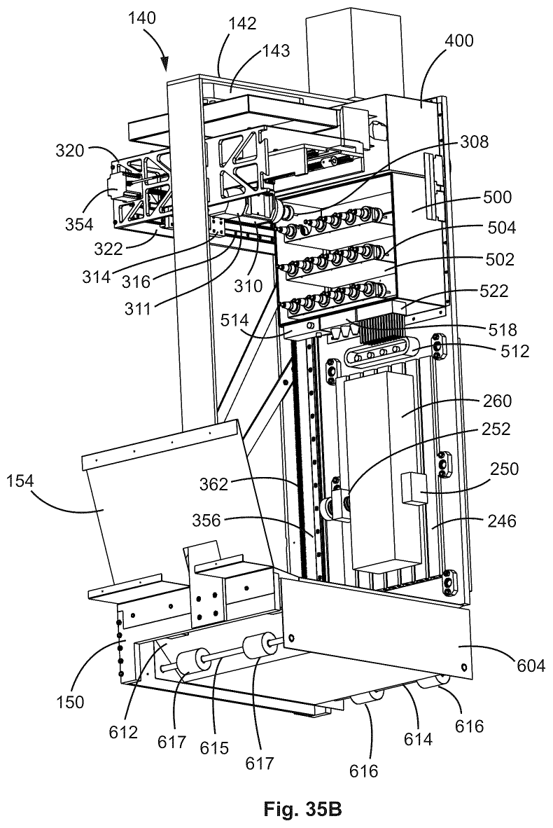

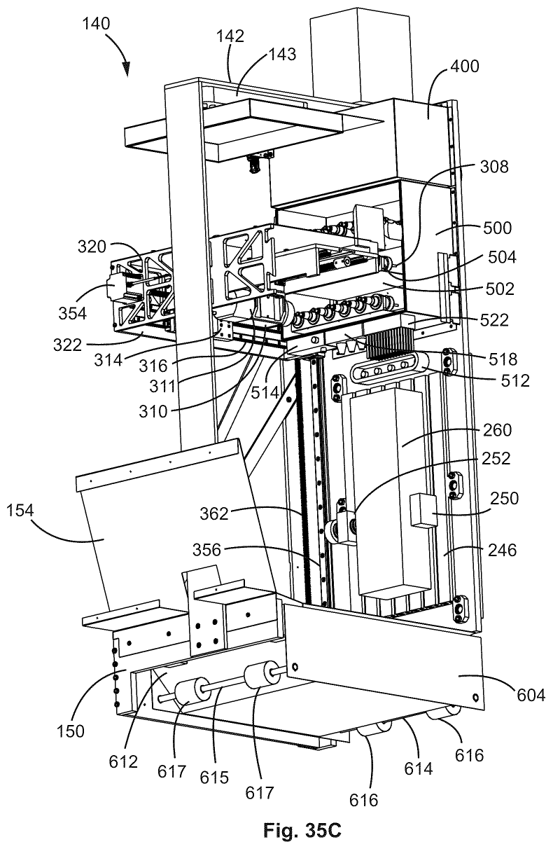

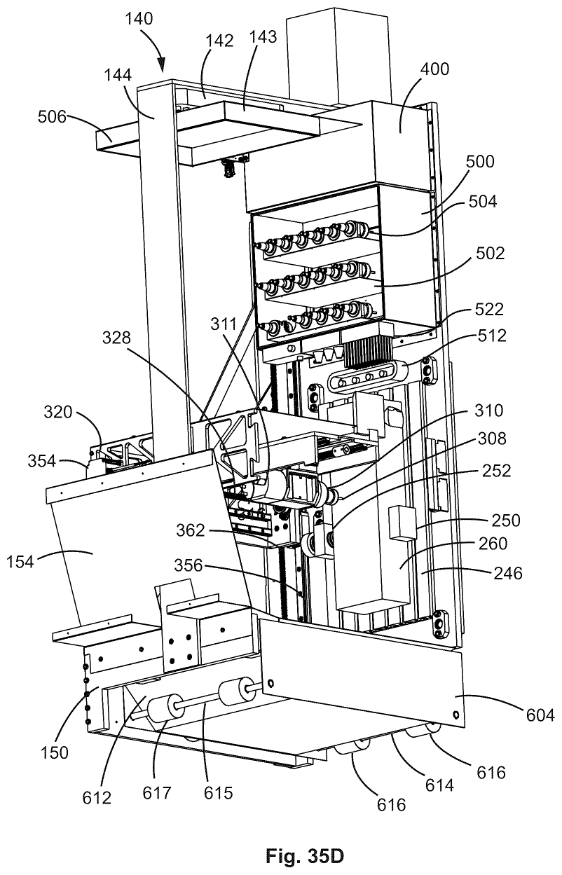

The spindle 302 may open interior door 506 and access the plurality of work tools 504 in order to automatically change tools during machining operations (FIGS. 35A to 35D). For example, machining a part may require cutting bits of different lengths, diameters, types, materials, or operating speeds. Using the gantry system as described previously, the spindle 302 can be moved into the tool bay 500 towards an open shelf slot 510 (FIG. 35B). After slowing or stopping rotation of spindle 302, it may be moved along the Z axis, and the work tool 306 holding cutting bit 308 may be placed into the open shelf slot 510, and released from the chuck 304. The spindle 302 can then be moved towards the required work tool 504, and secure the required work tool 504 in the chuck 304 (FIG. 35C). Once the required work tool 504 is secured in the chuck 304, the spindle 302 may close the interior door 506 and resume machining operations. It will be appreciated that, instead of using a chuck 304, the work tools 504 may be tapered such that they can be secured in the spindle 302 via friction.

As discussed previously, the CNC machine may have two doors to provide access to internal components of the CNC machine 100. These doors may provide access to openings in the main datum frame 112. As discussed, these may comprise a lower door 124 and an upper door 126. Optionally, e.g., if a tool bay 500 is larger than an electronics bay 400 and is located below the electronics bay 400, the lower door 124 may have a larger width and/or height than upper door 126. Each of lower door and upper door may have a respective one or more hinges 128, and a respective one or more handles 130. The one or more hinges 128 may connect the doors 124, 126 to the front face 114 of, e.g., the main datum frame 112, such that the doors open horizontally outwards (e.g., rotate sideways) when a pulling force is applied to one or more handles 130. Alternately or in addition, doors 124, 126 may have one or more hinges 128 that connect the doors 124, 126 to, e.g., the front face 114 of main datum frame 112, such that the doors open vertically outwards (e.g., rotate upwardly) when a pulling force is applied to one or more handles 130.

As exemplified in FIG. 1, both of doors 124, 126 may be positioned above opening 118 and above any fastening holes 120. However, optionally, fastening holes 120 may be positioned around and above one or both of doors 124, 126, and/or around opening 118.

As exemplified in FIGS. 4 and 5, one or both of doors 124, 126 may have a transparent screen or window 134 which allows an operator of the CNC machine 100 to view what is behind doors 124, 126. The window 134 may be made of glass, plastic, or any other transparent material that allows an operator to clearly see through the material. The window 134 may be any size within the door 124, 126, and may be any shape. In an embodiment, one or both of doors 124, 126 may have more than one window or the entire door may be transparent.

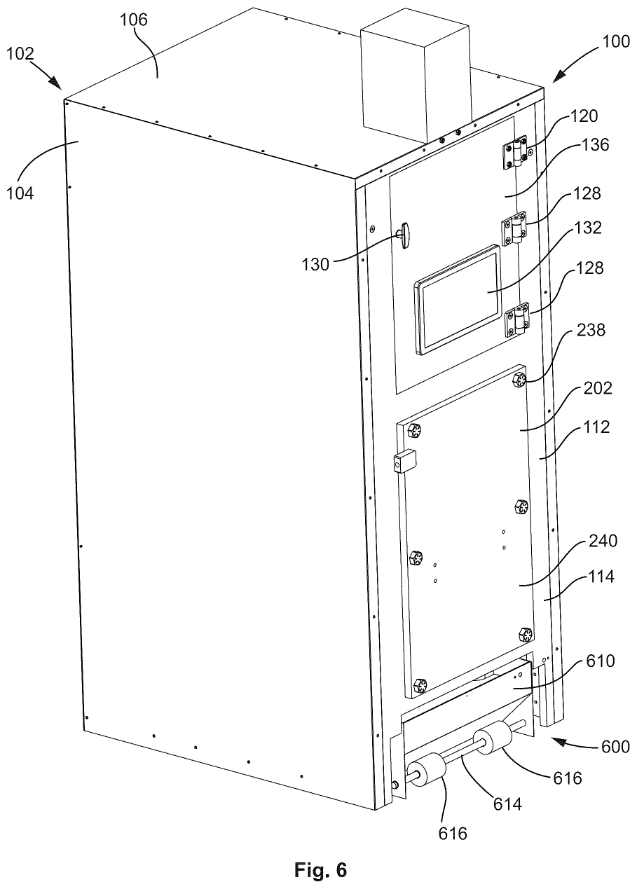

As discussed previously and as exemplified in FIG. 6, only have one door 136, which is configured to cover substantially the same area as doors 124, 126 exemplified in FIGS. 4 and 5, may be provided. The door 136 may similarly be connected to the front face 114 of, e.g., the main datum frame 112 via hinges 128, and may similarly have one or more handles 130. The door 136 may similarly be configured to open horizontally and/or vertically when a pulling force is applied to one or more handles 130.

Similar to embodiments containing two or more doors, fastening holes 120 may be disposed entirely below the door 136, or may be positioned around and above door 136.

### Cleaning a Working Tool

In accordance with this aspect, which may be used by itself or with one or more of the other aspects set out herein, a CNC machine may be equipped to clean a cutting bit 308 prior to and/or after use in a machining operation. During machining of a work piece 260, cutting chips or other material may build up on cutting bit 308 and reduce the efficiency of the cutting bit 308. An advantage of this design is that the tools may be cleaned while in the working volume.

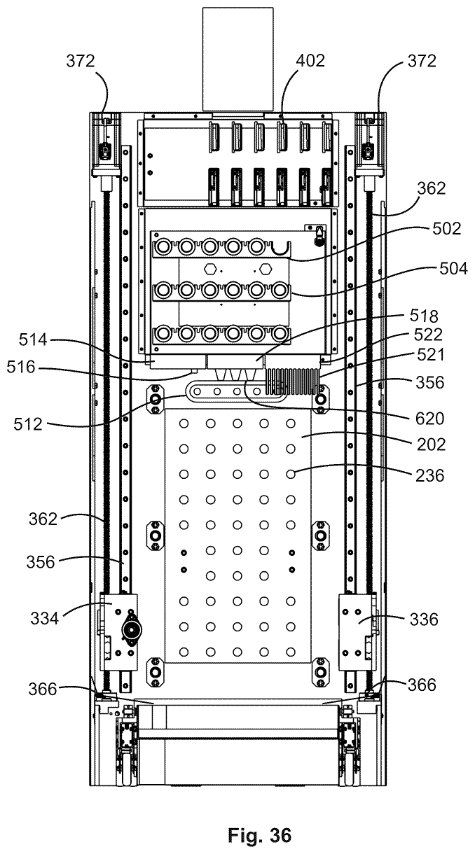

In accordance with this aspect, a cleaning unit, which may include three cleaning stages, may be provided. The cleaning members of the cleaning unit may be removably or permanently affixed inside the working volume, e.g., under the tool bay 500. The cleaning unit may use any or all of the three stages, namely a liquid rinse unit 514, an air blow off unit 518, and a brush off unit 522 to clean the cutting bit 308 (FIG. 36).

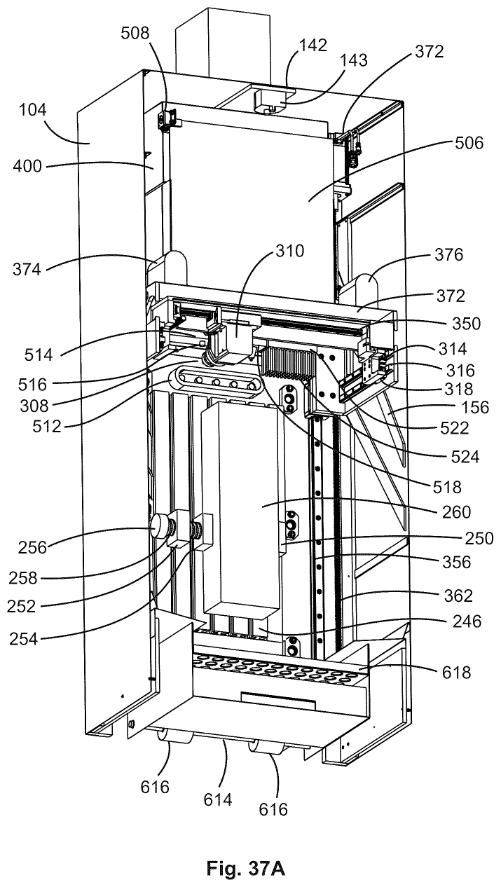

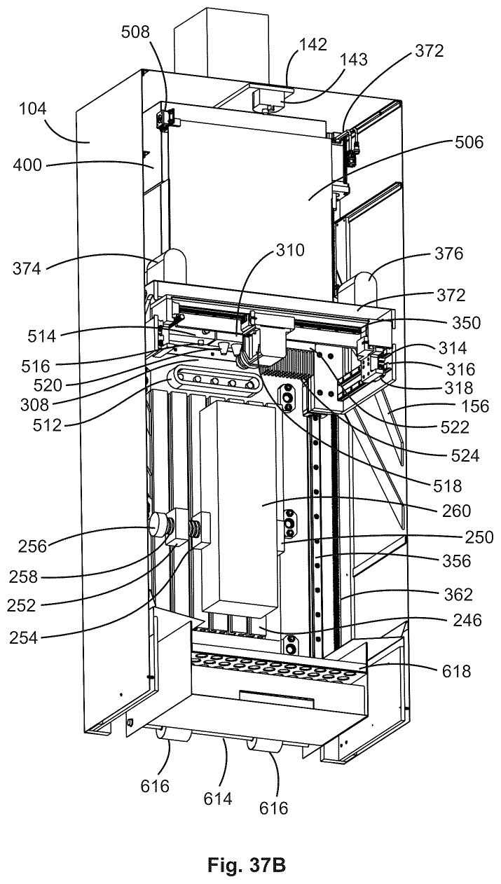

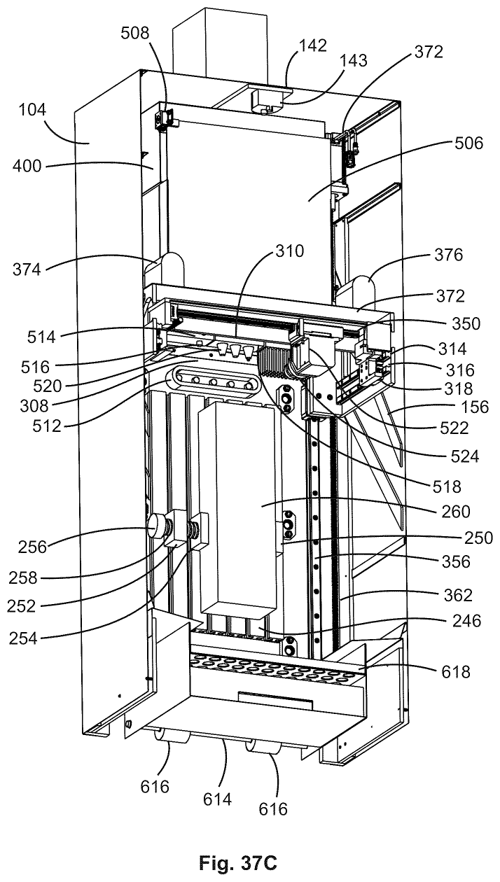

During the liquid rinse stage, the cutting bit 308 may be moved below a liquid nozzle 516 of the liquid rinse unit 514, and a liquid such as water or heavily diluted coolant may be dispersed from liquid nozzle 516 onto cutting bit 308 (FIG. 37A). During the liquid rinse stage, the cutting bit 308 may be kept stationary, may be translated along any axis, and/or may be rotated. In an embodiment, the liquid rinse unit 514 may include a motion sensor, which may be disposed below or near the liquid nozzle 516, to signal when the cutting bit 308 is positioned under liquid nozzle 516. The liquid nozzle 516 may disperse liquid for a set amount of time, or may disperse liquid until the motion sensor detects that the cutting bit 308 is no longer positioned under liquid nozzle 516. The liquid flow out of liquid nozzle 516 may be pressurized to increase the velocity of the liquid, or main flow out of nozzle 516 due only to the force of gravity. In an embodiment, the liquid rinse unit 514 may include more than one liquid nozzle 516.

During the air blow off stage, the cutting bit 308 may be moved below one or more air nozzles 520 of the air blow off unit 518, and pressurized air may be blown out of the one or more air nozzles onto cutting bit 308 (FIG. 37B). During the air blow off stage, the cutting bit 308 may be kept stationary, may be translated along any axis, and/or may be rotated. In an embodiment, a motion sensor, which may be part of the air blow off unit 518 and may be the same sensor as used with the liquid rinse unit 514, may be disposed below or near the one or more air nozzles 520 to signal when the cutting bit 308 is positioned under the one or more air nozzles 520. The one or more air nozzles 520 may blow air onto cutting bit 308 for a set amount of time, or may blow air until the motion sensor detects that the cutting bit 308 is no longer positioned under any one of the air nozzles 520.

During the brush off stage, the cutting bit 308 may be moved into one or more bristles 524 of the brush off unit 522 which may hang vertically in close proximity to one another (FIG. 37C). During the brush off stage, the cutting bit 308 may be kept stationary, may be translated along any axis, and/or may be rotated. Alternately or in addition, the brush off unit 522 may vibrate or move the one or more bristles 524 against the cutting bit 308. In an embodiment, a motion sensor, which may be part of the brush off unit 522 and may be the same sensor as used with the liquid rinse unit 514 and/or the air blow off unit 518, may be disposed below or near the group of bristles 524 to signal when the cutting bit 308 is positioned within the group of bristles 524. In an embodiment where the brush off unit 522 moves the bristles 524, the bristles 524 may move for a set amount of time, or may move until the motion sensor detects that the cutting bit 308 is no longer positioned within the group of bristles 524.

It will be appreciated that the stages of the cleaning process may take place in any order, and any stage of the cleaning process may be repeated if necessary. Further, any stages of the cleaning process may be skipped, or may be performed independent of any other stages of the cleaning process.

Optionally, a tool cleaning camera 512 may be disposed near or below the liquid rinse unit 514, the air blow off unit 518 and/or the brush off unit 522. The tool cleaning camera 512 may face the cutting bit 308 before and after the cleaning process. Alternately or in addition, right spindle camera 374 and/or left spindle camera 376 (if provided) may be used in addition to or instead of tool cleaning camera 512 to determine if the cutting bit 308 requires cleaning stages.

Optionally the tool cleaning camera 512 may be equipped with lighting elements to illuminate the cutting bit 308. The video feedback of tool cleaning camera 512 may be displayed on, e.g., the electronic interface 132 which is discussed subsequently. Based on the video feedback of tool cleaning camera 512, an operator may determine that additional cleaning stages are necessary. Alternately or in addition, AI may be used to determine whether the tool has been adequately cleaned or requires additional cleaning stages, or that cleaning stages can be skipped.

It will be appreciated that the cutting bit 308 may always undergo one or more cleaning stages before being placed in the tool bay 500 so that the work tool 504 may be changed. Alternately, the cutting bit 308 may be placed within the view of the tool cleaning camera 512 to determine whether the cutting bit 308 requires cleaning before being placed in the tool bay 500. Alternately or in addition, after replacing work tool 306 with a new work tool 504, the cutting bit of the new work tool 504 may undergo one or more cleaning stages before machining the work piece 260.

It will be appreciated that the tool cleaning camera 512 may be used to determine if a cutting bit 308 is damaged or broken. For example, if a cutting bit 308 should contact the work piece 260, but a change in power level in the spindle 302 is not detected (i.e., the cutting bit 308 is not contacting the work piece 260), a camera may be used to determine if the cutting bit 308 is broken. In an embodiment, the video feedback from the camera may be displayed on the electronic display screen 132 for an operator to determine whether the cutting bit 308 is damaged or broken. Alternately or in addition, an AI system may be employed to automatically determine whether the cutting bit 308 is damaged or broken based on the video feedback from tool cleaning camera 512.

### Removable Chip and Coolant Tray

In accordance with this aspect, which may be used by itself or with one or more of the other aspects set out herein, a CNC machine may have a removable chip and/or coolant tray which can enter and exit the enclosed working volume of the mill body.

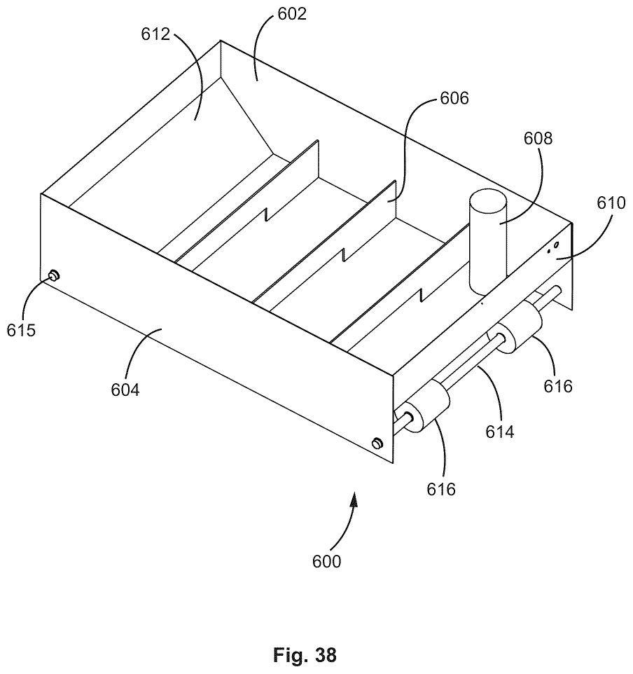

In order to collect cuttings and fluid, a coolant tray 600 may be used with the CNC machine 100 (FIG. 38). The coolant tray 600 may be of any shape that may underlie part or all of the working volume. Accordingly, as exemplified, the coolant tray 600 may be substantially rectangular, and the sidewalls of the coolant tray 600 may comprise a coolant volume which can store coolant or any other fluid. Optionally, one or more side of the coolant tray, e.g., the rear end 610 and front end 612 of the coolant tray 600 as exemplified in FIG. 38, may be angled to allow fluid to flow into the coolant volume 628. Accordingly, coolant flowing down a wall of the working volume may be directed into the coolant tray 600.

One or more baffles 606 may be disposed in the coolant volume. For example, as exemplified, baffles 600 may extend completely or substantially between right wall 602 and left wall 604 of the coolant tray 600. An advantage of having the baffle(s) extend laterally or partially laterally is that they will inhibit fluid moving forwardly and backwardly as a coolant try 600 is withdrawn from, e.g., the front of the CNC machine.

A coolant pump 608 may be part of the coolant tray 600 and may be disposed within the coolant volume. The coolant pump 608 may be used to recirculate coolant that pools within the coolant volume. Accordingly, used coolant may collect in the coolant volume and be circulated through a recirculation conduit to a coolant jet(s) provided in the working volume. It will be appreciated that one or more filters may be provided in the coolant recirculation system. Accordingly, fluid collected in the coolant volume of the coolant tray 600 may be pumped out of the coolant volume by pump 608 and recycled for further use in the CNC machine 100. For example, coolant collected in the coolant volume may be pumped by pump 608 back into a storage reservoir of the CNC machine 100 to be constantly reused in the current machining operation. Advantageously, due to the large horizontal surface area of the coolant tray 600 any fluid can may be collected as it falls without requiring a funnel or tubing/piping system, increasing the speed of fluid flow and allowing fluid to be pumped and recycled at a much faster rate.

If a coolant pump is removable with the coolant tray 600, then, when the coolant tray 600 is removed from the enclosed working volume through recess 122, the pump 608 may be automatically disconnected from power and fluid connection with the recirculation conduit. Similarly, when the coolant tray 600 is inserted into the enclosed working volume through recess 122, the pump 608 may be automatically reconnected to power and fluid connection with the recirculation conduit.

Optionally, to assist in the removal of the coolant tray 600 from the CNC machine, wheels, tank treads or the like may be provided. As exemplified in FIG. 38., the coolant tray 600 may further comprise a rear axle 614 and a front axle 615, each disposed between the right wall 602 and the left wall 604 and each further optionally disposed under the rear wall 610 and the front wall 612 respectively. One or more rear rollers 616 may be rotatably affixed to the rear axle 614, such that rotation of the rear rollers 616 is allowed but lateral movement along rear axle 614 is prevented. Further, one or more front rollers may be rotatably affixed to the front axle 615, such that rotation of the front rollers is allowed but lateral movement along front axle 615 is prevented.

It will be appreciated that the front rollers and the rear rollers 616 may optionally each be disposed under the angled front wall 612 and rear wall 610 respectively, and may be accessible from the front of the coolant tray 600 and the rear of the coolant tray 600 respectively. Advantageously, the front rollers and rear rollers 616 are easily accessible, and can be inspected or cleaned without disassembly, lifting, or rotation of the coolant tray 600. Further, by positioning the rollers under angled walls, the front rollers and rear rollers 616 do not impede the capacity of the coolant volume, and do not affect the structure of the coolant tray 600.

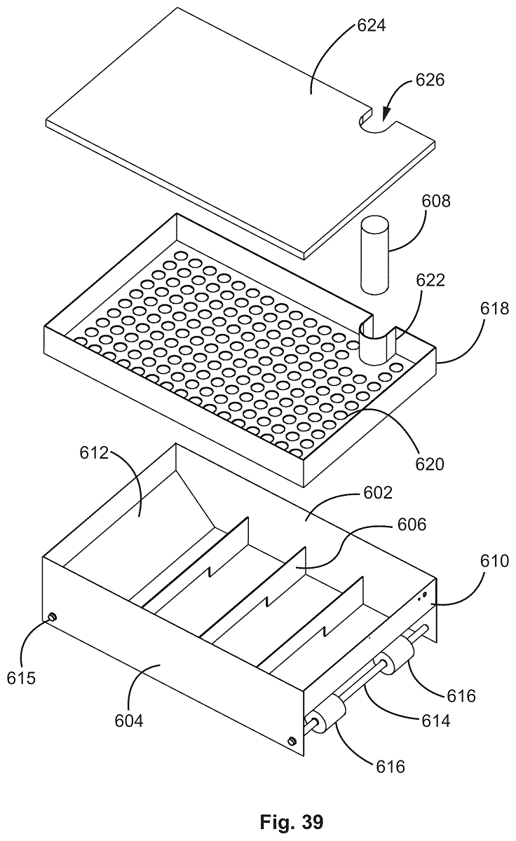

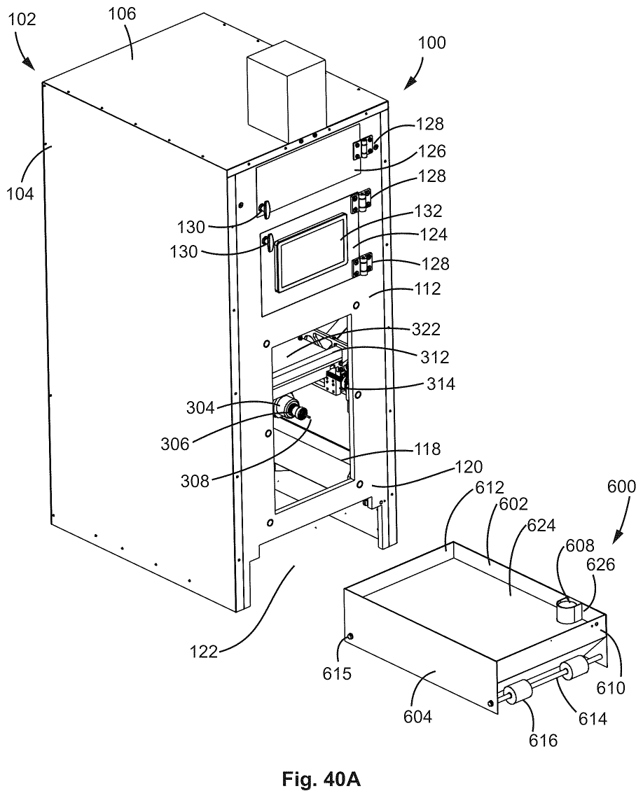

Optionally, a chip tray 618 may be removably mounted into the upper end of the coolant tray 600 (FIG. 39). The chip tray 618 may be removably mountable to walls of the coolant tray 600 and/or the chip tray 618 may rest on top of baffles 606.

The chip tray 618 may be made of a porous material, whereby liquid may flow through the chip tray 618 but solid objects remain on top of chip tray 618. Accordingly, as exemplified in FIG. 39, the chip tray 618 may have a plurality of holes 620, which may serve to prevent large cuttings or non-liquid material from passing into the coolant volume, which is located below the chip tray 618.

If the coolant tray includes a coolant pump, then depending upon the location of the recirculating fluid conduit and/or the size of the coolant pump, a divot 622 may be formed in a side of chip tray 618 to accommodate the recirculating fluid conduit and/or the coolant pump (see, e.g., FIG. 39).

Alternately, or in addition to the chip tray 618, a porous sheet 624 may be disposed on top of the coolant volume, e.g., on top of or overlying the chip tray 618. The porous sheet 624 may also have a divot 626 to accommodate the recirculating fluid conduit and/or the coolant pump (see, e.g., FIG. 39).

When the coolant tray 600 underlies the enclosed working volume of the mill body 102, any fluids or particulate material created or dispersed during a machining operation may fall into the chip tray 618 and/or porous sheet 624 due to the force of gravity, and liquids may flow through chip tray 618 and/or porous sheet 624 into the coolant volume of coolant tray 600. Due to the horizontal orientation of the spindle 302 and the vertical orientation of the work piece 260, liquids or particulate can fall freely through the enclosed working volume and into the coolant tray 600.

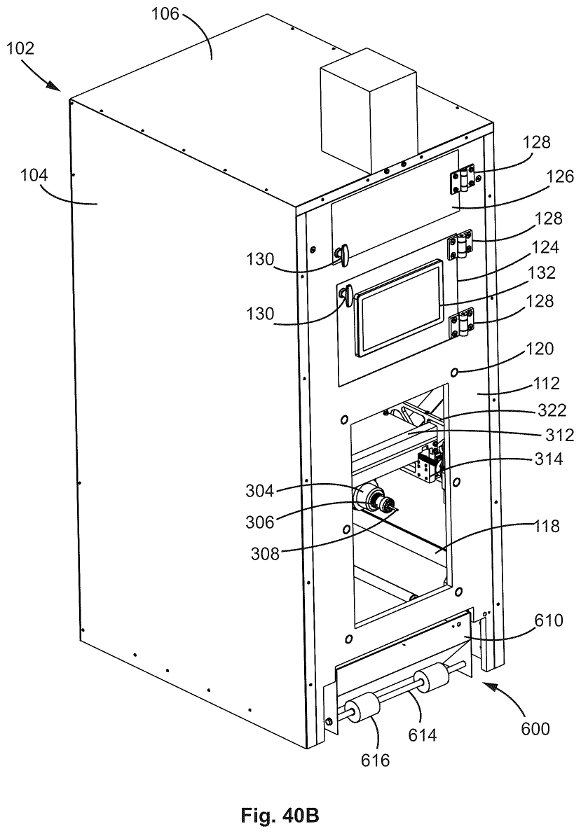

The assembly comprising the coolant tray 600, the chip tray 618, and/or the porous sheet 624 may be moved along the floor using the front rollers and rear rollers 616 (FIGS. 40A and 40B). Accordingly, the coolant tray 600 containing the chip tray 618 and/or the porous sheet 624 may be rolled towards the CNC machine 100 and moved into the recess 122 in the main datum frame 112 such that the coolant tray 600 underlies the enclosed working volume of the mill body 102. Similarly, the coolant tray 600 containing chip tray 618 and/or porous sheet 624 may be removed from the mill body 102 through recess 122. As the coolant tray 600 moves along the floor, the baffles 606 may prevent or reduce movement of liquid in the coolant volume to reduce spillage.

Optionally, when the coolant tray 600 is inserted into the mill body 102 through recess 122, the coolant tray may be supported by the counterweight frame 140, such as by left lower frame member 146, right lower frame member 148, and/or rear lower frame member 150. For example, the left lower frame member 146, right lower frame member 148 may have rails which mate with engagement surfaces (e.g., rails) provided on the coolant tray 600.

Optionally, the recess and the coolant tray may be sized such that an arm, prong, or fork of a carrier such as a forklift or pallet truck or trolley beams 228 may enter into recess 122 to lift CNC machine 100 while the coolant tray 600 is inserted into recess 122. Alternately, the coolant tray 600 may fill the recess 122 substantially or completely, such that an arm, prong, or fork of a carrier cannot be inserted into the recess 122.

### User Interface

In accordance with this aspect, which may be used by itself or with one or more of the other aspects set out herein, a CNC machine may have a user interface, which may be a display screen and may be a soft touch screen.

The electronic display screen 132 may display information relating to the operation and functionality of CNC machine 100. The electronic display screen may display text information, such as numbers, words, and symbols, and/or may display images and video, including, for example, images and videos captured within the working volume of the mill body 102.

Optionally, the display screen may be interactive and enable an operator to enter commands. Accordingly, the electronic display screen 132 may be a touchscreen user interface (UI) configured to permit interaction between an operator and the CNC machine 100. The touchscreen UI may include icons, buttons, sliders, text entry boxes, virtual keyboards, or any other elements to permit effective user input. The electronic display screen 132 may further be equipped with an audio output device such as a speaker to audibly notify a user of alerts, required inputs, and the like.

The electronic display screen 132 may use any type of display technology, such as liquid-crystal display (LCD), light-emitting diode (LED) backlit LCD, thin-film transistor (TFT) LCD, LED, quantum dot LED (QLED), organic LED (OLED), active-matrix OLED (AMOLED), super AMOLED, and the like.

In accordance with this aspect, an electronic display screen 132 may be removably mounted onto one or more latches or hooks which may be permanently or removably affixed any part of the CNC machine, such as to either one of doors 124, 126 or door 136.

The electronic display screen 132 may be substantially the same size as a door 124, 126, 136 or the electronic display screen 132 may be approximately half the size of a door. If the electronic display screen 132 is smaller than the door on which it is positioned, then the electronic display screen 132 may be located anywhere on the door, such as in the upper or lower half of the door.

If the door includes one or more windows 134 in addition to the electronic display screen 132, then the electronic display screen 132 may block some or all of window(s) 134 when in a first position. Accordingly, the electronic display screen 132 may be moveably mounted to enable the operator to view, e.g., a bay 400, 500.

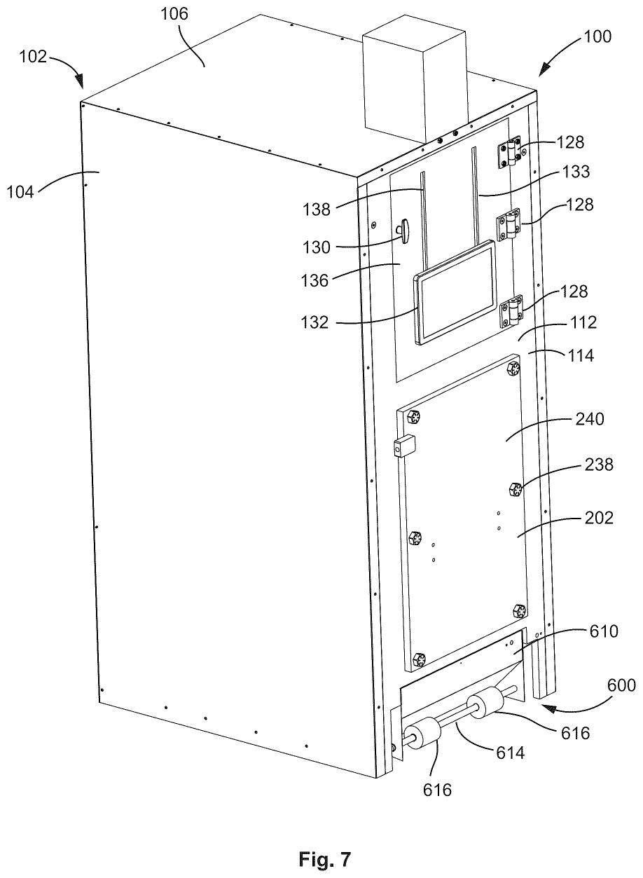

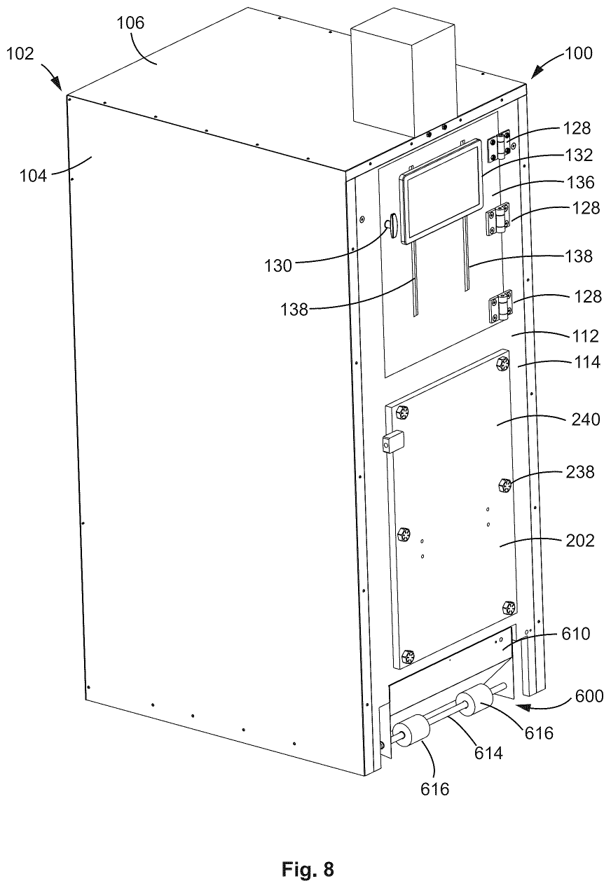

In order to enable the electronic display screen 132 to move, one or more rails, such as vertical rails 138, may be affixed to the door to facilitate movement of the electronic display screen 132. As exemplified in FIGS. 7 and 8, the electronic display screen 132 may be vertically movable along the height of door 136 via the rails 138.

Accordingly, if the electronic display screen 132 blocks some or all of window(s) 134 when in a first position (e.g., at the bottom of the rails 138 as exemplified in FIG. 7), then the electronic display screen 132 may be moved along the rails so as to allow some or all of window 134 to be viewed when in a second position (e.g., at the top of the rails 138 as exemplified in FIG. 8). Accordingly, the electronic display screen 132 may be moveably mounted to enable the operator to view, e.g., a bay 400, 500.

The electronic display screen 132 may be configured to hold its position anywhere along the rails 138 when moved vertically such that the electronic display screen 132 does not move downwards immediately or over time due to the force of gravity. The electronic display screen 132 may hold its position on the rails 138 due to frictional forces, magnetic forces, spring forces, or any other suitable method for counteracting the force of gravity. Although not explicitly illustrated, a person of skill in the art understands that any other method besides for vertical movement of the electronic display screen may be possible, including at least threaded rods, strings, gears, motors, and the like.

Although embodiments have been described wherein the rails 138 are affixed to a door, it will be appreciated that the rails 138 may instead be affixed to the front face of the CNC machine, e.g., the front face 114 of main datum frame 112, with one rail being disposed, e.g., on a left side of the door, and the other rail being disposed on a right side of the door.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

This specification also includes the subject matter of the following clause sets:

### Clause Set A

1. A computer numerical control (CNC) machine comprising:
   (a) a mill body comprising a front side, a rear side and opposed lateral sides which enclose a working volume, the front side having a work piece insertion opening;
   (b) a main datum frame that extends vertically when the CNC machine is positioned on a floor, the main datum frame has a front face and a rear face; and,
   (c) a spindle provided in the working volume wherein, when the CNC machine is positioned on the floor, the spindle has an axis of rotation that extends horizontally.
2. The CNC machine of clause 1 wherein the spindle is provided on a gantry which is moveably mounted to the mill body.
3. The CNC machine of clause 2 wherein the work piece insertion opening is provided in the main datum frame.
4. The CNC machine of clause 3 wherein the CNC machine further comprises a counterweight that underlies the working volume whereby, when at least a portion of a work piece is positioned in the working volume, a vertical plane intersects the at least a portion of the work piece and the counterweight.
5. The CNC machine of clause 4 wherein the counterweight frame is connected to the main datum frame.
6. The CNC machine of clause 1 wherein the work piece insertion opening is provided in the main datum frame.
7. The CNC machine of clause 6 wherein the CNC machine further comprises a counterweight that underlies the working volume whereby, when at least a portion of a work piece is positioned in the working volume, a vertical plane intersects the at least a portion of the work piece and the counterweight.
8. The CNC machine of clause 7 wherein the counterweight frame is connected to the main datum frame.
9. The CNC machine of clause 1 wherein the CNC machine further comprises a counterweight that underlies the working volume whereby, when at least a portion of a work piece is positioned in the working volume, a vertical plane intersects the at least a portion of the work piece and the counterweight.
10. The CNC machine of clause 9 wherein the counterweight frame is connected to the main datum frame.
11. The CNC machine of clause 6 wherein the main datum frame supports a work piece in the working volume when the work piece is inserted into the working volume.
12. The CNC machine of clause 11 wherein the main datum frame comprises first connectors that removably receive second connectors whereby, when the first and second connectors inter-engage the work piece is secured in the working volume.
13. The CNC machine of clause 12 wherein the first connectors comprise openings in which the second connectors are lockingly removably receivable.
14. The CNC machine of clause 1 wherein the mill body comprises a frame and the front side, the rear side and the opposed lateral sides comprise sheet metal that encloses the working volume and the front side further comprises the main datum frame.
15. The CNC machine of clause 14 wherein the spindle is provided on a gantry which is moveably mounted to the mill body.
16. The CNC machine of clause 15 wherein the work piece insertion opening is provided in the main datum frame.
17. The CNC machine of clause 17 wherein the CNC machine further comprises a removable coolant tray that underlies the working volume.
18. The CNC machine of clause 17 wherein a chip tray is removably positionable in the coolant tray.
19. The CNC machine of clause 18 wherein the CNC machine further comprises a carry recess in which the coolant tray is removably receivable and, when the coolant tray is removed, an arm of a carrier is removably receivable whereby, when the arm is inserted into the carry recess, the CNC machine or movable over the floor.
20. The CNC machine of clause 1 wherein the CNC machine further comprises a removable coolant tray and a counterweight that underlies the working volume and, when the coolant tray is inserted into the CNC machine, the coolant tray is supported by the counterweight.

### Clause Set B

1. A computer numerical control (CNC) machine comprising:
   (a) a mill body comprising a front side, a rear side and opposed lateral sides which enclose a working volume, the front side having a work piece insertion opening;
   (b) a main datum frame that extends vertically when the CNC machine is positioned on a floor;
   (c) a counterweight wherein, when the CNC machine is positioned on a floor, the counterweight underlies the working volume and, when at least a portion of a work piece is positioned in the working volume, a vertical plane intersects the at least a portion of the work piece and the counterweight; and,
   (d) a spindle provided in the working volume wherein, when the CNC machine is positioned on the floor, the spindle has an axis of rotation that extends horizontally.
2. The CNC machine of clause 1 wherein the spindle is provided on a gantry which is moveably mounted to the mill body.
3. The CNC machine of clause 2 wherein the work piece insertion opening is provided in the main datum frame.
4. The CNC machine of clause 3 wherein the counterweight is connected to the main datum frame.
5. The CNC machine of clause 1 wherein the counterweight is connected to the main datum frame.
6. The CNC machine of clause 1 wherein the work piece insertion opening is provided in the main datum frame.
7. The CNC machine of clause 6 wherein the CNC machine further comprises a counterweight that underlies the working volume whereby, when the at least a portion of a work piece is positioned in the working volume, a vertical plane intersects the at least a portion of the work piece and the counterweight.
8. The CNC machine of clause 7 wherein the counterweight is connected to the main datum frame.
9. The CNC machine of clause 1 wherein the CNC machine further comprises a counterweight that underlies the working volume whereby, when the at least a portion of a work piece is positioned in the working volume, a vertical plane intersects the at least a portion of the work piece and the counterweight.
10. The CNC machine of clause 9 wherein the counterweight is connected to the main datum frame.
11. The CNC machine of clause 6 wherein the main datum frame supports a work piece in the working volume when the work piece is inserted into the working volume.
12. The CNC machine of clause 11 wherein the main datum frame comprises first connectors that removably receive second connectors whereby, when the first and second connectors inter-engage the work piece is secured in the working volume.
13. The CNC machine of clause 12 wherein the first connectors comprise openings in which the second connectors are lockingly removably receivable.
14. The CNC machine of clause 1 wherein the mill body comprises a frame and the front side, the rear side and the opposed lateral sides comprise sheet metal that encloses the working volume and the front side further comprises the main datum frame.
15. The CNC machine of clause 14 wherein the spindle is provided on a gantry which is moveably mounted to the mill body.
16. The CNC machine of clause 15 wherein the work piece insertion opening is provided in the main datum frame.
17. The CNC machine of clause 1 wherein the CNC machine further comprises a removable coolant tray that underlies the working volume.
18. The CNC machine of clause 17 wherein a chip tray is removably positionable in the coolant tray.
19. The CNC machine of clause 18 wherein the CNC machine further comprises a carry recess in which the coolant tray is removably receivable and, when the coolant tray is removed, an arm of a carrier is removably receivable whereby, when the arm is inserted into the carry recess, the CNC machine is movable over the floor.
20. The CNC machine of clause 1 wherein the CNC machine further comprises a removable coolant tray and a counterweight that underlies the working volume and, when the coolant tray is inserted into the CNC machine, the coolant tray is supported by the counterweight.

### Clause Set C

1. A computer numerical control (CNC) machine comprising:
   (a) a mill body comprising a front side, a rear side and opposed lateral sides which enclose a working volume, the front side having a work piece insertion opening;
   (b) a main datum frame that extends vertically when the CNC machine is positioned on a floor;
   (c) a removable coolant tray that underlies the working volume; and,
   (d) a spindle provided in the working volume wherein, when the CNC machine is positioned on the floor, the spindle has an axis of rotation that extends horizontally.
2. The CNC machine of clause 1 wherein the coolant tray comprises a coolant volume in which used coolant is receivable during a milling operation and the coolant tray comprises a plurality of baffles.
3. The CNC machine of clause 2 wherein the coolant tray is removable in a removal direction and the baffles extend transverse to the removal direction.
4. The CNC machine of clause 3 wherein the coolant tray is removably insertable in a front of the CNC machine.
5. The CNC machine of clause 4 wherein a chip tray is removably positionable in the coolant tray.
6. The CNC machine of clause 4 wherein the CNC machine further comprises a carry recess in which the coolant tray is removably receivable and, when the coolant tray is removed, an arm of a carrier is removably receivable whereby, when the arm is inserted into the carry recess, the CNC machine is movable over the floor.
7. The CNC machine of clause 6 wherein the carrier comprises a pallet truck, a forklift or the work piece trolley.
8. The CNC machine of clause 7 wherein the carrier comprises a work piece trolley.
9. The CNC machine of clause 1 wherein the CNC machine further comprises a counterweight that underlies the working volume whereby, when the at least a portion of a work piece is positioned in the working volume, a vertical plane intersects the at least a portion of the work piece and the counterweight.
10. The CNC machine of clause 9 wherein the counterweight is connected to the main datum frame.
11. The CNC machine of clause 1 wherein, when the coolant tray is inserted into the CNC machine, the coolant tray is supported by the counterweight.
12. The CNC machine of clause 1 further comprising a chip tray that is concurrently removable with the coolant tray.
13. The CNC machine of clause 12 wherein the coolant tray comprises a coolant volume in which used coolant is receivable during a milling operation and when the chip tray and coolant tray are positioned in the CNC machine, the chip tray overlies the coolant volume.
14. The CNC machine of clause 13 wherein the chip tray is porous.
15. The CNC machine of clause 14 wherein the chip tray is removably positionable in an upper end of the coolant tray.
16. The CNC machine of clause 1 further comprising a coolant pump and the coolant pump is concurrently removable with the coolant tray.
17. The CNC machine of clause 16 wherein the coolant pump is automatically connected in flow communication with a coolant delivery flow path when the coolant tray is inserted into the CNC machine.
18. The CNC machine of clause 17 wherein the coolant tray comprises floor engaging wheels.
19. The CNC machine of clause 1 wherein the coolant tray comprises floor engaging wheels.
20. The CNC machine of clause 1 further comprising a removable porous chip tray and when the coolant tray and the chip tray are inserted into the CNC machine, the chip tray overlies the coolant tray.

### Clause Set D

1. A combination of:
   (a) a computer numerical control (CNC) machine comprising a mill body comprising a front side, a rear side and opposed lateral sides which enclose a working volume, the front side having a work piece insertion opening; and,
   (b) a work piece trolley that is discrete from the CNC machine, the work piece trolley comprising a plurality of wheels and a work piece support surface and a work piece holder, the orientation of the work piece support surface is adjustable from a generally horizontal orientation in which a work piece is mountable to the work piece holder and a vertical orientation in which at least a portion of the work piece is insertable into the working volume through the work piece insertion opening.
2. The combination of clause 1 wherein the work piece support surface comprises a work piece table on which the work piece is supported when the work piece is secured in position by the work piece holder.
3. The combination of clause 2 wherein the work piece table is removably connectable to the mill body and, when connected to the mill body, the work piece insertion opening is closed.
4. The combination of clause 2 wherein the mill body further comprises a main datum frame that extends vertically when the CNC machine is positioned on the floor, the main datum frame has the work piece insertion opening and the work piece table is removably connectable to the main datum frame.
5. The combination of clause 4 wherein the work piece trolley comprises a trolley frame and the work piece table is removably connectable to the trolley frame.
6. The combination of clause 3 wherein the work piece trolley comprises a trolley frame and the work piece table is rotatable from the horizontal orientation to the vertical orientation.
7. The combination of clause 2 wherein the work piece trolley comprises a trolley frame and the work piece table is removably connectable to the trolley frame.
8. The combination of clause 1 wherein the work piece support surface is rotatable from the horizontal orientation to the vertical orientation.
9. The combination of clause 1 wherein, when the work piece support surface is in the vertical orientation, the work piece is provided on the work piece trolley and the work piece trolley is moved to insert the work piece into the working volume, the work piece trolley moves in a forward direction, when the work piece trolley is moved in the forward direction, the work piece trolley has a front end and a rear end, the rear end has swivel wheel and the front end has wheels that have an axis or rotation that is fixed in a plane transverse to the forward direction.
10. The combination of clause 1 wherein the work piece trolley is moveable with respect to the CNC machine between a loading position in which a work piece is mountable to the work piece support surface and secured in position by the work piece holder and a milling position in which the work piece is positioned to be milled.
11. The combination of clause 1 wherein the work piece trolley further comprises a mechanical advantage screw, lever or pneumatic, hydraulic or electric drive which is drivingly connected to the work piece support surface whereby the orientation of the work piece support surface is adjustable.
12. The combination of clause 1 wherein the work piece trolley further comprises a robot arm or crane operable to move a work piece onto the work piece trolley.
13. The combination of clause 1 wherein the mill body comprises a spindle provided in the working volume wherein, when the CNC machine is positioned on a floor, the spindle has an axis of rotation that extends horizontally.
14. The combination of clause 1 wherein, when the work piece is positioned in the working volume and the CNC machine is operated to work the work piece, the work piece remains in a stationary position in the working volume.
15. The combination of clause 1 wherein, when the work piece is positioned on the work piece trolley and secured in position by the work piece holder, a position of the work piece in at least one axis is adjustable.
16. The combination of clause 1 wherein, when the work piece is positioned in the working volume and the CNC machine is operated to work the work piece, the spindle is moveable in three axes and the work piece is also moveable in at least one of the three axes.
17. The combination of clause 1 wherein the work piece trolley has a fold down step.
18. The combination of clause 1 wherein the work piece support surface has a door whereby, when the work piece is positioned in the working volume, the door is openable whereby access is provided to a working component of the mill body.

### Clause Set E

1. A computer numerical control (CNC) machine comprising:
   (a) a mill body comprising a front side, a rear side and opposed lateral sides which enclose a working volume, the front side having a work piece insertion opening; and,
   (b) a work piece support surface, the orientation of the work piece support surface is adjustable from a generally horizontal orientation in which a work piece is mountable to a work piece holder and a vertical orientation in which at least a portion of the work piece is insertable into the working volume through the work piece insertion opening.
2. The CNC machine of clause 1 wherein the work piece support surface is moveably mounted to the mill body.
3. The CNC machine of clause 2 wherein the work piece support surface is rotationally mounted to the mill body.
4. The CNC machine of clause 3 wherein the work piece support surface is also translatably mounted to the mill body wherein the work piece support surface is translatable away from the front side and subsequently rotated from the horizontal orientation to the vertical orientation.
5. The CNC machine of clause 4 further comprises a mechanical advantage screw, lever or pneumatic, hydraulic or electric drive which is drivingly connected to the work piece support surface whereby the orientation of the work piece support surface is adjustable.
6. The CNC machine of clause 3 further comprises a mechanical advantage screw, lever or pneumatic, hydraulic or electric drive which is drivingly connected to the work piece support surface whereby the orientation of the work piece support surface is adjustable.
7. The CNC machine of clause 1 further comprises a robot arm or crane operable to move a work piece onto the work piece support surface.
8. The CNC machine of clause 1 wherein the mill body comprises a spindle provided in the working volume wherein, when the CNC machine is positioned on a floor, the spindle has an axis of rotation that extends horizontally.
9. The CNC machine of clause 1 wherein, when the work piece is positioned in the working volume and the CNC machine is operated to work the work piece, the work piece remains in a stationary position in the working volume.
10. The CNC machine of clause 1 wherein, when the work piece is positioned on the work piece support surface and secured in position by the work piece holder, a position of the work piece in at least one axis is adjustable.
11. The CNC machine of clause 1 wherein, when the work piece is positioned in the working volume and the CNC machine is operated to work the work piece, the spindle is moveable in three axes and the work piece is also moveable in at least one of the three axes.
12. The CNC machine of clause 1 wherein the work piece support surface has a door whereby, when the work piece is positioned in the working volume, the door is openable whereby access is provided to a working component of the mill body.
13. The CNC machine of clause 12 wherein the working component comprises a tool holder.
14. The CNC machine of clause 12 wherein the working component comprises an electronics bay.
15. The CNC machine of clause 1 wherein, in the milling position, the work piece support surface closes the work piece insertion opening.
16. The CNC machine of clause 15 wherein the mill body comprises first connectors that removably receive second connectors whereby, when the first and second connectors inter-engage, the work piece is secured in the working volume.
17. The CNC machine of clause 16 wherein, when the first and second connectors inter-engage, the work piece support surface is secured in the vertical orientation.
18. The CNC machine of clause 17 wherein the first connectors comprise openings in which the second connectors are lockingly removably receivable.

### Clause Set F

1. A combination of:
   (a) computer numerical control (CNC) machine comprising a mill body comprising a front side, a rear side and opposed lateral sides which enclose a working volume, the front side having a work piece insertion opening; and,
   (b) a work piece trolley that is discrete from the CNC machine, the work piece trolley comprising a trolley frame, a work piece table removably mountable to the trolley frame and a work piece holder, the orientation of the work piece table is adjustable from a generally horizontal orientation in which a work piece is mountable to the work piece holder and a vertical orientation in which at least a portion of the work piece is insertable into the working volume through the work piece insertion opening.
2. The combination of clause 1 wherein the work piece table is removably connectable to the mill body and, when connected to the mill body, the work piece insertion opening is closed.
3. The combination of clause 1 wherein the mill body further comprises a main datum frame that extends vertically when the CNC machine is positioned on the floor, the main datum frame has the work piece insertion opening and the work piece table is removably connectable to the main datum frame.
4. The combination of clause 1 wherein the work piece table is rotatable from the horizontal orientation to the vertical orientation.
5. The combination of clause 1 wherein, when the work piece table is in the vertical orientation, the work piece is provided on the work piece trolley and the work piece trolley is moved to insert the work piece into the working volume, the work piece trolley moves in a forward direction, when the work piece trolley is moved in the forward direction, the work piece trolley has a front end and a rear end, the rear end has swivel wheels and the front end has wheels that have an axis or rotation that is fixed in a plane transverse to the forward direction.
6. The combination of clause 1 wherein the work piece trolley is moveable with respect to the CNC machine between a loading position in which a work piece is mountable to the work piece table and secured in position by the work piece holder and a milling position in which the work piece is positioned to be milled.
7. The combination of clause 1 wherein the work piece trolley further comprises a mechanical advantage screw, lever or pneumatic, hydraulic or electric drive which is drivingly connected to the work piece table whereby the orientation of the work piece table is adjustable.
8. The combination of clause 1 wherein the work piece trolley further comprises a robot arm or crane operable to move a work piece onto the work piece trolley.
9. The combination of clause 1 wherein the mill body comprises a spindle provided in the working volume wherein, when the CNC machine is positioned on a floor, the spindle has an axis of rotation that extends horizontally.
10. The combination of clause 1 wherein, when the work piece is positioned in the working volume and the CNC machine is operated to work the work piece, the work piece remains in a stationary position in the working volume.
11. The combination of clause 1 wherein, when the work piece is positioned on the work piece trolley and secured in position by the work piece holder, a position of the work piece in at least one axis is adjustable.
12. The combination of clause 1 wherein, when the work piece is positioned in the working volume and the CNC machine is operated to work the work piece, the spindle is moveable in three axes and the work piece is also moveable in at least one of the three axes.
13. The combination of clause 1 wherein the work piece trolley has a fold down step.
14. The combination of clause 1 wherein the work piece table has a door whereby, when the work piece is positioned in the working volume, the door is openable whereby access is provided to a working component of the mill body.
15. The combination of clause 12 wherein the working component comprises a tool holder.
16. The combination of clause 12 wherein the working component comprises an electronics bay.
17. The combination of clause 1 wherein the work piece holder is removably attachable to the work piece trolley.
18. The combination of clause 17 wherein the work piece holder is removably attachable to the work piece trolley at a plurality of locations.
19. The combination of clause 17 wherein the work piece holder comprises two distinct components, one of which is translatable towards the other from a work piece mounting position to a work piece secured position.
20. The combination of clause 1 wherein, when the work piece table is in the vertical orientation, the work piece is provided on the work piece trolley and the work piece trolley is moved to insert the work piece into the working volume, the work piece trolley moves in a forward direction, when the work piece trolley is moved in the forward direction, the work piece trolley has a front end and a rear end, the rear end has swivel wheels and the front end has wheels that have an axis of rotation that is fixed in a plane transverse to the forward direction.

### Clause Set G

1. A work piece support surface that is moveable between a horizontal loading position in which a work piece is mountable to the work piece support surface and a vertical milling position in which the work piece is positioned in a working volume that is internal of a computer numerical control (CNC) machine, and a work piece holder that is removably attachable to the work piece support surface.
2. The work piece support surface of clause 1 wherein, in the milling position, the work piece support surface closes a work piece insertion opening of the CNC machine.
3. The work piece support surface of clause 2 wherein the work piece insertion opening is provided in a main datum frame of the CNC machine.
4. The work piece support surface of clause 2 wherein the work piece support surface is moveably mounted to the CNC machine.
5. The work piece support surface of clause 4 wherein the work piece support surface is rotationally mounted to the CNC machine.
6. The work piece support surface of clause 5 wherein the work piece support surface is also translatably mounted to the CNC machine wherein the work piece support surface is translatable away from the work piece insertion opening and subsequently rotated from the horizontal loading position to the vertical milling position.
7. The CNC machine of clause 6 further comprises a mechanical advantage screw, lever or pneumatic, hydraulic or electric drive which is drivingly connected to the work piece support surface whereby a position of the work piece support surface is adjustable.
8. The CNC machine of clause 5 further comprises a mechanical advantage screw, lever or pneumatic, hydraulic or electric drive which is drivingly connected to the work piece support surface whereby the position of the work piece support surface is adjustable.
9. The work piece support surface of clause 2 wherein the work piece support surface comprises a T slot table.
10. The work piece support surface of clause 2 wherein the work piece holder surface comprises a tailstock and a rotating clamp.
11. The work piece support surface of clause 2 wherein the work piece holder comprises two distinct components, one of which is translatable towards the other from a work piece mounting position to a work piece secured position.
12. The work piece support surface of clause 4 wherein the work piece support surface comprises a T slot table.
13. The work piece support surface of clause 4 wherein the work piece holder surface comprises a tailstock and a rotating clamp.
14. The work piece support surface of clause 4 wherein the work piece holder comprises two distinct components, one of which is translatable towards the other from a work piece mounting position to a work piece secured position.
15. The work piece support surface of clause 2 wherein the work piece support surface is provided on a work piece trolley that is discrete from the CNC machine.
16. The work piece support surface of clause 15 wherein the work piece support surface comprises a T slot table.
17. The work piece support surface of clause 15 wherein the work piece holder surface comprises a tailstock and a rotating clamp.
18. The work piece support surface of clause 15 wherein the work piece holder comprises two distinct components, one of which is translatable towards the other from a work piece mounting position to a work piece secured position.

### Clause Set H

1. A computer numerical control (CNC) machine comprising:
   (a) a mill body comprising a front side, a rear side and opposed lateral sides which enclose a working volume, the front side having a work piece insertion opening;
   (b) a spindle provided in the working volume wherein, when the CNC machine is positioned on the floor, the spindle has an axis of rotation that extends horizontally; and,
   (c) a tool bay which has an interior door that is moveable between a closed position in which the tool bay is isolated from the working volume and an open position in which the tool bay is accessible from within the working volume.
2. The CNC machine of clause 1 wherein the spindle is operable to open the interior door.
3. The CNC machine of clause 2 wherein the spindle is operable to insert a tool into the tool bay.
4. The CNC machine of clause 1 wherein the spindle is operable to insert a tool into the tool bay.
5. The CNC machine of clause 1 wherein the tool bay further comprises an exterior door that is moveable between a closed position and an open position in which the tool bay is accessible by a user from an exterior to the CNC machine.
6. The CNC machine of clause 5 wherein the exterior door comprises a window.
7. The CNC machine of clause 6 wherein the exterior door comprises a user interface.
8. The CNC machine of clause 5 wherein the exterior door comprises a user interface.
9. The CNC machine of clause 8 wherein the user interface is vertically moveable.
10. The CNC machine of clause 1 further comprising a user interface.
11. The CNC machine of clause 10 wherein the user interface is vertically moveable.
12. The CNC machine of clause 1 further comprising a main datum frame that extends vertically when the CNC machine is positioned on a floor and the tool bay is positioned on the main datum frame.
13. The CNC machine of clause 12 wherein the work piece insertion opening is provided in the main datum frame.
14. The CNC machine of clause 1 further comprising a detector operable to determine if a tool is clean prior to the tool being inserted into the tool bay.
15. The CNC machine of clause 14 wherein the detector comprises a camera.
16. The CNC machine of clause 14 further comprising a cleaning air flow path extending to a nozzle whereby, when the detector determines that the tool is not clean, air is directed at the tool prior to the tool being inserted into the tool bay.
17. The CNC machine of clause 15 further comprising a cleaning air flow path extending to a nozzle whereby, when the detector determines that the tool is not clean, air is directed at the tool prior to the tool being inserted into the tool bay.
18. The CNC machine of clause 1 wherein the tool bay is pressurized during a milling operation.

1. A combination of:
(a) a computer numerical control (CNC) machine comprising:
(i) a mill body comprising a front side, a rear side and opposed lateral sides which enclose a working volume, the front side having a work piece insertion opening; and,
(ii) a spindle provided in the working volume wherein, when the CNC machine is positioned on a floor, the spindle has an axis of rotation that extends horizontally;
(b) a work piece trolley comprising a work piece holder, the work piece trolley moveable with respect to the CNC machine between a loading position in which a work piece is mountable to the work piece trolley and a milling position in which the work piece is positioned to be milled;

2. The combination of claim 1 wherein, as the work piece trolley is moved to the milling position, at least a portion of the work piece is inserted through the work piece insertion opening into the working volume.

3. The combination of claim 2 wherein the work piece trolley comprises a work piece table and, in the milling position, the work piece table closes the work piece insertion opening.

4. The combination of claim 2 wherein the work piece trolley and/or the work piece table is removably attachable to the mill body.

5. The combination of claim 3 wherein, in the milling position, the work piece is fully inserted into the working volume and the work piece table abuts the front side of the mill body.

6. The combination of claim 2 wherein, in the milling position, the work piece is partially inserted into the working volume and the work piece insertion opening is closed by a variable seal, the variable seal comprising a plurality of seals that are moveable in a plane parallel to the front side.

7. The combination of claim 1 wherein the mill body further comprises a main datum frame that extends vertically when the CNC machine is positioned on the floor, the main datum frame has a front face and a rear face.

8. The combination of claim 7 wherein the spindle is provided on a gantry which is moveably mounted to the mill body.

9. The combination of claim 8 wherein the work piece trolley remains in a fixed position during milling of a work piece.

10. The combination of claim 8 wherein the work piece insertion opening is provided in the main datum frame and front and rear faces of the main datum frame are parallel to each other.

11. The combination of claim 1 wherein the CNC machine further comprises a counterweight that underlies the working volume, the counterweight whereby, when at least a portion of the work piece is positioned in the working volume, a vertical plane intersects the at least a portion of the work piece and the counterweight.

12. The combination of claim 1 wherein the CNC machine further comprises a carry recess which removably receives an arm of a carrier whereby, when the arm is inserted into the carry recess, the CNC machine is movable over the floor.

13. The combination of claim 12 wherein the carrier comprises a pallet truck, a forklift or the work piece trolley.

14. The combination of claim 13 wherein the carrier comprises the work piece trolley.

15. The combination of claim 1 wherein the CNC machine further comprises a removable coolant tray.

16. The combination of claim 15 wherein the coolant tray underlies the working volume.

17. The combination of claim 16 wherein a chip tray is removably positionable in the coolant tray.

18. The combination of claim 17 wherein the CNC machine further comprises a carry recess in which the coolant tray is removably receivable and, when the coolant tray is removed, an arm of a carrier is removably receivable whereby, when the arm is inserted into the carry recess, the CNC machine is movable over the floor.

19. The combination of claim 18 wherein the carrier comprises a pallet truck, a forklift or the work piece trolley.

20. The combination of claim 19 wherein the carrier comprises the work piece trolley.

21. The combination of claim 1 wherein the CNC machine comprises a plurality of wheels which are retractable between a floor engaging position and a raised position in which the plurality of wheel are spaced from the floor.
